(19) United States
(12) Patent Application Publication
(10) Pub. No.: US 2010/0208631 A1
(43) Pub. Date: Aug. 19, 2010

(54) INAUDIBLE METHODS, APPARATUS AND SYSTEMS FOR JOINTLY TRANSMITTING AND PROCESSING, ANALOG-DIGITAL INFORMATION

(75) Inventors: Duo ZHANG, Irvine, CA (US); Fan-Gang Zeng, Irvine, CA (US)

Correspondence Address: CROWELL & MORING LLP;INTELLECTUAL PROPERTY GROUP, P.O. BOX 14300, WASHINGTON, DC, 20044-4300, US

(73) Assignee: The Regents of the University of California, Oakland, CA (US)

(21) Appl. No.: 12/707,583

(22) Filed: Feb. 17, 2010

Related U.S. Application Data
(60) Provisional application No. 61/153,212, filed on Feb. 17, 2009.

(51) Int. Cl. H04L 5/00

(52) U.S. Cl. 370/297

(57) ABSTRACT

The disclosure relates to jointly transmitting and processing analog-digital information using Inaudible Synchronous Online User-optimized Processing (iSOUP), wherein digital and analog information can be transmitted via one connection. iSOUP may be implemented in real-time MP3 anti-piracy, customized MP3 songs, Internet customized medical devices, Internet customized consumer electronics, Internet controlled psychoacoustic and physiological tests, tinnitus treatment devices, anti-piracy MP3 players, assistive listening MP3 players, healthcare sensor networks, Bluetooth sensors, audio-visual hearing aids (HAs) and cochlear implants (CIs), audio-touch HAs and CIs, Bluetooth HAs and CIs, automated fitting of HAs and CIs. The invention has applicability in copyright protection, data hiding, hearing aid remote controls, children learning devices, musical special effects generators, multiuser multimedia devices, Internet treatment and disease surveillance, wireless medical devices, wireless telemetry, multimedia rehabilitation devices, hearing aids and other implants.

### CROSS REFERENCE TO RELATED APPLICATION

This application claims the benefit of U.S. Provisional Application No. 61/153,212, filed on Feb. 17, 2009.

### FIELD OF THE INVENTION

The present invention relates generally to the fields of communications, signal processing, multimedia entertainment devices and medical devices. It also relates to MP3 real-time anti-piracy, customized MP3 songs, Internet customized hearing aid, Internet customized consumer electronics, Internet controlled psychoacoustic and physiological tests, wireless tinnitus treatment devices, anti-piracy MP3 players, assistive listening MP3 players, healthcare sensor networks, Bluetooth sensors, audio-visual hearing aids and CIs (cochlear implants), audio-touch hearing aids and CIs, Bluetooth hearing aids and CIs, automated fitting hearing aids and CIs, inaudible copyright protection, inaudible data hiding, handy hearing aid remote controls, children learning devices, musical special effects generators, multiuser multimedia devices, Internet-based healthcare (treatment devices and chronic disease surveillance), wireless medical devices, wireless telemetry, patient multimedia rehabilitation devices, hearing aids, middle ear implants (MEI), bone conduction implants (BCI), vestibular implants (VI), cochlear implants (CI), hybrid cochlear/vestibular implants (HCVI), auditory nerve implants (ANI), auditory brainstem implants (ABI), auditory midbrain implants (AMI) (the term “auditory implants” hereafter shall include MEI, BCI, VI, CI, HCVI, ANI, ABI, and AMI).

Furthermore, it also relates to eyeglass hearing aids and auditory implants, auditory hallucination treatment devices, wireless sleep helping devices, phantom pain relief devices, Meniere's disease treatment devices, neuralgia relief devices, tinnitus treatment devices, depression relief devices, stroke and brain damage rehabilitation devices, dementia rehabilitation devices, multiple sclerosis rehabilitation devices, Parkinson's disease rehabilitation devices, audio-visual rehabilitation devices, hearing disease treatment devices, neurological disorder treatment devices, behind-the-ear/in-the-ear (BTE/ITE) devices, multimedia integration devices, processor updating, fast verification tools, parallel processing systems, audio cables, network cables, and wireless connectors.

More particularly, the present invention relates to inaudible methods, apparatus and systems for jointly transmitting and processing analog-digital information over an audio cable, a wireless connection, a sound wave free-field connection, Internet, or other media. Through the transmission and processing, sound, speech, voice, music, audio, song, melody, instrumental music, concerto, sonata, audio book, digital radio, puretone, complex tone, or physiological/acoustic stimulus is transmitted from a MP3 player, MP4 player, WMA player, WAV player, CD player, computer, iPod™, iPhone™, cell phone, loudspeaker, AM/FM radio, PDA, handheld computer, amplifier's output, camcorders, tape player, MiniDisc, Hi-MiniDisc, electric instruments, professional console, audio mixing desk, walkman, telecoil, or any other audio player, to a microphone, headphone, headset, earphone, earpiece, earset, computer, cell phone headset, hearing aid, auditory implants, audio recorder, canalphone, hydrophone, PDA, handheld computer, amplifier's input, camcorders, professional console, audio mixing desks, telecoil, or any other audio receiver.

### BACKGROUND OF THE INVENTION

Audio jack, audio cable, wireless audio connection, and over-the-air audio connection (i.e. sound wave free-field transmission) are widely used. For example, an audio cable connection is a de facto standard for many devices. Currently, only analog sound waveform is transmitted through an audio cable, wireless audio connection, or over-the-air audio connection. For convenience, the term “audio link” hereafter (as defined herein) represents audio cable, wireless audio connection, or over-the-air audio connection.

Digital information plays a critical role in a wide range of applications. Unfortunately, digital information is not transmitted through such audio links by conventional devices. Furthermore, hybrid analog-digital information is not transmitted through such audio links; nor is there any method of jointly transmitting and processing digital information or hybrid analog-digital information through audio links.

### SUMMARY OF THE INVENTION

Disclosed and claimed herein are inaudible methods, apparatus and systems for jointly transmitting and processing analog-digital information over an audio cable, a wireless connection, an over-the-air connection, Internet, or other media. One aspect of the present invention involves iSOUP (Inaudible Synchronous Online User-optimized Processing), wherein both digital and analog information can be transmitted via one line (or one connection), whereas conventional devices requires the use of two cables (or two connections) separately for audio waveform and digital information.

Through the use of the invention, one or more of the following advantages over conventional devices may be realized:

Much Lower Cost

The present invention may offer innovative methods whose cost can be a thousand times lower than conventional methods. For example, conventionally thousands-of-dollars fitting hardware is used to fit or personalize a hearing aid (or a cochlear implant) to a specific patient. However, the innovative methods disclosed herein need only a one-dollar audio cable to do the same job. Furthermore, the innovative methods offer faster and easier product development.

Standard Interface to Any Computer or MP3 Player.

The methods of the invention can be applied to any commercial device that has an audio jack/plug, e.g. a MP3 player, computer, cell phone, hearing aid, or auditory implant. The methods disclosed thus can be used everywhere.

Inaudible Sound Level.

As set forth in the present disclosure, the inaudibility of digital transmission offers novel applications in anti-piracy MP3 player, inaudible copyright protection, etc.

One Single Interface.

A wide range of conventional devices have two interfaces for digital and analog, respectively. However, the invention preferably uses only one interface to substitute two.

Less Weight and Smaller Size for Behind-the-Ear Devices.

Having only one interface, the innovative devices of the invention have a smaller size and a less weight than conventional devices. For Behind-The-Ear (BTE), In-The-Ear (ITE), or portable applications, smaller size and less weight are considerably more desirable.

Wireless Medical Devices, Including Wireless Tinnitus Treatment Device.

One aspect of the invention relates to wireless medical devices using a wireless audio connection. An example is a novel wireless tinnitus treatment device. The invention is compatible to all existing wireless technologies. Thanks to many one-dollar wireless chips, the wireless medical devices of the invention enjoy low cost.

Real-Time MP3 Anti-Piracy.

An anti-piracy MP3 player disclosed herein makes pirated copies become useless. Only the licensed user of the MP3 player not anyone else can enjoy songs purchased.

Assistive Listening MP3 Player for Highest Music Appreciation of a Patient.

An assistive listening MP3 player as disclosed herein for offering a hearing-impaired patient the highest real-time music entertainment. The MP3 player is personalized for high sensation, high fidelity, broad frequency range, and high quality.

Multimedia Medical Devices, Including Audio-Visual Hearing Aids, Audio-Touch Hearing Aids, and Audio-Visual-Touch Hearing Aids.

Another aspect of the invention relates to multimedia medical devices for employing multisensory integration. The applications of the present invention cover simulating 8 senses of audio, visual, temperature, smell, taste, touch, rotary, and linear-acceleration. For example, audio-visual/audio-touch/audio-visual-touch hearing aids and cochlear implants are disclosed for employing audio-visual, audio-touch, or audio-visual-touch integration to enhance the perception of speech and music.

Healthcare Sensor Network and Internet Healthcare.

Another aspect of the invention relates to low-cost healthcare sensor network and low-cost Internet healthcare regarding medical surveillance, Internet diagnosis, Internet treatment, etc. It enables the diagnostic plots of a patient to be viewed anywhere in the world.

Automated Fitting of Hearing Aid and Cochlear Implant Without Requiring Hardware.

Another aspect of the invention relates to automated fitting methods for hearing aids (HA), middle ear implants (MEI), bone conduction implants (BCI), vestibular implants (VI), cochlear implants (CI), hybrid cochlear/vestibular implants (HCVI), auditory nerve implants (ANI), auditory brainstem implants (ABI), auditory midbrain implants (AMI), etc. Optimal fitting parameters are automatically generated without requiring thousands-of-dollars conventional fitting hardware. The fitting needs no human intervention. It is more accurate, objective, and free from human subjective bias or human unintentional mistakes.

Because of the teachings set forth herein, it is the first time ever that fitting can be done everywhere by a computer and an audio cable. Conventionally, special expensive hardware has been a prerequisite for fitting.

The parameters to be fitted to a specific patient can be any kind. They can include but are not limited to subchannel gain, audible threshold (THL), most comfortable level (MCL), frequency bin, electrode index, FIR/IIR filter coefficient, windowing function, compression function, and/or block size of input/processing/output.

Handy Wireless Controller for Hearing Aid and Cochlear Implant.

Another aspect of the invention relates to a handy wireless controller for controlling a hearing aid (HA) remotely and playing music to the HA remotely. It can switch the HA to different programs and adjust the HA volume remotely. When plugged by a conventional MP3 player, it delivers music to the HA wirelessly. It may look like a wristwatch or a pocket-size case. This controller also applies to an auditory implant.

Digital Transmission over an Analog Audio Cable for the First Time.

Conventional methods do not provide digital transmission over an analog audio cable. The invention disclosed herein further relates to digital transmission over an analog audio cable for the first time. The invention also relates to digital transmission through a wireless audio connection and a sound wave free-field audio connection for the first time.

Ease of Internet Update.

Another aspect of the invention relates to an innovative method that updates/upgrades any device through an audio cable from the Internet. The updating/upgrading may include new parameters, new programs, new cores, or new operating systems.

Synchronization of Multiple Devices.

Another aspect of the invention relates offering a novel method to synchronize multiple devices through an audio cable, wirelessly, or inaudibly over the air.

Multiuser Sharing Systems.

Another aspect of the invention relates to multiuser sharing systems for a classroom, music hall, auditorium, multilingual translation room, or church.

Real-Time Algorithm Accelerator.

Another aspect of the invention relates to a real-time accelerator that speeds up a conventional device and solves a typical problem: the conventional device needs to upgrade but can not afford the computation of a desired algorithm, e.g. wavelet transform, speaker recognition, pitch extraction, etc.

Wireless Data Recording.

Another aspect of the invention relates to a low-cost method of wireless data recording and wireless data logging.

Other aspects, features, and techniques of the invention will be apparent to one skilled in the relevant art in view of the description of the embodiments of the invention.

### BRIEF DESCRIPTION OF THE DRAWINGS

FIG. 1(a) depicts a multichannel audio plug with more than 5 contacts (Tip, Ring 1, Ring 2, . . . , Ring N, and Sleeve), in accordance with one or more embodiments of the invention.

FIG. 1(b) depicts two variations of TRRS connector, in accordance with one or more embodiments of the invention;

FIG. 1(c) depicts two variations of TRS connector, where a black solid disc means either a socket or a pin, in accordance with one or more embodiments of the invention;

FIG. 2 depicts a time-frequency (TF) series, where a group of frequency bins is selected for each time slot, in accordance with one or more embodiments of the invention;

FIG. 3 depicts a multichannel time-frequency (MCTF) series, where the timing offsets of Δ12, . . . and Δ1L can be different across L channels, in accordance with one or more embodiments of the invention;

FIG. 4 depicts a wireless audio connection for transmitting iSOUP Frame Structure (iSOUP-FS), in accordance with one or more embodiments of the invention;

FIG. 5 depicts an iSOUP Frame Structure (iSOUP-FS), in accordance with one or more embodiments of the invention;

FIGS. 6(a)-(i) depict a long-frame, short-frame, marker-frame, compressed-frame, expanded-frame, abundant-frame, super-frame, multisensory-frame, and surveillance-frame, respectively, in accordance with one or more embodiments of the invention;

FIGS. 7(j)-(p) depict a stereo-short-frame, stereo-long-frame, TRRS-short-frame, TRRS-marker-frame, TRRRS-short-frame, FDM (Frequency-Division Multiplexing)-frame, and multicarrier-frame, respectively, in accordance with one or more embodiments of the invention;

FIG. 8 depicts a time-frequency-space (TFS) stream-frame, in accordance with one or more embodiments of the invention;

FIGS. 9(a)-(b) depict basic topologies of iSOUP Technique for an integrated topology and standalone topology, respectively, in accordance with one or more embodiments of the invention;

FIG. 10 depicts an embodiment of iSOUP network, in accordance with one or more embodiments of the invention;

FIG. 11 depicts a top-layer framework of iSOUP User Optimization Procedure (iSOUP-UOP), in accordance with one or more embodiments of the invention;

FIGS. 12(a)-(c) depict the first five Stages I-V of iSOUP User Optimization Procedure (iSOUP-UOP), in accordance with one or more embodiments of the invention;

FIGS. 13(a)-(b) depict an iSOUP Algorithm Enhancement Procedure (iSOUP-AEP), in accordance with one or more embodiments of the invention;

FIG. 14 depicts iSOUP data hiding, in accordance with one or more embodiments of the invention;

FIG. 15 depicts a Bluetooth iSOUP Frame Structure (iSOUP-FS) over orthogonal frequency-division multiplexing (OFDM), in accordance with one or more embodiments of the invention;

FIG. 16 depicts an Anti-Piracy MP3 Player, in accordance with one or more embodiments of the invention;

FIG. 17 depicts a low-cost MP3 lyrics LCD displayer in accordance with one or more embodiments of the invention;

FIG. 18 depicts an iSOUP multiple-device synchronizer, in accordance with one or more embodiments of the invention;

FIG. 19 depicts an architecture of iSOUP Healthcare Sensor Network (iSOUP-HSN) with Alarming Mechanism, in accordance with one or more embodiments of the invention;

FIG. 20 depicts an iSOUP Bluetooth sensor, in accordance with one or more embodiments of the invention;

FIGS. 21(a)-(e) depicts a Music Enhancer, in accordance with one or more embodiments of the invention;

FIG. 22 depicts a Wireless Controller for Hearing Aid, in accordance with one or more embodiments of the invention;

FIGS. 23(a)-(b) depict a Radio Assisted Hearing Aid, in accordance with one or more embodiments of the invention;

FIG. 24 depicts a One-Interface Hearing Aid, in accordance with one or more embodiments of the invention;

FIGS. 25(a)-(b) depict an Audio-visual hearing aid and audio-visual auditory implant, in accordance with one or more embodiments of the invention;

FIGS. 26(a)-(b) depict a Bluetooth audio-visual hearing aid and Bluetooth audio-visual auditory implant, in accordance with one or more embodiments of the invention;

FIGS. 27(a)-(b) depict a wireless audio-visual hearing aid, audio-touch hearing aid, and/or an audio-visual-touch hearing aid, in accordance with one or more embodiments of the invention;

FIGS. 28(a)-28(c) depict a New Music Trainer, in accordance with one or more embodiments of the invention; and

FIGS. 29(a)-29(c) depict a Pocket Wireless Tinnitus Treatment Device, in accordance with one or more embodiments of the invention.

### DETAILED DESCRIPTION OF THE INVENTION

### Definitions

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive. Similarly, “combinations of A, B, and C” shall mean a set including A, B, C, (A, B), (A, C), (B, C), (A, B, C). Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics can be combined in any suitable manner on one or more embodiments without limitation.

As used herein, both of the terms “audio” and “audio material” shall mean sound, speech, voice, music, song, melody, instrumental music, concerto, sonata, audio book, digital radio, puretone, complex tone, physiological stimulus, or any combinations of the above. The term “iSOUP audio material” shall mean the audio material that is created by iSOUP technique.

As used herein, the term “all standard sizes” shall mean 3/32 inch (2.5 mm), ⅛ inch (3.5 mm), 0.21 inch (5.3 mm, used in fire safety communications and 16 mm projector speakers), and ¼ inch (6.3 mm).

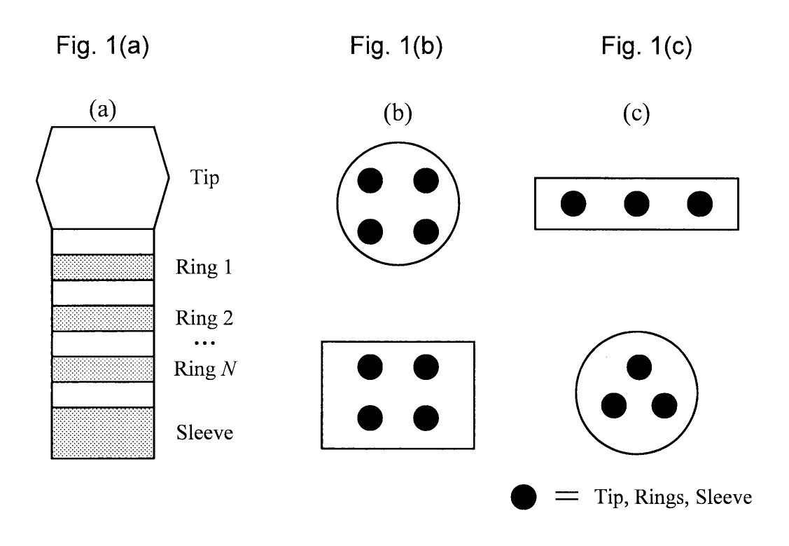

As used herein, the term “jack” shall mean a female connector that is one of the following types: (1) three-contact TRS (Tip-Ring-Sleeve) connector in all standard sizes, e.g. its 3.5 mm version in common stereo headphones, and its 2.5 mm version in cell phone headsets (providing a mono output plus a microphone input); (2) two-contact TS (Tip-Sleeve) connector in all standard sizes; (3) four-contact TRRS (Tip-Ring-Ring-Sleeve) connector in all standard sizes, e.g. its 2.5 mm version in cell phone stereo headsets (providing a stereo output plus a microphone input), its 3.5 mm version in compact camcorders (providing stereo plus a video signal), and its use of contacts for power supply of certain audio players; (4) five-contact TRRRS (Tip-Ring-Ring-Ring-Sleeve) connector in all standard sizes; (5) two-pin “310 connector” that consists of two TRS plugs (or jacks) with a standard spacing, e.g. its use in armrests of airplanes and in patch panels of telephone central offices; (6) same-shape connector as the above (1)-(5) but having more than 5 contacts, as shown in FIG. 1-(a); (7) same-shape connector as the above (1)-(6) but have a size different from all standard sizes; (8) same-shape connector as the above (1)-(7) but having different signal assignment, e.g. signal ground is intentionally assigned to Tip, although it is typically assigned to Sleeve; (9) connector having the same functionality as (1)-(8) but different size or different shape, e.g. two examples (as two variations of TRRS connector) are shown in FIG. 1-(b), while another two examples (as two variations of TRS connector) are shown in FIG. 1-(c); and (10) any combinations of the above (1)-(9). The term “plug” shall mean a male connector that fits with a jack defined by (1)-(10). The term “multichannel jack (or plug)” shall mean a jack (or plug) having more than one channel. In certain embodiments of the present invention, one contact of a multichannel jack (or plug) can be used as a power supply. The term “telecoil” shall mean a miniature device that picks up magnetic sound signals.

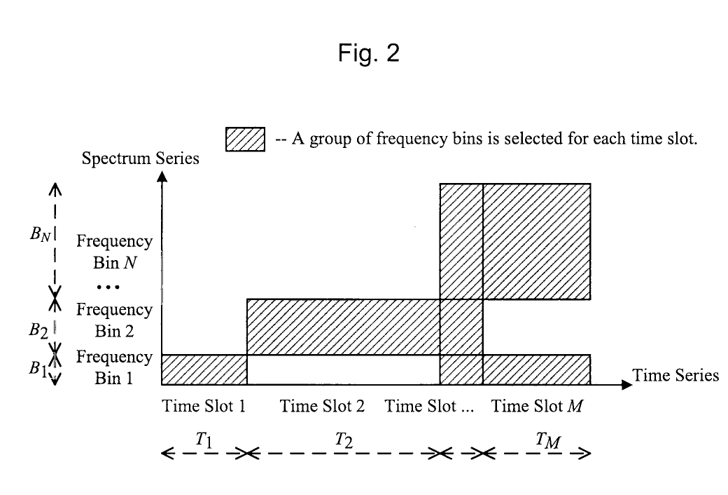

FIG. 1(a) depicts one embodiment of a multichannel audio plug with more than 5 contacts (Tip, Ring 1, Ring 2, . . . , Ring N, and Sleeve). FIG. 2(b) depicts two variations of TRRS connector, according to one embodiment. FIG. 2(c) depicts two variations of TRS connector, where a black solid disc means either a socket or a pin.

As used herein, the term “transmitter” shall mean a MP3 player, MP4 player, WMA player, WAV player, CD player, computer, cell phone, loudspeaker, iPod™, iPhone™, PDA (Personal Digital Assistant), handheld computer, amplifier's output, camcorders, tape player, MD (MiniDisc), Hi-MD, electric instruments (e.g. guitars, keyboard, and organs), professional console, audio mixing desk, walkman, AM/FM radio, telecoil, modular synthesizer, or any combinations of the above. The term “audio player” shall be equivalent to a transmitter. The term “receiver” shall mean a microphone, headphone, headset, earphone, earpiece, earset, computer, cell phone headset, canalphone, audio recorder, PDA, handheld computer, amplifier's input, hearing aid, auditory implants, hydrophone, camcorders, professional console, audio mixing desks, telecoil, effects processing device, camera flash synchronization input, or any combinations of the above. The term “transceiver” shall mean a device that is a combination of a transmitter and a receiver, either physically or functionally. The term “audio receiver” shall be equivalent to a receiver.

As used herein, the term “audio cable” shall mean an electrical line that belongs to one of the following categories:

Category 1: one end of the electrical line is either a jack (as defined herein) or a plug (as defined herein). The other end can be any connector that is different from a jack and a plug. Examples of the connector at the other end includes but is not limited to: (1) RCA (Radio Corporation of America) connector; (2) 0.173 inch Bantam TT (4.4 mm Tiny Telephone) connector; (3) a telecoil; (4) XLR (Cannon™ X-series-Latch-Rubber) connector; (5) a transmitter; (6) a receiver; or (7) TOSLINK™ connector;

Category 2: one end of the electrical line is a jack or a plug, the other end is a jack or a plug, and both ends have either same or different size;

Category 3: the electrical line is made of a bundle of parallel lines. Each of the parallel lines belongs to Category 1 or 2;

Category 4: the electrical line is made of a concatenation of serial lines. Each of the serial lines belongs to Categories 1, 2, or 3; and

The “audio cable” defined above can be mono, stereo, or multichannel, either shielded or unshielded, either unidirectional or bidirectional, and either plated or not.

As used herein, “Bluetooth™” shall mean IEEE Standard 802.15.1 that utilizes wireless communications from fixed and mobile devices, creating wireless personal area networks (PANs). The use of “Bluetooth™” in one embodiment does not mean the embodiment is bound only with Bluetooth™ technology. However, said use shall mean the embodiment can also be freely integrated with any wireless technology that provides similar wireless connectivity. As used herein, the term “relevant wireless technologies” shall mean Zigbee™, RFID™ (Radio-Frequency IDentification), WiFi™, WiMax™, ANT wireless network, FM (Frequency Modulation) system, AM (Amplitude Modulation) system, PM (Phase Modulation) system, any system using one of relevant modulation schemes (as defined herein), or any existing or customized wireless techniques. The term “wireless audio receiver” shall mean a device in which Bluetooth™ or one of relevant wireless technologies is incorporated with an audio receiver as defined herein. The term “wireless audio transmitter” shall mean a device in which Bluetooth™ or one of relevant wireless technologies is incorporated into an audio transmitter as defined herein.

As used herein, both of the terms “wireless connection” and “wireless audio connection” shall include four types of wireless transmission: active, passive, semi-passive (a.k.a. semi-active) and beacon. The active type can use an existing or customized wireless technique to transmit continuous audio stream or audio burst, e.g. Bluetooth™, Zigbee™, active RFID™ (Radio-Frequency IDentification), WiFi™, WiMax™, ANT wireless network, FM (Frequency Modulation) system, AM (Amplitude Modulation) system, PM (Phase Modulation) system, any system using one of relevant modulation schemes (as defined herein), or any existing or customized wireless techniques. The passive type (e.g. passive RFID™) requires no power or battery, only active when a transmitter is nearby to power it by wireless illumination, whereas the semi-passive type requires a limited power source. The beacon type transmits autonomously with a certain blink pattern and does not respond to a query of a wireless transmitter.

As used herein, the term “over-the-air audio connection” shall mean sound wave free-field transmission, wherein audio material is played over free-field air or other gases, or through an acoustic tube, from where a receiver (e.g. a microphone) picks it up. The term “underwater audio connection” shall mean a sound wave propagation underwater, which is detected by a receiver, e.g. a human ear underwater or a hydrophone.

As used herein, the term “network” shall mean a collection of transmitters, receivers, transceivers, plugs/jacks, audio splitters, adders, multipliers, mixers, modulators, audio adaptors, extension cables, telecoils, and/or computers, all of which are interconnected.

As used herein, the term “audio link” shall mean any of the following types: (1) audio cable; (2) wireless audio connection; (3) over-the-air audio connection; (4) underwater audio connection; (5) infrared audio connection; (6) optical audio connection; (7) mechanical conduction based audio connection; (8) audio connection over a network (that is constructed by the above (1)-(7) plus transmitters, receivers, transceivers, plugs/jacks, audio splitters, adders, multipliers, mixers, modulators, audio adaptors, extension cables, telecoils, and/or computers); and (9) any combinations of the above (1)-(8). When the “audio link” is used as a building block of an embodiment, the embodiment shall automatically have nine variations, where the nine variations are generated by substituting the “audio link” with each of the above (1)-(9). The present invention covers the nine variations. The term “communication link” shall mean an audio link or a logical connection through a network.

As used herein, the term “hybrid analog-digital information” shall mean a combination of both analog information and digital information, and shall include but is not limited to the four types: (1) uncorrelated type, in which digital information is independent of analog information; (2) simplified type, in which only digital information exists; (3) correlated type, in which the content of digital information is dependent on analog information; and (4) combined type, in which two or three out of (1), (2), and (3) occur.

As used herein, the term “analog-digital information” shall include (1) digital information; and (2) hybrid analog-digital information as defined herein.

As used herein, the term “hearing aid” shall mean a device that is designed to amplify and modulate sounds for the wearer, where said device shall be body-worn, behind-the-ear (BTE), in-the-ear (ITE), mini BTE, receiver-in-the-ear (RITE), in-the-canal (ITC), mini-canal (MIC), completely-in-the-canal (CIC), open-fit (over-the-ear), or consumer programmable.

As used herein, the term “BTE/ITE device” shall be interpreted as a generic device whose type is behind-the-ear (BTE), in-the-ear (ITE), or one of their variations: mini BTE, RITE, ITC, MIC, CIC, open-fit, and consumer programmable. When the “BTE/ITE” is used in an embodiment, the embodiment shall be either BTE or ITE, and shall automatically have seven variations by substituting “BTE/ITE” with mini BTE, RITE, ITC, MIC, CIC, open-fit, or consumer programmable. The present invention covers the seven variations. The same interpretation shall be applied to “BTE/ITE hearing aid”, “BTE/ITE auditory implant”, and similar terms. An exception to this definition will occur only when a type and an embodiment are in some way inherently mutually exclusive.

As used herein, the term “auditory implant (AI)” shall mean a middle ear implant (MEI), bone conduction implant (BCI), vestibular implant (VI), cochlear implant (CI), hybrid cochlear/vestibular implant (HCVI), auditory nerve implant (ANI), auditory brainstem implant (ABI), auditory midbrain implant (AMI), or any combinations of the above.

As used herein, the term “bin” shall mean a frequency band. The term “slot” shall mean a piece of time duration along time axis. The terms “LP”, “BP”, and “HP” shall mean lowpass, bandpass, and highpass, respectively. The terms “AM”, “FM”, “PM”, “SSB modulation”, and “MC modulation” shall mean amplitude modulation, frequency modulation, phase modulation, single-sideband modulation, and multicarrier, respectively. The terms “OOK”, “FSK”, “ASK”, “PSK”, “QAM”, “MSK”, “CPM”, “PPM”, and “OFDM”, shall mean on-off keying, frequency-shift keying, amplitude-shift keying, phase-shift keying, quadrature amplitude modulation, minimum-shift keying, continuous phase modulation, pulse-position modulation, and orthogonal frequency-division multiplexing, respectively. The terms “relevant modulation schemes” shall include AM, FM, PM, SSB modulation, MC modulation, 00K, FSK, ASK, PSK, QAM, MSK, CPM, PPM, and OFDM.

As used herein, the term “time-frequency series” shall mean a signal that consists of a series of time slots in time-domain. In each time slot, a set of frequency bins is selected. Once a frequency bin is selected, either a sinusoid wave or a predefined bandpass waveform is added as a basic component onto a composite signal. In the end, all the components selected, are added together to form the composite signal. For next slot, another set of components form the composite signal.

FIG. 2 depicts one embodiment of a time-frequency (TF) series, where a group of frequency bins is selected for each time slot. As shown in FIG. 2, the lengths of time slots can be different, and the bandwidths of frequency bins can also be different. The term “parameter vector” of a time-frequency series shall mean a minimal group of digital parameters that can completely generate the time-frequency series. Still referring to FIG. 2, each hatched rectangle shall mean a basic component that spans one time slot, where the basic component can be a bandlimited signal, white bandlimited noise, spectrum-shaped bandlimited noise, AM/FM/PM/SSB signal, puretone, multi-tone, complex tone, notch signal, comb signal, or a signal modulated by any of relevant modulation schemes. The term “basic time-frequency block” shall mean the foregoing basic component of one time slot on one frequency bin, i.e. a hatched rectangle shown in FIG. 2.

As used herein, the term “stereo imaging” shall mean a listener can locate spatial locations of specific sound components and where each component (e.g. each instrument within a piece of concerto music) is coming from, both laterally and in depth. For mixed sound, the term concerns human imagination of the location of each component of the sound.

As used herein, the term “special effects” shall mean:

stereo imaging, chorusing, heavy low frequency effects, echo, and reverberation, as in theater, music hall, cinema, auditorium, performance, concerto, and sonata;

pitch shifting, phasing, flanging, and additive background sound (e.g. natural sea flows, winds, rains, or lullabies).

As used herein, the terms “normal-hearing (NH) user”, “unaided mild-to-moderately hearing-impaired (UMMHI) user”, “hearing aid (HA) user”, “cochlear implant (CI) user”, and “auditory implant (AI) user” shall respectively mean:

a person who has normal hearing;

a patient who has mild to moderate hearing loss but does not need to (or does not want to) wear a hearing aid (HA);

a patient who wears at least one hearing aid;

a patient who is implanted with at least one cochlear implant; and

a patient who is implanted with at least one auditory implant;

As used herein, the term “multisensory device” shall mean a device that processes one or more of audio, visual, taste, smell, touch, linear acceleration, rotary, and temperature information. The term “8-sensory device” shall mean a device that processes all of audio, visual, taste, smell, touch, linear acceleration, rotary, and temperature information. As used herein, assuming eight unordered elements are audio, visual, taste, smell, touch, linear acceleration, rotary, and temperature, the term “simplified multisensory combinations” of an 8-sensory device shall mean all 1-element combinations (having eight entries: audio, visual, taste, smell, touch, linear acceleration, rotary, and temperature), all 2-element mathematical combinations (having twenty-eight entries: audio-visual, audio-temperature, and other twenty-six), all 3-element mathematical combinations (having fifty-six entries: audio-visual-temperature and other fifty-five), all 4-element mathematical combinations (having seventy entries: audio-visual-temperature-smell and other sixty-nine), all 5-element mathematical combinations (having fifty-six entries: audio-visual-temperature-smell-taste and other fifty-five), all 6-element mathematical combinations (having twenty-eight entries: audio-visual-temperature-smell-taste-rotary and other twenty-seven), and all 7-element mathematical combinations (having eight entries: audio-visual-temperature-smell-taste-rotary-linear-acceleration and other seven). In summary, said term “all simplified multisensory combinations” shall comprise 254 entries.

The term “multiple human sensory receptors” shall mean human sensory receptors that can perceive vision, audition, taste, smell, touch, linear acceleration, spinning, and temperature information, including photoreceptor, mechanoreceptor, olfactoreceptor, gustatoreceptor, gravity sensitive receptor, and thermoreceptor.

As used herein, the term “hearing diseases” shall mean diseases that affect normal functionality of auditory system. Said term includes but is not limited to Meniere's disease, auditory hallucination, conductive hearing loss, sensorineural hearing loss, combined hearing loss (conductive and sensorineural), otosclerosis, tinnitus, and presbycusis.

As used herein, the term “neurological disorders” shall mean insomnia, depression, stroke, brain damage, schizophrenia, dementia, Multiple Sclerosis (MS), Parkinson's disease, neuralgia, chronic pain, phantom pain, paralysis, Alzheimers, and brain disorder diseases.

As used herein, the term “feature information” shall mean energy, rms (root-mean-square) value, magnitude spectrum, phase spectrum, spectrogram, intensity, pitch, formants (F1, F2, F3, F4, F5, and F6), slope of pitch, interval of pitch, contour of pitch, rhythm, onset time-points, sound source location, sensory type, sensory location, sensory duration, mean (1^{st} central moment), standard deviation (2^{nd} central moment), skewness (3^{rd} central moment), kurtosis (4^{th} central moment), high-order central moments, cumulants, and/or any statistical characteristics.

As used herein, the term “fitting” shall mean personalizing and/or customizing a device for a specific user. The term “refitting” shall mean reconfiguring and/or reprogramming a device for a specific user. The terms “mapping” and “remapping” shall be equivalent to “fitting” and “refitting”, respectively.

As used herein, the term “healthcare provider” shall mean a doctor, a medical consultant, a healthcare providing clinic/hospital, a technician, or a person/entity that is authorized to test, diagnose, or treat a patient.

As used herein, the term “relevant encryption algorithms” shall mean AES (Advanced Encryption Standard), DES (Data Encryption Standard), Hash Transform, Triple-DES, RSA (Rivest-Shamir-Adleman), DSA (Digital Signature Algorithm), Cramer-Shoup Cryptosystem, ElGamal Encryption, WEP (Wired Equivalent Privacy), and any existing encryption algorithm.

As used herein, the term “iSOUP Box” shall mean a processing module that provides iSOUP (Inaudible Synchronous Online User-optimized Processing) functionalities. An iSOUP Box shown hereafter as a separate building block of a figure does not necessarily mean the Box must be standalone. Said iSOUP Box can be a standalone device or can be integrated as a part into a system. The term “iSOUP device” shall mean a device that includes an iSOUP Box.

As used herein, the term “terminal” shall mean a computer provides Internet access.

As used herein, the term “LCD” shall mean Liquid Crystal Display technique, while the term “relevant display technologies” shall mean Cathode Ray Tube (CRT), Digital Light Processing (DLP), Field Emission Display (FED), Light-Emitting Diode (LED), Liquid Crystal On Silicon (LCOS), Organic Light-Emitting Diode (OLED), Plasma Display Panel (PDP), Surface-conduction Electron-emitter Display (SED), Vacuum Fluorescent Display (VFD), or any combinations of the above.

As used herein, the term “relevant visual images” shall mean a progress bar, a flashing arrow, a digital number, a letter/word, a light, a light array, a transient flashing effect, an image, or any other content being displayed.

System Architecture

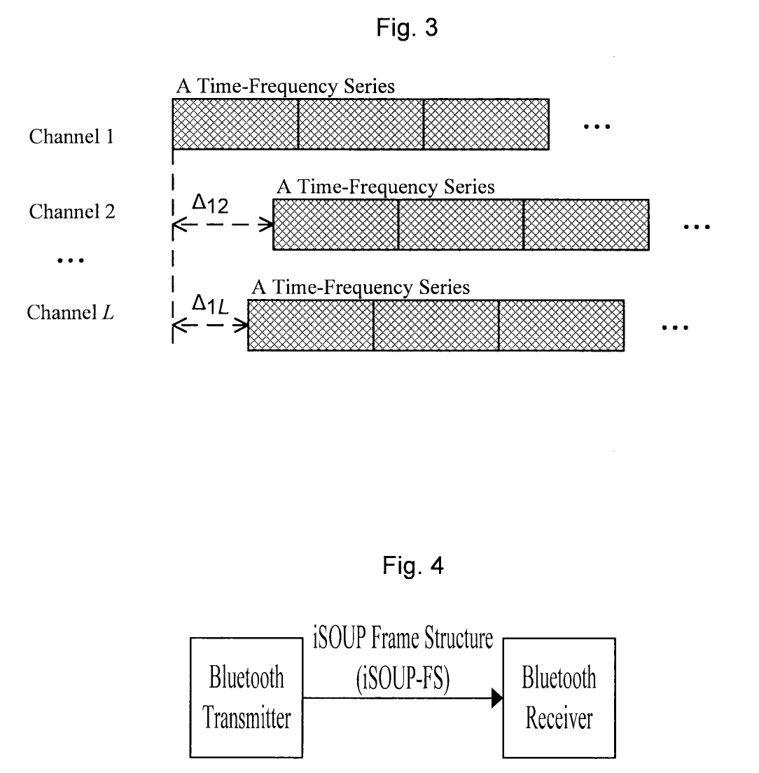

The basic building block of the present invention is a “multichannel time-frequency series”, which is constructed by a group of foregoing time-frequency (TF) series over a multichannel audio link. FIG. 3 depicts one embodiment of a multichannel time-frequency (MCTF) series, where the timing offsets of Δ12, . . . and Δ1L can be different across L channels. As shown in FIG. 3, the timing offset between each two TF series can be different as Δ₁₂, . . . , Δ_{1L}. The timing offset can be positive or negative. If the offset is positive, that means delay; otherwise, that means advance. As used herein, the term “stereo time-frequency (TF) series” shall mean a two-channel case of said multichannel time-frequency (MCTF) series.

In the present invention, iSOUP (Inaudible Synchronous Online User-optimized Processing) is a method that uses a multichannel time frequency series through transmitters, audio links, and receivers to jointly transmit and process digital information or hybrid analog-digital information, where the method comprises the following eights components: iSOUP-FS (Frame Structure), iSOUP-TP (Topology), iSOUP-UOP (User Optimization Procedure), iSOUP-IUP (Internet Update Procedure), iSOUP-IHP (Internet Healthcare Procedure), iSOUP-AEP (Algorithm Enhancement Procedure), iSOUP-IAP (Inaudibility Procedure), and iSOUP-BFRP (Bias-Free Random Procedure).

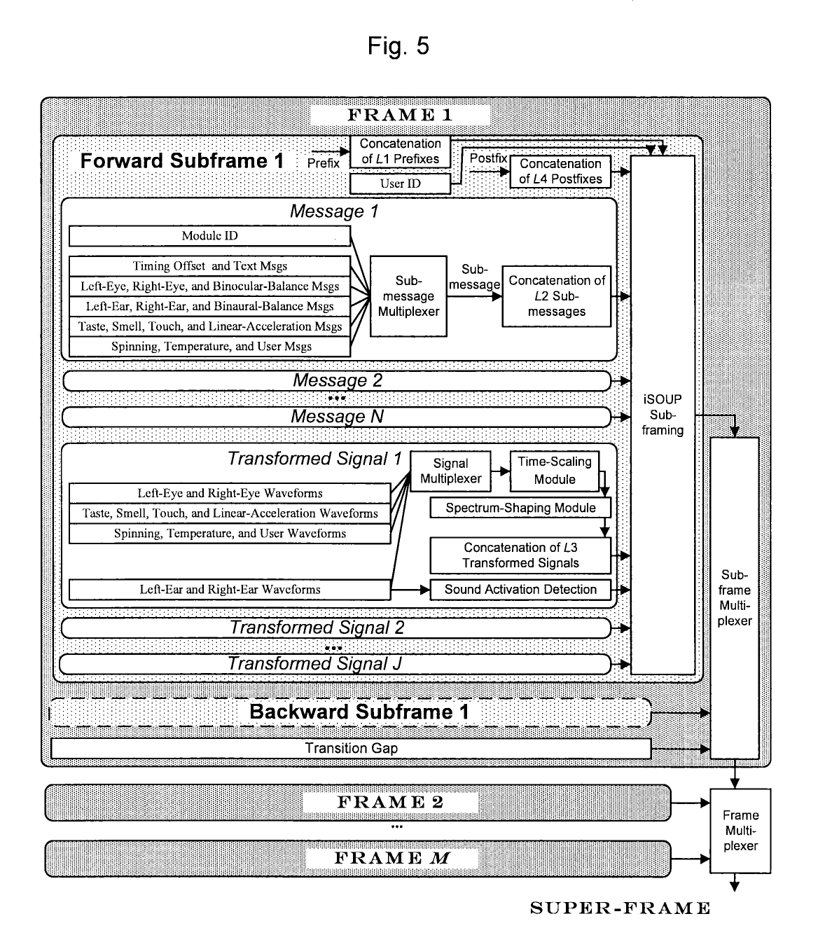

Referring to FIG. 5, iSOUP-FS (Frame Structure) consists of Prefix, Message, T-Signal (Transformed-Signal), and Postfix. Prefix and Postfix are user predefined waveforms that are unique for user identification. In certain embodiments, one of Prefix, Message, T-Signal and Postfix, or two or three of them, can be removed for simplification, e.g. Postfix is not used in certain embodiments. Prefix consists of a multichannel time-frequency series of FIG. 3, and so does Postfix.

Message comprises feature information and/or user information. The feature information can be but is not limited to energy, rms, magnitude spectrum, phase spectrum, spectrogram, intensity, pitch, formants (F1, F2, F3, F4, F5, and F6), slope of pitch, interval of pitch, contour of pitch, rhythm, onset time-points, sound source location, sensory type, sensory location, sensory duration, mean, standard deviation, skewness, kurtosis, high-order central moments, cumulants, and/or any statistical characteristics. The user information can be but is not limited to User ID, Serial Number, Music ID, relative amplitudes, delays, program selection, timer, digital volume control, direction of listening (with directional microphones), music/speech/noisy/environmental/directional/omnidirectional/automatic mode selection, sensitivity control, battery remote turn-off/turn-on, production date, distribution date, reproduction date, purchase date, purchase store, user class, bar code, and/or User Msg. The User Msg includes but is not limited to index of frequency bin, electrode index, FIR/IIR filter coefficient, subchannel gain, audible threshold (THL), most comfortable level (MCL), windowing function, compression function, and/or block size of input/processing/output. Message is digital, more accurate and more concise than conventional waveform. For example, digital pitch is more accurate and more concise than conventional analog waveform being obtained by filtering between 50 Hz and 500 Hz. T-Signal is a copy of an original analog waveform, a compressed version of the waveform, an expanded version of the waveform, or a filtered version of the waveform.

In more detail, still referring to FIG. 5, Prefix can be a time series, a spectrum series, a time-frequency series (of FIG. 2), or a multichannel time-frequency series (of FIG. 3). In accordance to FIG. 2, a time-frequency series comprises two dimensions of time axis and spectral axis. For each time slot, a group of frequency bins is selected and added together for emission. The lengths of time slots are generally different as are the bandwidths of frequency bins.

In further detail, still referring to FIG. 5, User ID can change over frames, which forms a multiuser sharing system. In said system, User ID can be used for user-unique identification, e.g. its use in inaudible copyright protection.

iSOUP Frame Structure (iSOUP-FS) can be transmitted through a wireless audio connection. For example, as shown in FIG. 4, a wireless audio connection is formed from a Bluetooth Transmitter to a Bluetooth Receiver. iSOUP-FS is delivered through the wireless audio connection.

Topology describes the required connectedness of iSOUP. iSOUP-UOP (User Optimization Procedure) is a part that optimizes the configuration of an iSOUP device for a specific user. iSOUP-IUP (Internet Update Procedure) is a part that updates the processor parameter, program, core, or operating system of an iSOUP device, simply through an audio link plus Internet. iSOUP-IHP (Internet Healthcare Procedure) is a part that runs remote healthcare, remote measurement, remote diagnosis, and/or remote treatment, simply through an audio link plus Internet. iSOUP-AEP (Algorithm Enhancement Procedure) is a part that enhances performance of an existing algorithm in real time. iSOUP-IAP is a part that makes Prefix, Message, and Postfix inaudible.

Frame Structure

Referring to FIG. 5, a super-frame comprises a number of frames, namely Frame 1, Frame 2, . . . , Frame M, where Frame m (1≦m≦M) is bidirectional and composed of the m-th Forward Subframe and the m-th Backward Subframe. The m-th Forward Subframe consists of a concatenation of L₁ Prefixes, a User ID, and a concatenation of L₄ Postfixes, N Messages, and J T-Signals (Transformed-Signal). A Message comprises a concatenation of L₂ Sub-messages, each of which comes out of a Sub-message Multiplexer that pipelines all or part of Module ID, Timing Offset Msg, Text Msg, Left-Eye Msg, Right-Eye Msg, Binocular-Balance Msg, Left-Ear Msg, Right-Ear Msg, Binaural-Balance Msg, Taste Msg, Smell Msg, Touch Msg, Linear-Acceleration Msg, Spinning Msg, Temperature Msg, and User Msg (e.g. mode selection or user control command). Still Referring to FIG. 5, a “Time-Scaling Module” provides the following functionality: when the input original signal is x(t), the output is a signal y(t)=x(rt), where r is the factor of time-scaling; and therefore, T-Signal becomes a Compressed Signal if r>1, a copy of the original signal if r=1, or an Expanded Signal otherwise. As shown in FIG. 5, the Time-Scaling Module takes the outcome of the Signal Multiplexer that arranges Left-Eye Waveform, Right-Eye Waveform, Left-Ear Waveform, Right-Ear Waveform, Taste Waveform, Smell Waveform, Touch Waveform, Linear-Acceleration Waveform, Spinning Waveform, Temperature Waveform, and User Waveform. In certain embodiments, a “Spectrum-Shaping Module” is needed to optimize the spectral shape of y(t) for a specific user. Here, the output signal of the Spectrum-Shaping Module is z(t)=y(t)* y(t)*hₛₛ(t), being a convolution of the signal y(t) (coming out of the Time-Scaling Module) with a spectrum-shaping filter hₛₛ(t).

T-Signal is composed of a concatenation of L₃ signals z(t), which comes from the Spectrum-Shaping Module. In the end, J T-Signals are combined with N Messages, L₁ Prefixes, and L₄ Postfixes by the iSOUP Subframing module and the Sound Activation Detection (SAD) module of FIG. 5. The SAD can also be silence detection, gap detection, or onset detection. The SAD module can detect the silence gaps within the original waveform so that a transmitter enabled by the SAD, only transmits inaudible digital messages during the silence gaps. To that end, a SAD-frame takes the role of transmitting digital Message, Prefix, and Postfix at inaudible low levels during the silence gaps.

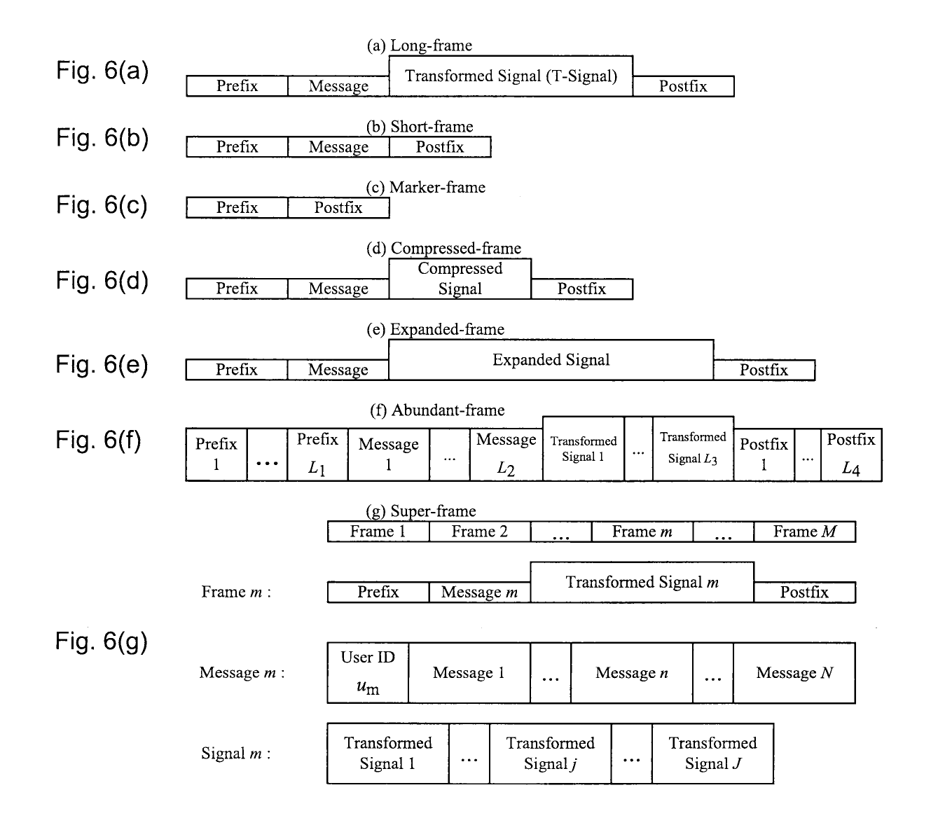

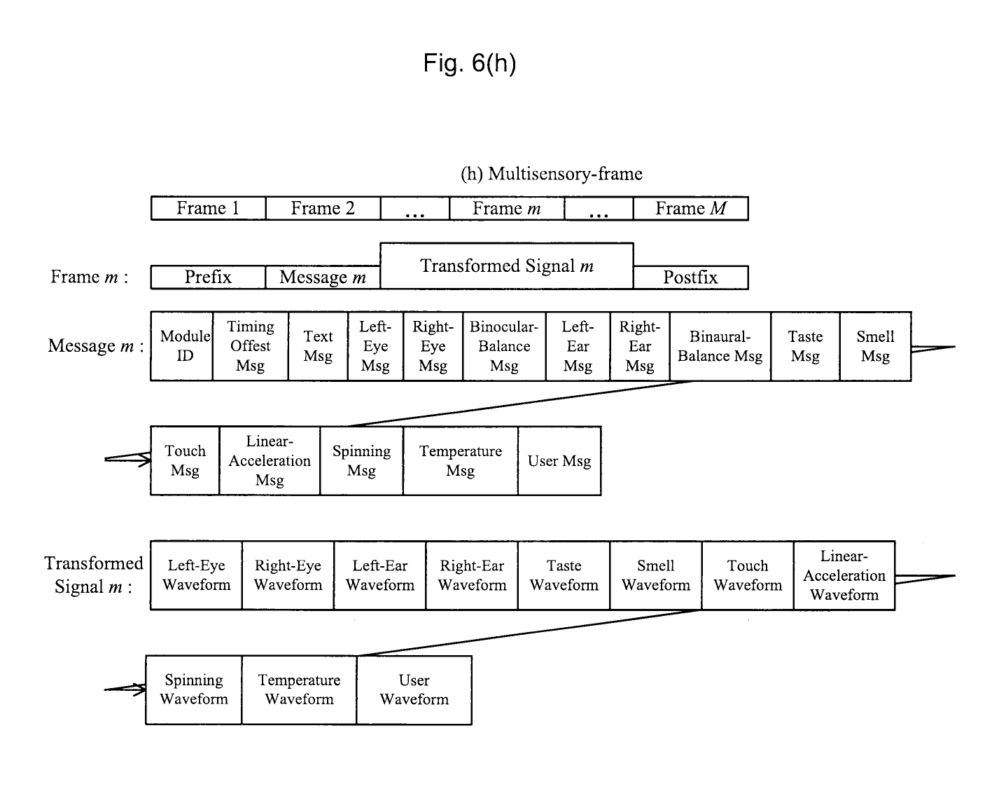

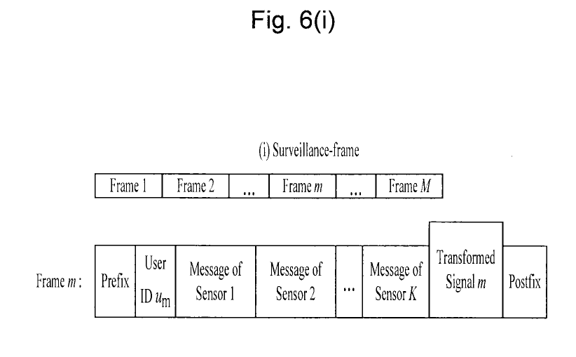

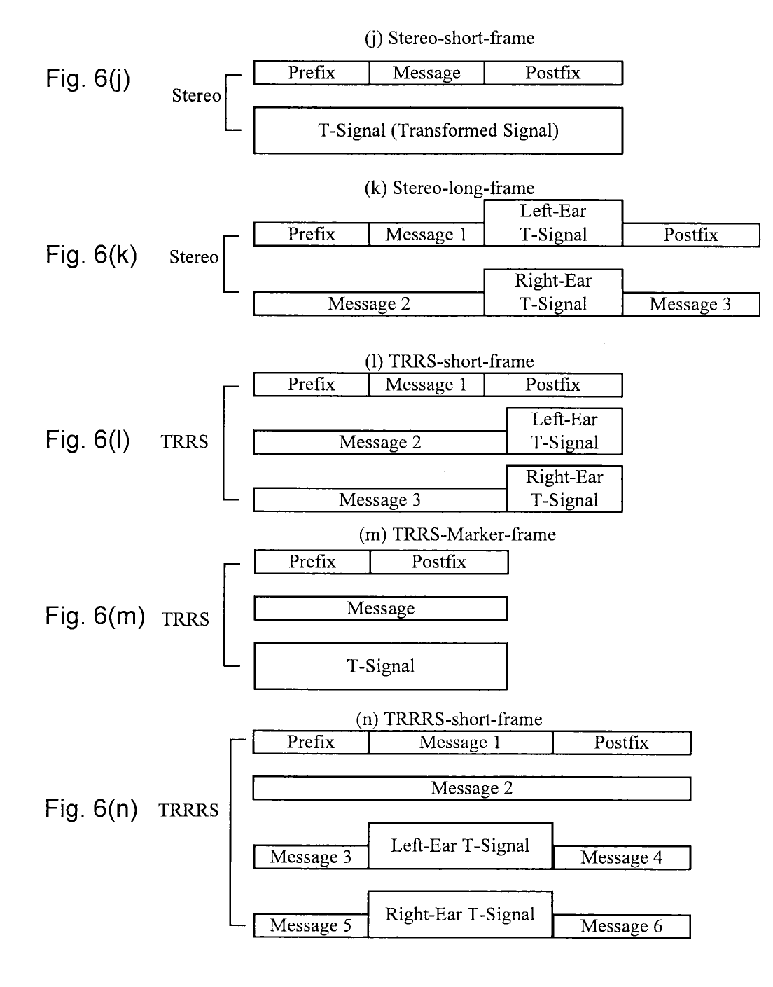

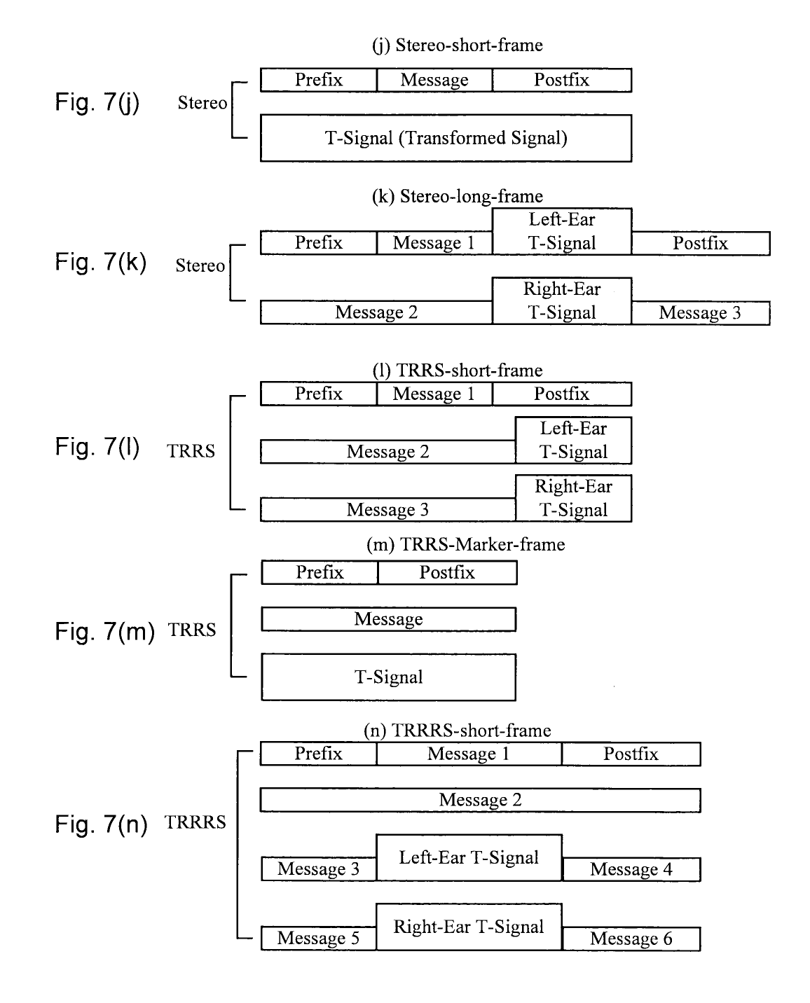

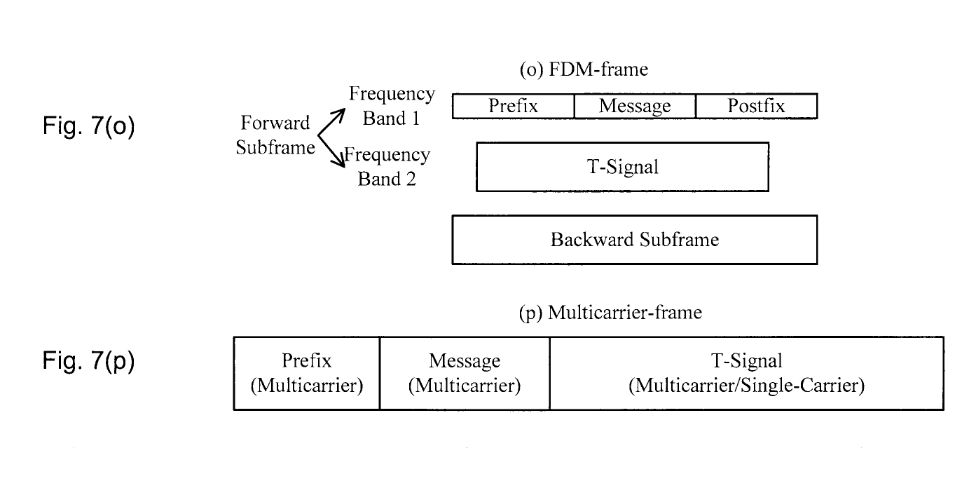

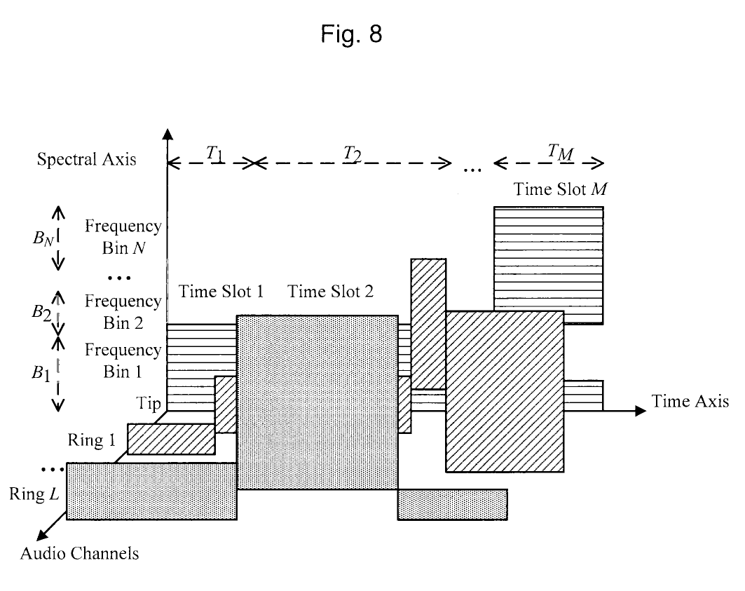

Based on FIG. 5, a plurality of simplified variations of iSOUP-FS (Frame Structure) is shown in FIG. 6 as: (a) long-frame, (b) short-frame, (c) marker-frame, (d) compressed-frame, (e) expanded frame, (f) abundant-frame, (g) super-frame, (h) multisensory-frame, and (i) surveillance-frame. In a plurality of embodiments for stereo and multichannel audio links, there are stereo-short-frame, stereo-long-frame, TRRS-short-frame, TRRS-marker-frame, TRRRS-short-frame, FDM-frame (Frequency Division Multiplexing), and TFS (time-frequency-space) stream-frame in use, as shown in FIG. 7(j)-(o) and FIG. 8, respectively.

Still referring to FIG. 5, inherent bidirectional structure of iSOUP-FS can use TDD (time division duplex) to transmit a Forward Subframe and a Backward Subframe in two directions, respectively. Between the two Subframes, the Transition Gap is used to provide time for transition. In certain embodiments, as shown in FIG. 7-(o), TFS (time-frequency-space) stream-frame provides advanced FDM (Frequency Division Multiplexing) capability to transmit Prefix, Message, T-Signal, and/or Postfix in parallel over multiple frequency bands and multiple time slots. In one embodiment, a Forward Subframe is a flow of user control command, mode selection, and parameter through an audio link, while a Backward Subframe is a simultaneous flow of telemetry measurements through the same link, e.g. body resistance, capacitance, inductance, current, voltage, and electromagnetic field distribution, and human response. Because both Subframes are simultaneous in time, this inherent structure provides real-time capability of instantaneous backward measurement upon the stimulation of a Forward Subframe. In another embodiment, simultaneous fitting and telemetry are performed through one audio link.

In accordance with iSOUP-FS (Frame Structure), digital transmission can use short-frame, while long-frame, compressed-frame, expanded-frame, and abundant-frame, can be used for hybrid analog-digital transmission. Super-frame can be used for a multiuser sharing system.

In certain embodiments, a Backward Subframe can be removed by setting its time duration to zero so that iSOUP-FS changes into unidirectional. In one embodiment, Text Msg of iSOUP is used for displaying caption and lyrics.

Now referring to FIG. 6-(a), long-frame offers a hybrid analog-digital transmission based on Prefix, Message, T-Signal, and Postfix, where T-Signal (Transformed Signal) is a copy of the original analog signal (e.g. input sound) when the factor of time-scaling is 1. Message bears digital feature information and/or digital user information. In FIG. 6-(b), short-frame offers a 100% digital transmission.

Referring to FIG. 6-(c), marker-frame provides a time marker to synchronize multiple devices. Right on the time point that said multiple devices capture the frame, said devices take actions simultaneously. In compressed-frame of FIG. 6-(d), T-Signal becomes a Compressed Signal r times shorter in length than the original signal. In a plurality of embodiments, based on the structure of FIG. 6-(d), the original analog signal can be time-scaled into a half-length T-Signal, while Prefix, Message, and Postfix are padded into the other half length. Thus, hybrid analog-digital transmission spends the same time as the original analog transmission. Therefore, this type of compressed-frame changes real-time analog signal into real-time hybrid analog-digital signal. In a plurality of embodiments, this type of compressed-frame can be used in a real-time algorithm accelerator for iSOUP-AEP (Algorithm Enhancement Procedure).

Now referring to FIG. 6-(e), expanded-frame offers an inverse functionality of compressed-frame to match a low-rate device. In FIG. 6-(f), abundant-frame provides multiple Prefixes (L₁), multiple Messages (L₂), multiple T-Signals (L₃), and multiple Postfixes (L₄), and increases throughput within a frame. In certain embodiments, one or more of L₁, L₂, L₃, and L₄ can be set as 1. In FIG. 6-(g), super-frame offers: (1) continuous frame-by-frame transmission for one user when User ID keeps the same; and (2) interleaved multiuser sharing system when User ID changes over frames.

Multisensory-Frame and Surveillance-Frame

Referring to FIG. 5 and FIG. 6-(h), multisensory-frame aims at eight human sensory receptors. In multisensory-frame, Timing Offset Msg is used to adjust the stimulation times of the successive Left-Eye Waveform, Right-Eye Waveform, Left-Ear Waveform, Right-Ear Waveform, Taste Waveform, Smell Waveform, Touch Waveform, Linear Acceleration Waveform, Spinning Waveform, Temperature Waveform, and User Waveform. The adjustment compensates the different response times of the eight human sensory receptors based on the fact that: different human sensory receptors typically have different response times in the order of 200 ms for photoreceptor, 160 ms for auditory mechanoreceptor, 250 ms for olfactoreceptor, 400 ms for gustatoreceptor, 110 ms for touch mechanoreceptor, and 370 ms for pain receptor. The response times of gravity sensitive receptor and thermoreceptor are also different. Based on said adjustment, highest user feeling of integration of eight sensations is simultaneously achieved for highest entertainment and/or best treatment. In certain embodiments, audio-visual fusion is achieved as a simplified version of integration of the eight sensations.

Still referring to FIG. 6-(h), a user can use a number of devices, each of which has a unique identifier, namely Module ID of FIG. 6-(h). Human feelings of said multiple devices is synchronously integrated in brain for highest performance.

In further detail, still referring to FIG. 6-(h), Timing Offset Msg is critical to achieve highest perception of human multisensory integration. Timing Offset Msg stores eight response times from offset. The response times are different from user to user. Even for a specific user, his response times change along with age. Thus, before the storage, measurements are performed to obtain personal up-to-date response times, which are used to achieve highest entertainment and/or best treatment. In medical applications, if a user has one or more sensorial diseases, he may experience irregular response times. In summary, the different response times, being caused by medical irregularity plus inter-user variability and intra-user time-variability, are measured by physiological and psychological tests. Then, optimal Timing Offset Msg is configured according to the test results.

Now referring to FIG. 6-(i), surveillance-frame can be used to collect measurements for electrical sensors mounted outside/inside human body, e.g. heart rate sensor and temperature sensor. As shown in FIG. 6-(i), Message k bears measurement data of Sensor k.

Multichannel Frame

In a plurality of embodiments, a jack/plug has more than one channel, e.g. stereo, three-channel, or more. Referring to FIG. 7-(j), stereo-short-frame takes advantage of left-channel and right-channel, where one channel transmits Prefix, Message and Postfix, while the other transmits T-Signal. Such a configuration offers inter-channel synchronicity and double throughput. As to FIG. 7-(k), stereo-long-frame transmits two T-Signals to form a stereo, along with Prefix, Message 1, Postfix through one channel, as well as Messages 2 and 3 through another channel. In certain embodiments of stereo-long-frame, Message 2 and/or Message 3 can be removed, while only Message 1 bears information.

Now referring to FIG. 7-(l), TRRS-short-frame offers stereo along with more throughput of transmitting Messages 1, 2, and 3, in which both left-ear and right-ear digital information can be stored. In FIG. 7-(m), TRRS-marker-frame can synchronize multiple devices on the time point that the multiple devices capture Prefix and Postfix. In TRRRS-short-frame of FIG. 7-(n), multiple Messages 1-6 can be delivered simultaneously. In certain embodiments, one or more of Message 2-6 of FIG. 7(j)-(n) can be removed for simplification.

Multicarrier-Frame

Multicarrier-frame aims at transmitting iSOUP Frame Structure (iSOUP-FS) through multiple (N) frequency bands. Multicarrier-frame is especially suited for frequency-selective audio link.

The structure of multicarrier-frame is as FIG. 8-(p), where “single-carrier” corresponds to a simplified multicarrier-frame with N=1. In FIG. 8-(p), Prefix and Message are transmitted through multicarrier, while T-Signal is transmitted through either multicarrier or single-carrier.

The N frequency bands can be orthogonal or overlapped. If they are overlapped, they are typically based on an OFDM (orthogonal frequency-division multiplexing) scheme.

TFS (Time-Frequency-Space) Stream-Frame

In certain embodiments, Prefix, Message, T-Signal (Transformed-Signal), and Postfix can be interleaved among multiple time slots, and transmitted over multiple frequency bands through multiple audio channels, as shown in Time-Frequency-Space (TFS) stream-frame of FIG. 8. FIG. 8 uses a multichannel audio cable as an example, where multiple (L+1) audio channels are manufactured as Tip and Rings 1 . . . L.

In certain embodiments, TFS (time-frequency-space) stream-frame can be used for one user. The structure of TFS (time-frequency-space) stream-frame has a basic block that is one time slot×one frequency bin×one channel. In said structure, an allocation array a(t, f , s) and a direction array d(t, f, s) are defined for the t-th time slot over f-th frequency bin through s-th audio channel:

$$a ( t , f , s ) = \{ \begin{matrix}0 , & not allocated \\ 1 , & prefix \\ 2 , & message \\ 3 , & left \text{-} ear signal \\ 4 , & right \text{-} ear signal \\ 5 , & postfix ;\end{matrix} \\ d ( t , f , s ) = \{ \begin{matrix}0 , & forward \\ 1 , & backward .\end{matrix} \qquad Eq . ( 1 )$$

where the direction array determines whether the basic block belongs to the Forward Subframe or the Backward Subframe.

In multiuser embodiments, TFS (time-frequency-space) stream-frame can be employed by multiple users. A multiuser allocation is formed by Eq. (2), where m(t, f, s) represents which user a basic block is allocated to. This structure can be used to control multiusers. Also, this structure can be used to compare multiusers when one user is a benchmark.

$$m ( t , f , s ) = \{ \begin{matrix}0 , & User 0 \\ 1 , & User 1 \\ ⋮ & ⋮ \\ N , & User N .\end{matrix} \qquad Eq . ( 2 )$$

Based on the allocation array, the basic blocks are allocated to Prefix, Message, T-Signal, and Postfix, respectively. In a plurality of embodiments, Pilot, Message, T-Signal, and Postfix are transmitted over different frequency bins, which make use of frequency division multiplexing (FDM) technique.

In a plurality of embodiments, a layered protocol stack is hierarchically placed on top of iSOUP-FS, where the protocol stack uses iSOUP-FS as physical layer and can include all or part of application layer, presentation layer, session layer, transport layer, network layer, and data link layer. To that end, one of relevant encryption algorithms can be applied, e.g. AES, DES, Hash Transform, Triple-DES, RSA, DSA, Cramer-Shoup Cryptosystem, ElGamal Encryption, and WEP. In a plurality of embodiments, iSOUP-FS is further built on top of Bluetooth or one of relevant wireless technologies, used as the lowest air interface.

In certain embodiments, one or more of Prefixes, Messages, T-Signals, and Postfixes in FIG. 5, FIG. 6(a)-(i), FIG. 7(j)-(o), and FIG. 8, can be removed for simplification. In certain embodiments, the power levels of Prefix and Message are intentionally increased to be audible.

iSOUP Frame Structure (iSOUP-FS) shall have permutation variations in which the time-domain order of placing Prefixes, Messages, T-Signals, and Postfixes is another permutation different from the order shown in FIG. 5, FIG. 6(a-i), FIG. 7(j-o), or FIG. 8. The present invention covers all the permutation variations.

Similarly, iSOUP-FS shall have permutation variations in which the time-domain order of placing Prefixes, Messages, T-Signals, Postfixes, Module ID, Timing Offset Msg, Text Msg, Left-Eye Msg, Right-Eye Msg, Binocular-Balance Msg, Left-Ear Msg, Right-Ear Msg, Binaural-Balance Msg, Taste Msg, Smell Msg, Touch Msg, Linear-Acceleration Msg, Spinning Msg, Temperature Msg, User Msg, Left-Eye Waveform, Right-Eye Waveform, Taste Waveform, Smell Waveform, Touch Waveform, Linear-Acceleration Waveform, Spinning Waveform, Temperature Waveform, and User Waveform, is another permutation different from the order shown in FIG. 5, FIG. 6(a-i), FIG. 7(j-o), or FIG. 8. The present invention covers all the permutation variations.

Topology

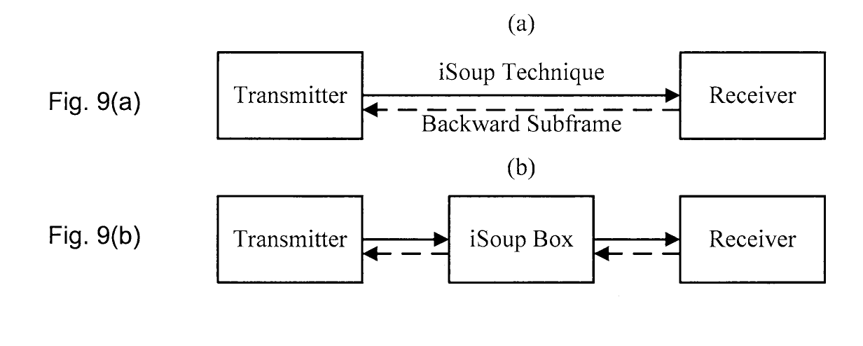

Referring to FIG. 9, there are two basic topologies: (a) integrated topology, where iSOUP-FS (Frame Structure) is transmitted through an audio link between a transmitter and a receiver; and (b) standalone topology, where iSOUP Box is used as a standalone device to stay between a transmitter and a receiver. In certain embodiments of standalone topology, a real-time stream, e.g. AM/FM radio, speech, and audio plus video, is played to iSOUP Box by the transmitter of FIG. 9-(b), where iSOUP Box takes the role of processing said stream and assisting receiver's enhancement of performance. Said assistance is performed by transmitting a compressed-frame from iSOUP Box to the receiver. To generate the compressed-frame, the original real-time stream is time-scaled down by a factor of r so that Message can occupy the idle gap between T-signals. The compressed-frame is critical in the embodiments.

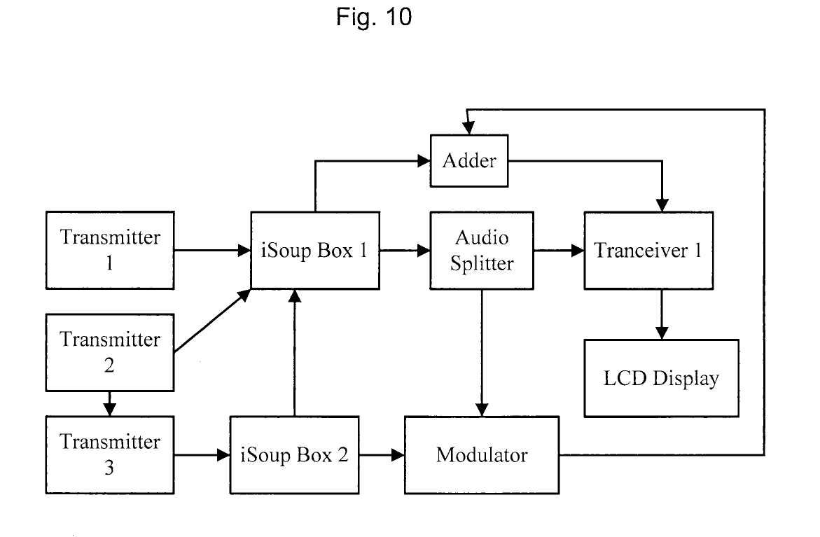

An iSOUP network is based on basic topologies. In a plurality of embodiments, an audio link can be a multi-hop path through said iSOUP network, e.g. the path from Transmitter 2 to Transceiver 1 in FIG. 10. Said iSOUP network can include the transmission of “many transmitters to one iSOUP Box” and “one iSOUP Box to many receivers”. In a plurality of embodiments, Bluetooth or one of relevant wireless technologies defined by herein can be used as an edge of said iSOUP network.

iSOUP-UOP

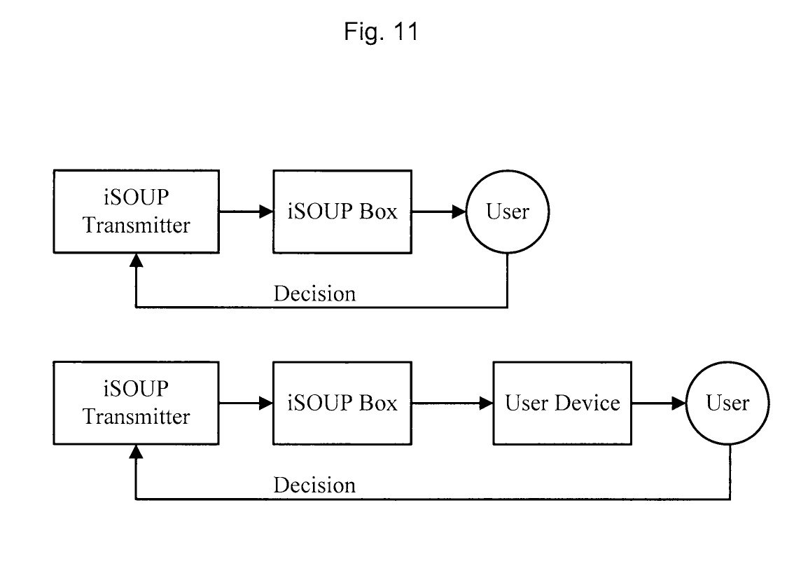

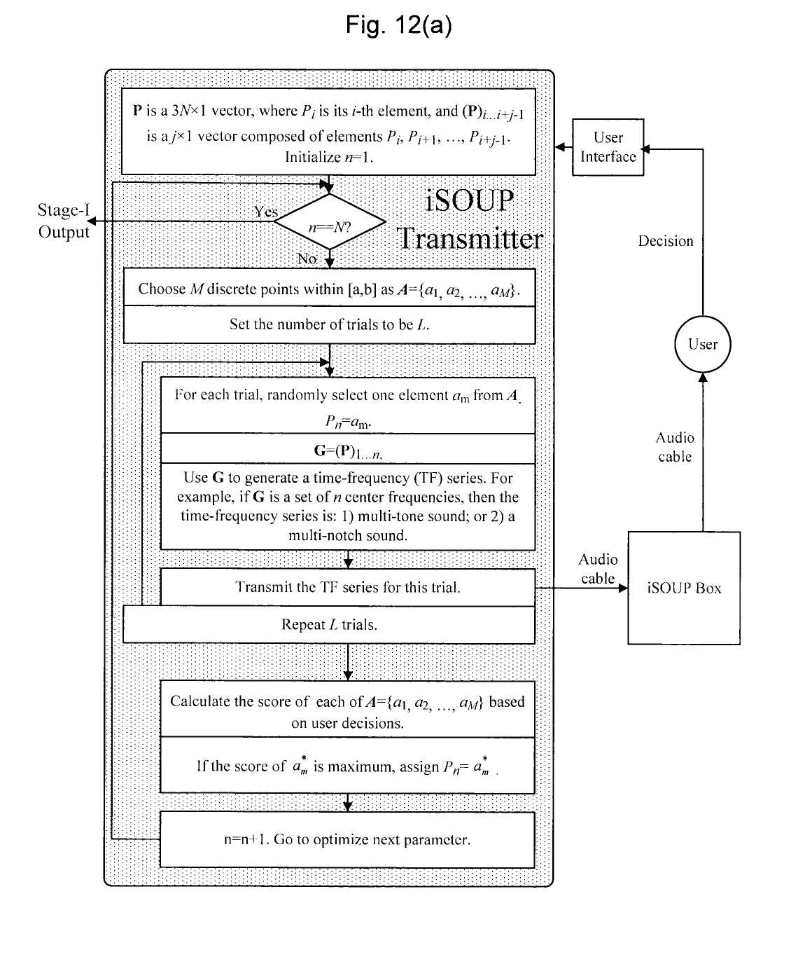

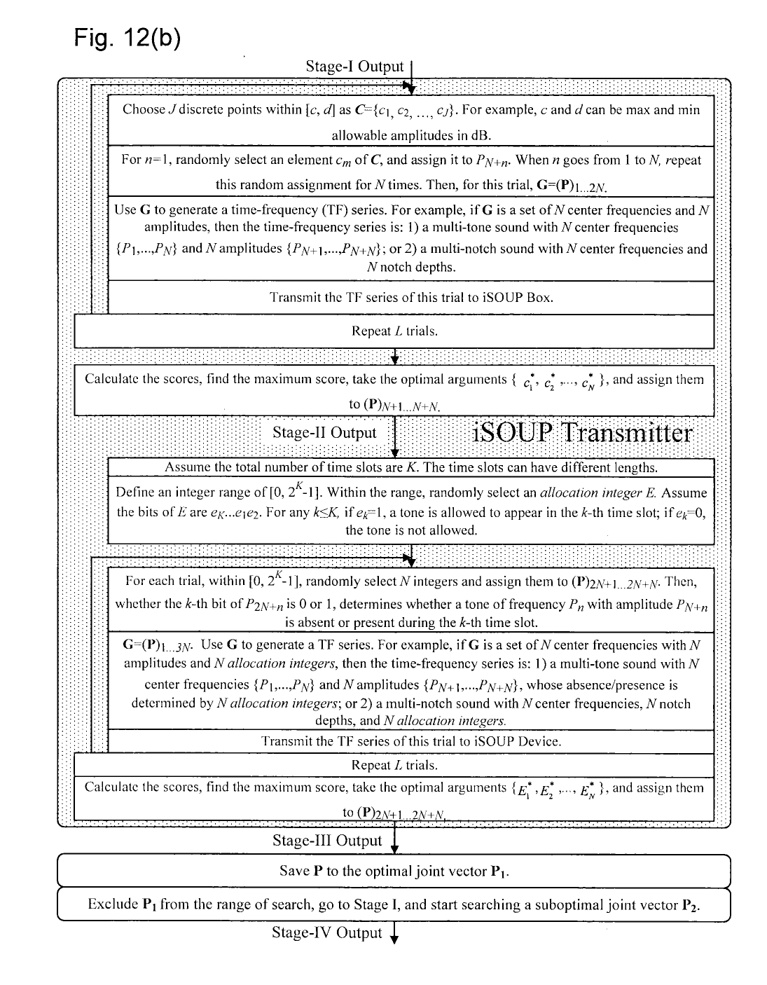

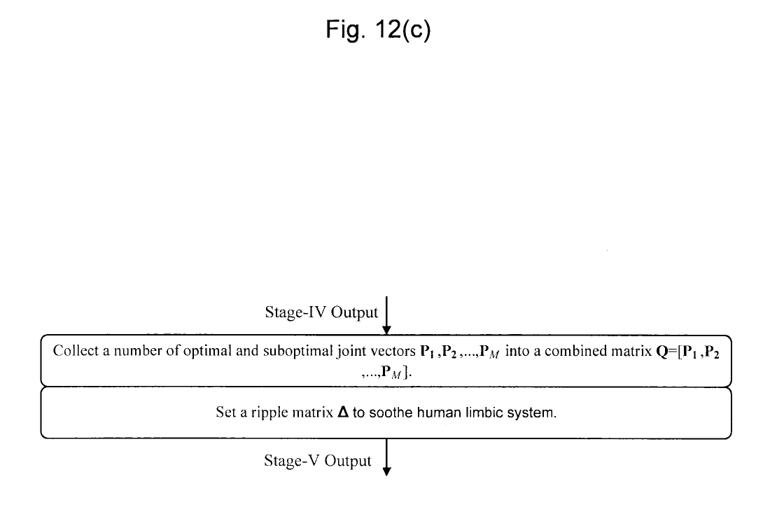

iSOUP-UOP (User Optimization Procedure) is a part that runs iSOUP-FS over iSOUP-TP (topology), where a user performs optimization through Stages I, II, III, IV, V, and VI and takes advantage of the personal characteristics of a human body system. The first five Stages I-V are shown in FIG. 11 and FIG. 12(a)-(c). The procedure acts as an optimizer working in two modes: (1) global optimization, where an optimal parameter is globally searched; and (2) local optimization, where a predefined point is designated by a user, or a finite set of candidate parameters are provided as prior knowledge. In the latter mode, iSOUP-UOP searches near the designated point or among the set of candidates. Referring to FIG. 11, which depicts one embodiment of top-layer framework of iSOUP-UOP, in order to complete said optimization, a decision shall be made by either of the following two methods: (1) a user makes his own decision; or (2) the reaction of a user is monitored by a machine to judge and generate a decision, e.g. positive or negative.

Referring to FIG. 11, a user makes a decision based on the output of iSOUP Box, which receives iSOUP-FS from an iSOUP transmitter directly (or indirectly via a user device). There are T types of parameters to be optimized (where T is an integer). For illustration, T is set to be 3 in FIG. (a)-(c), assuming three types of parameters are A, C, and E. The present invention covers the variations in which T is different from 3.

Referring to FIG. 12(a), the first five Stages I-V of iSOUP User Optimization Procedure (iSOUP-UOP) are depicted. In particular, Stage I searches the best set for A, e.g. A can be center frequencies on which a basic time-frequency block (of FIG. 2) centers. The basic time-frequency block can be (but is not limited to) one of the following types: a bandlimited signal, lowpass/highpass/bandpass signal, multi-pole/multi-zero/pole-zero signal, white bandlimited noise, spectrum-shaped bandlimited noise, AM/FM/PM/SSB signal, puretone, multi-tone, complex tone, multi-notch signal, multi-comb signal, or a signal modulated by relevant modulation schemes. The type that a specific user prefers can also be selected/changed during optimization.

Stage II (FIG. 12(b)) searches the best set for C, e.g. subband amplitudes. Stage III (FIG. (12(b)) searches the best set for E, e.g. usage of time slot. Stage IV stacks the three best sets into an optimal joint vector P₁, and then searches a suboptimal joint vector P₂. Similarly, the search continues until P_{M} is found and thus a combined matrix Q=[P₁, P₂, . . . , P_{M}] is constructed by the optimal joint vector and the M-1 suboptimal joint vectors.

Stage V (FIG. 12(b)) sets a ripple matrix Δ that intentionally provides a time-varying fluctuation for each column of the combined matrix Q. Thus, a range of [Q−Δ, Q+Δ] is formed. I matrices are randomly generated from the range. Then the I matrices generated are collected into a concatenated matrix R=[Q₁, Q₂, . . . , Qₗ]. In more detail, referring to FIG. 12(c), Stage V adds the ripple matrix Δ that creates fluctuation of Q, where the fluctuation matches properties of personal human perception. The fluctuation over T types of parameters, e.g. center frequencies, amplitudes, usage of time slots, bandwidths, duration of time slots, and subband category, can soothe human limbic system that affects a variety of functions including subjective feeling, emotion, behavior, memory, and olfaction. In certain embodiments, the ripple matrix Δ is used to make brain stay vital from refractory status, tiredness, or boringness.

After the first five Stages I-V of iSOUP-UOP, the concatenated matrix R=[Q₁, Q₂, . . . , Q ₗ] of a user is obtained. Then, at the beginning of Stage VI of iSOUP-UOP, L integers are randomly generated from the range of [1, M]. Define the integers generated as {g₁, g₂, g_{L}}. Stage VI includes L trials.

For the l-th trial (1≦l≦L), Qₗ is taken out of the concatenated matrix R, where P_{g}_{ₗ}^{l} is assumed to be the gₗ-th column of the matrix Qₗ. P_{g}_{ₗ}^{l} is used to generate a time-frequency series rₗ(t). In Stage VI, rₗ(t) is then modified by sₗ(t), vₗ(t), and w(t), where sₗ(t) is a broadband white noise or a pseudorandom noise covering all subbands, vₗ(t) is a spectrum-shaped noise, and w(t) is a user-preferred audio material (e.g. a piece of music, a piece of instrument sound, or a piece of concerto).

After the modification, a composite signal uₗ(t) is generated as follows:

uₗ(t)=αᵣ·rₗ(t)+αₛ·sₗ(t)+αᵥ·vₗ(t)+α_{w}·w(t), Eq. (3)

where αᵣ, αₛ, αᵥ, α_{w} ∈ [0, β] are power factors, and is β user-controlled constant.

Based on the power factors, one of rₗ(t), sₗ(t), vₗ(t), and w(t) having maximum level becomes foreground, while the other three becomes background. Three examples are (1) the foreground is rₗ(t) and the background is music without noise, (2) the foreground is noise and the background is music, or (3) the foreground is rₗ(t) with no background sound. For the l-th trial, Stage VI plays the composite signal uₗ(t) to the user, who replies by a decision either immediately or after a designated duration.

Repeat L trails when l goes from 1 to L. Based on L decisions, Stage VI calculates the scores for each of the M joint vectors P₁, P₂, . . . , P_{M}. According to the scores, Stage VI finds the maximum score and its associated Pₘ. For convenience, let Pₘ* denote Pₘ.

Jointly considering Pₘ* and its associated maximum score, Stage VI adjusts the power factors based on the framework of FIG. 11, and goes to the beginning of Stage VI ([00136]) for next round.

The foregoing steps repeat until the best power factors are found as αᵣ*, αₛ*, αᵥ*, α_{w}*. Meanwhile, the best Pₘ* is found. The best composite signal uₗ*(t) is generated by Eq. (3), wherein rₗ(t) is created per trial by Pₘ*, plus an additive noise vector from [−(Δ)ₘ, (Δ)ₘ], and (Δ)ₘ is the m-th column of Δ. Finally, the concatenation of all trials of uₗ*(t) (1≦l≦L) becomes a complete User-Optimized Time-Frequency (UOTF) series for highest entertainment or best treatment of a specific user.

In certain embodiments, the optimization of Stage VI can be performed under certain constraints, e.g. rms of u(t) is kept constant, or \sqrt{αᵣ²+αₛ²+αᵥ²+α_{w}^{w}²}=β, where β is a constant associated with audible THL. In certain embodiments, one or more of αᵣ, αₛ, αᵥ, and α_{w}, can be set zero permanently. In certain embodiments, one or more of Stages I, II, III, IV, V, and VI, or one or more of parts of the six Stages, can be simplified or removed for implementation.

In certain embodiments, Δ can be set as a zero matrix for simplification so that no perceptual fluctuation needs to be created during optimization. In certain embodiments, M, being the number of suboptimal joint vectors, is set zero for simplification so that no suboptimal joint vectors need to be sought.

In certain embodiments, the numbers of trials of six stages of iSOUP-UOP can be different.

In certain embodiments, additional constraints can be added into the first five Stages I-V of iSOUP-UOP, e.g. the sum of power spectral density should be constant. In certain embodiments, an optimal stimulus seeker is created for a user according to iSOUP-UOP over iSOUP-FS.

In certain embodiments, the audio link can be replaced by Internet plus an audio link. When Internet connection gets involved in iSOUP-UOP, a remote supervising person takes the user's decision and remotely controls the iSOUP transmitter through Internet plus the audio link. Said supervising person changes the parameters following FIG. 12(a)-(c).

In certain embodiments, joint optimization method of any stage of iSOUP-UOP can be replaced by: (1) the simplex algorithm that search along points on the boundary of the polyhedral set of feasible region; (2) the ellipsoid method consisting of a specialization of the nonlinear optimization technique; (3) the interior point projective methods that search through the interior of the feasible region; or (4) the affine scaling variants of the interior point projective methods.

iSOUP-UOP has variations in which the order of performing Stages I-VI is a permutation different from the order of FIG. 12(a)-(c). iSOUP-UOP of the present invention covers all the variations.

Furthermore, iSOUP-UOP has variations in which either one stage or more than one stages are removed from Stages I-VI for simplification. iSOUP-UOP of the present invention covers all the variations.

iSOUP-IUP and iSOUP-IHP

For home-use or self-use iSOUP devices, it is convenient to install software by ubiquitous audio cable plus Internet. When the software is available online, a user uses iSOUP Internet Update Procedure (iSOUP-IUP) to make the first time installation via an audio link plus Internet into said devices.

Furthermore, for an iSOUP device, the capability of periodically updating its core, processor, digital parameters, program, and/or operating system, is critical. This can also be simply done by a low-cost audio cable plus Internet.

iSOUP-IUP is the method in which a user may use an audio cable plus Internet to: (1) make the first time installation; and/or (2) upgrade its core, processor, digital parameters, program, and/or operating system. In more detail, iSOUP-IUP consists of a resident seed and an audio material.

The audio material, being distributed on Internet by companies, is generated by iSOUP-FS (Frame Structure). The Message within the audio material stores the bytes of desired software and/or desired updates.

The audio material is downloaded and played through an audio cable to the resident seed. The resident seed resides in the iSOUP device, receives the software and/or the updates, and saves them into its non-volatile memory, e.g. PROM, EAROM, EPROM, EEPROM, or Flash memory.

After power on, the iSOUP device loads the software and/or the updates from its non-volatile memory.

In certain embodiments, iSOUP-IUP is used to modify digital parameters inside a user device. As a component of iSOUP, iSOUP-IUP is jointly used with iSOUP-FS, iSOUP-TP, and iSOUP-UOP for highest entertainment and/or best treatment. In certain embodiments, iSOUP-IUP is done over a wireless audio connection or over the air.

iSOUP-IHP (Internet Healthcare Procedure) is an iSOUP part that enables the diagnostic plots of a user to be viewed anywhere in the world, and runs simply through an audio link plus Internet. iSOUP-IHP includes four components: long-term surveillance, Internet diagnosis, Internet treatment and Internet counselling session.

In the long-term surveillance component, iSOUP-IHP provides long-term surveillance of user's medical status and/or side effect of a home treatment device, a self-use device, or an assistive device, as well as long-term surveillance of progress and deterioration of a chronic disease.

To that end, a user can perform an Internet based periodic test/measurement hourly, daily, weekly, monthly, annually, or on a longer basis. The test/measurement can also be non-periodic, which means it is done only when a user or a healthcare provider feels necessary.

The schedule of the test/measurement can be predefined, while the result of the test/measurement is fed back through iSOUP-FS to a healthcare provider, e.g. a doctor, a clinic/hospital, a medical consultant, or a person/entity authorized to test, diagnose, or treat a patient. Bias-free result is automatically reported through the Backward Subframe to the healthcare provider.

In a plurality of embodiments, such a telemetry mechanism can be reinforced by a local recorder that writes a result into a local computer, as well as a remote recorder that logs data remotely through iSOUP-IHP. For example, an audiologist can monitor a physiological, psychological, or psychoacoustic test in real time and record its result by a remote recorder. Furthermore, through iSOUP-IHP, visiting a healthcare provider for testing data and/or measuring data is not necessary anymore, since a user's data are immediately transmitted from home to the healthcare provider. Additionally, iSOUP is used to monitor a user's medical status during transportation, and the data is logged at a healthcare provider as an internet-based surveillance/record.

In certain embodiments, a local alarm, e.g. LED light, speaker, or body-worn vibrator, is used to caution a user, as well as a remote alarm to caution a healthcare provider about abnormal result. In certain embodiments, Bluetooth and relevant wireless technologies can be used to collect data through iSOUP-FS in replace of an audio cable. In embodiments for disabled or older persons, an auto-dial phone is connected to iSOUP Box to activate auto-reading of name, address, and real-time medical status through phone.

In Internet diagnosis, Internet treatment, and Internet counselling parts of iSOUP-IHP, a doctor, a medical consultant, or an authorized person, appears at the other end of Internet connection by conversations and videos of Instant Messaging (IM) software (e.g. MSN, Skype, Yahoo Messenger, or similar software). To that end, user interface along with iSOUP-IHP helps diagnose, treat, and counsel a user.

In a plurality of embodiments, parameters of a user device need refitting when the user's medical status changes gradually. To that end, the user can connect to a designated Internet website to perform a test/measurement through an audio link. Based on the test result, the decision on whether to update parameters or not, as well as new values of parameters, are automatically executed by iSOUP, after a healthcare provider reviews result/measurement remotely and approves the decision and the new values. In certain embodiments, pretest or posttest Internet counselling are performed by IM software. The upgrade of iSOUP Box and the distribution of test/measurement software are performed by iSOUP-IUP via Internet.

iSOUP-AEP and iSOUP-IAP

With iSOUP-FS, iSOUP-TP, iSOUP-UOP, iSOUP-IUP, and iSOUP-IHP, an iSOUP Box provides optimal performance, tracks newest update of software, and gets remote supervision for home use. Nevertheless, when a new available algorithm becomes intelligent but its required computation becomes unaffordably intensive, a conventional user device can not run the new algorithm to reach required performance, due to the limitation of computational capability, power consumption, size, and/or weight.

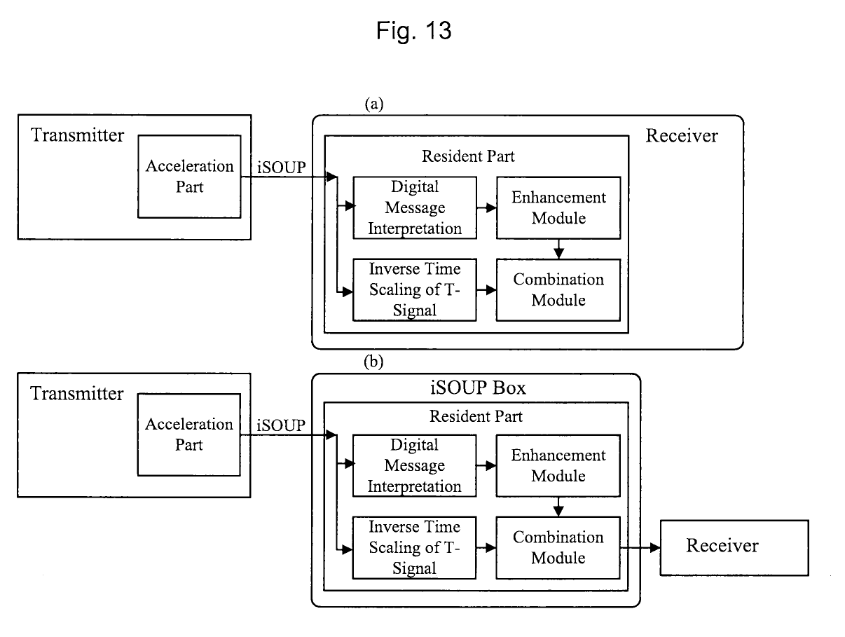

iSOUP-AEP (Algorithm Enhancement Procedure) is an iSOUP internal structure that provides compatible upgrade of a conventional user device through an audio link. Referring to FIG. 13, the principle of iSOUP-AEP is that a new algorithm is partitioned into an Acceleration Part (A-Part) and a Resident Part (R-Part). The A-Part running in a transmitter is a computational core that bears major computational load, e.g. wavelet transform, speaker recognition, noise cancellation, music onset detection, pitch extraction, or extraction of the feature information defined above. The R-Part is a part that jointly combines digital Message and analog T-Signal to reach highest performance. In summary, the A-Part is the part to extract the feature information of an input analog signal, while the R-Part is the part to use the feature information. Still referring to FIG. 13, SOUP-AEP consists of two modes: (1) the top block diagram is the integrated mode, where the R-Part runs within a conventional audio receiver; and (2) the bottom one is the standalone mode, where R-Part runs in a standalone iSOUP Box. In certain embodiments for music enhancement, special effects generation, or noise reduction, A-Part can be removed for simplification.

In a plurality of embodiments, when a new algorithm comprises an existing algorithm and an enhancement component, iSOUP-AEP puts the existing algorithm into the Combination Module of FIG. 13, while puts the enhancement component into the Enhancement Module of FIG. 13. To that end, Message can be combined into the existing algorithm to improve its performance. For example, wavelet transform can be used to distinguish speech and noise, offering noise reduction, while pitch can be used to enhance speech clarity and music appreciation.

In one embodiment, the iSOUP Box consists of two parallel modules, where one module is for the conventional use of playing MP3 music, while the other may be for running the R-Part.

In certain embodiments, the Spectrum-Shaping Module of FIG. 5 can be moved from iSOUP-UOP into the Resident Part of iSOUP-AEP. In these embodiments, the Spectrum-Shaping Module is thus moved from a transmitter into a receiver, and accordingly the transmitter does not need to perform spectrum shaping.

iSOUP-IAP (iSOUP Inaudibility Procedure) is a critical component of iSOUP. Using iSOUP-IAP, the power levels of Prefix, Message and Postfix are set to below what humans can hear. To that end, when a listener listens to both a conventional audio material and the iSOUP audio material (generated by iSOUP-FS, iSOUP-UOP, iSOUP-IUP, iSOUP-IHP over iSOUP-TP), he hears no difference.

iSOUP-BFRP

For entertainment, diagnosis, and treatment, iSOUP-BFRP (Bias-Free Random Procedure) is a critical inherent part that randomizes iSOUP-UOP, iSOUP-IUP, and iSOUP-IHP over iSOUP-FS and iSOUP-IAP. It is an automated part without human intervention. As a result, bias-free optimal parameter, bias-free measurement, and bias-free test result are provided.

iSOUP-BFRP can be used to selects one optimal DSP algorithm out of multiple candidate algorithms. Using iSOUP-BFRP, the set of multiple candidate algorithms can change per trail as a test is being executed. Based on how the change of the set is designed, iSOUP-BFRP have four types. The first type (Type 1) is a new DSP algorithm is created based on the real-time tracking of user decisions so that the set of candidate algorithms is expanded by inserting the new DSP algorithm into the set. From the expanded set, one algorithm is randomly chosen for each of successive trials. The expansion and the random choice are automatically done during the running of the test. The expanded set is informed to the user device via iSOUP-FS.

For Type 2, the size of the set decreases based on the real-time tracking of user decisions so that the set is automatically narrowed down. The narrowing down saves convergence time intensively. Type 2 has high time efficiency. With Type 3, the size of the set remains the same by replacing a previous candidate (of the set) with a newly created DSP algorithm automatically. Finally, type 4 is a combination of Types 1-3.

It is a capability that the set of multiple candidate DSP algorithms changes automatically as in Types 1-4. The capability does not exist in conventional methods. The capability provides: (1) more candidate algorithms are searched, larger range are searched, and better algorithm can be found; (2) new algorithms are created automatically during the running of the test; and (3) shorter time is cost because of automatic narrowing down.

In certain embodiments, the set of multiple candidate digital parameters replaces the role of the set of multiple candidate DSP algorithms described above. After the replacement, the purpose becomes finding one optimal digital parameter out of the set of multiple candidates for a specific user, which can be fulfilled as set forth above. In the fulfillment, there is no limitation on the type of the parameter. For example, the type can be one of: FIR/IIR filter coefficient, windowing function, compression function, and/or block size of input/processing/output, subchannel gain, index of frequency bin, electrode index, audible threshold (THL), and most comfortable level (MCL). iSOUP-BFRP covers all the types and similar variations. Here, the digital parameter is stored in Message of iSOUP-FS. In each trial, the value of the digital parameter can change.

In certain embodiments, the set of multiple candidate programs replaces the role of the set of multiple candidate DSP algorithms described above. After the replacement, the purpose becomes finding the program best fitted with a specific user. To compare candidate DSP programs, Message within iSOUP-FS carries an on-duty program per trial, where the effect of human gradual parameter drift is minimized by interleaving candidate DSP programs randomly. The randomness plus no intervention of people offers bias-free results, which can be automatically reported through the Backward Subframe to a computer or a recorder.

### Detailed Description for Normal People

Network Cable and Wireless Connector

In a plurality of embodiments, an audio cable integrated with iSOUP technique is used as a network cable. In a plurality of embodiments, a wireless audio connection integrated with iSOUP technique is used as a wireless connector. To that end, iSOUP provides wireless compatibility.

Single-Interface MP3 Player and Special Effects Generator

In certain embodiments, a single-interface MP3 player is created by iSOUP. To that end, said MP3 player uses only one interface to both transfer MP3 files from a computer and play the MP3 files to a listener. In certain embodiments, a special effects generator created by iSOUP, consists of a conventional MP3 player and an iSOUP Box that generates special effects including the modes of stereo imaging, chorusing, heavy low frequency effects, echo, reverberation, as in theater, music hall, cinema, auditorium, performance, concerto, and sonata), as well as pitch shifting, phasing, flanging, and additive background sound (e.g. natural sea flows, winds, rains, or lullabies). The selected mode of special effect is saved in Message of FIG. 6. In certain embodiments, lyrics are embedded into Message. Said special effects generator takes in “dry” audio input, reproduces and personalizes live music and performance, and further generates a variety of modes of special effects. In certain embodiments, said generator can be integrated as a part into a MP3 player or an audio receiver (e.g. headphone, headset, or earphone).

Processor Parameter Updater, Processor Program Updater, and Verification Tool for Fast Development

In a plurality of embodiments, a processor parameter updater is created by iSOUP to update one or more digital parameters of a user's processor through an audio link plus Internet. To that end, updating parameters is performed by iSOUP Internet Update Procedure (iSOUP-IUP) that plays a sound through the audio link and saves it into the memory of the processor.

In a plurality of embodiments, a processor program updater is created by iSOUP to update the program of a user's processor through an audio link plus Internet. To that end, upgrading a new high-version algorithm is performed by iSOUP-IUP that plays a sound through the audio link and saves it into the memory of the user device.

In certain embodiments, a verification tool of fast development is created by iSOUP. To that end, said tool is used to check real-time steps of a new program running within a processor, and verify the correctness of each step of the algorithm, namely synchronous verification and debugging (SVD). In said SVD, there is only an audio link between a host computer and said processor. Said verification tool is the first one-audio-link based verification tool, which offers to stop a real-time algorithm at any designated point and compare the intermediate result of the point with theoretical result. Said comparison is faster and more precise, where the advantages are: (1) even for a user's analog waveform input into the processor, each bit of intermediate/final digital result can be scrutinized during running; and (2) development cycle and debugging is fast.

Learning Device and Multisensory Entertainment Device

In certain embodiments, a learning device is created by iSOUP. In said learning device, multisensory information is inserted into both digital Message and analog T-Signal. In one embodiment, iSOUP-FS of FIG. 6-(h) can be used as a carrier to deliver the multisensory information. By using said learning device, a user's multiple human sensory receptors are simultaneously activated so that the user can learn new knowledge fastest, most completely, most tangibly, most vividly, and most impressively.

In certain embodiments, a multisensory entertainment device is created by iSOUP. In said device, a user can achieve highest subjective feeling and optimal fusion by 8-sensory integration or any of its simplified multisensory combinations through multisensory-frame. In one embodiment, an audio-visual entertainment device is created iSOUP by simplifying said multisensory device into a 2-sensory implementation.

Real-time Algorithm Accelerator

In certain embodiments, a real-time algorithm accelerator is created by iSOUP to enhance the performance of a conventional user device. Said accelerator uses an A(Acceleration)-Part to make a R(Resident)-Part run faster, which transforms a computationally intensive offline algorithm into a real-time implementation, with no hardware added. As a non-real-time to real-time transformer, said accelerator provides a low-cost device in small size and still offers conventional uses of playing conventional audio material. In one embodiment, said accelerator is a perceptual music onset detector running for a plurality of music analysis applications based on the fact that: the physical onset time and the perceptual onset time of a musical tone are distinctive, where the former occurs when the tone reaches a level of approximately 6-15 dB below its maximum value. In another embodiment, said accelerator is a real-time pitch extractor used with a conventional audio player, which does not exist in conventional methods.

iSOUP Network and Multiple Device Synchronizer

In a plurality of embodiments, a network is created by iSOUP using transmitters, receivers, transceivers, and audio links.

In certain embodiments, a multiple device synchronizer is created by iSOUP. Said synchronizer sends an iSOUP frame, e.g. marker-frame of FIG. 6-(c), to multiple hardware devices, all of which receives the frame simultaneously and works afterwards in a synchronous manner or keeps a predefined timing offset from each other.

Inaudible Data Hiding (IDH)

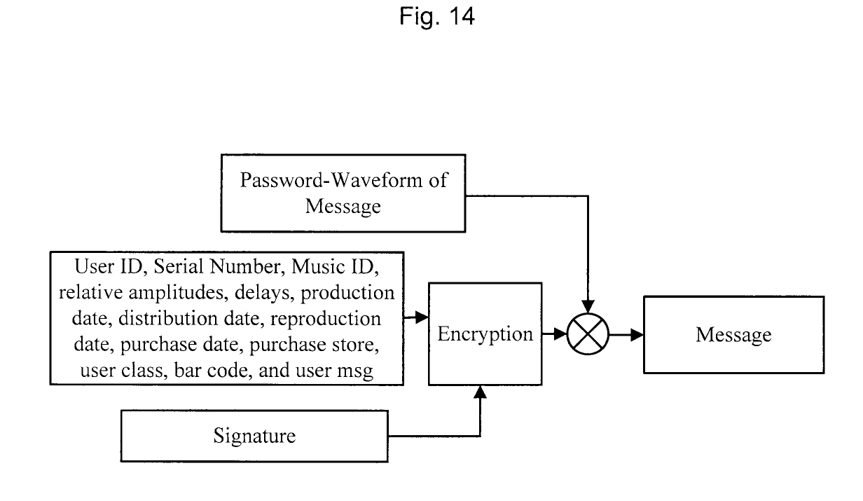

In a plurality of embodiments, inaudible data hiding (IDH) is created by iSOUP. Referring to FIG. 14, encryption algorithms encrypt the information of User ID, Serial Number, Music ID, relative amplitudes, delays, program selection, timer, digital volume control, direction of listening (with directional microphones), music/speech/noisy/environmental/directional/omnidirectional/automatic mode selection, sensitivity control, battery remote turn-off/turn-on, production date, distribution date, reproduction date, purchase date, purchase store, user class, bar code, and/or user msg. The encrypted information is modulated by a Password Waveform to generate Message. The amplitude of Message is then adjusted to below audible threshold based on iSOUP-IAP.

For each user, five critical user-unique components are Password Waveform of Prefix (PW-Prefix), Password Waveform of Postfix (PW-Postfix), Password Waveform of Message (PW-Message), Signature, and User ID. PW-Prefix is used as the predefined waveform for Prefix, while PW-Postfix is the predefined waveform for Postfix. Signature is a user-designated number, which is used as an encryption key of encryption algorithms. These five are uniquely assigned for each User ID. The discrete values of the relative amplitudes and delays are generated by a sequence, where the sequence is user unique and constructed by the Serial Number.

There are four multiplexing types of inaudible data hiding (IDH):

Sequential IDH. For sequential IDH, Message is transmitted prior to T-Signal; Parallel IDH. For parallel IDH, Message is transmitted through frequency bands different from T-Signal;

Overlapped IDH. In the iSOUP-FS created by overlapped IDH, Prefix, Message, and Postfix are buried into T-Signal in same time slots and same frequency bins so that Prefix, Message, and Postfix are overlapped with T-Signal in both time and frequency. The characteristic of Password Waveforms, e.g. specific time-domain shape, specific frequency-domain shape, specific correlation property, or specific cepstrum, is used by a receiver to extract Message from the iSOUP-FS; and

MCTF (multichannel time-frequency) IDH. For MCTF IDH, Message can be transmitted in an interleaving manner over time slots, frequency bands, and channels.

In certain embodiments, Password Waveform Module, Signature Module, or both, can be removed for simplification.

Internet Customized Consumer Electronics

In a plurality of embodiments, iSOUP is integrated into a consumer electronic device so that Internet can customize the device when needed.

In a plurality of embodiments, iSOUP is integrated into a hardware device so that Internet can customize the device when needed.

Internet Controlled Psychoacoustic or Physiological Test

In a plurality of embodiments, iSOUP is integrated into a hardware device so that Internet user interface can activate and control the device through an iSOUP frame. Thus, a psychoacoustic and/or a physiological test can be performed to obtain parameters from humans.

Customized Mp3 Song

In a plurality of embodiments, iSOUP customizes a MP3 song for a specific person. It injects personal information into a postprocessed song. The postprocessed song is a new MP3 file that only aims at the person.

MP3 Real-Time Anti-Piracy

In a plurality of embodiments, iSOUP puts the information of user and song into a MP3 song so that real-time anti-piracy can be realized.

In a plurality of embodiments, an iSOUP anti-piracy MP3 file is created by iSOUP. To obtain said file, a piece of audio material (e.g. MP3 music) released by entertainment and/or music companies is first divided into multiple segments. The audio material is then processed by one of two interleaving methods:

[197.1] Delay method. Each segment is adjusted by relative amplitude, delayed and added to itself. The delays of different segments are different. Said delays are encrypted into Message. When IDH music is played, an unlicensed listener can hear unbearable low-quality, smeared, and/or ambiguous music, while a licensed user can use a hardware iSOUP Box, connect it into a MP3 player, and cancel the delays to recover high-quality music. Said audio material licensed to one user is associated with only one unique (hardware) iSOUP Box released by entertainment and/or music companies, while other users' iSOUP devices can not recover it. The delay method shall have a variation in which the number of delayed paths is more than one. In the variation, the original segment experiences the distortion of multipath delay-overlap instead of two paths. The present invention covers the variation. The delay method is called “delayed inaudible data hiding (delayed IDH)” hereafter.
[197.2] Allocation method. A time-frequency (TF) series is constructed by the Serial Number, and then the audio material is allocated to the basic time-frequency blocks of the TF series. The allocation method is called “time-frequency inaudible data hiding (TF-IDH)” hereafter.

In certain embodiments, the relative amplitude of the delayed path is increased to a level that an unlicensed user can only hear meaningless noise. Said embodiments provide strict protection. The strict protection can also be used in the allocation method, where allocating different segments of music into non-continuous frequency bands makes them not understandable. Thus, music can be distorted jointly in time domain or frequency domain.

Said two interleaving methods change T-Signal based on the information within Message. After the change, one of the foregoing four multiplexing types is applied to integrated Prefix, Message, Postfix, and the changed T-Signal. Therefore, said two interleaving methods can be combined with the four multiplexing types to generate eight iSOUP Anti-Piracy MP3 Formats. Said iSOUP Anti-Piracy MP3 Formats are used for anti-piracy to avoid illegal pirated copies, because only one unique iSOUP Box can recover high-quality music.

In certain embodiments, a user's iSOUP Box can add special effects that are embedded in Message and are suitable for highest music entertainment.

Anti-Piracy MP3 Player

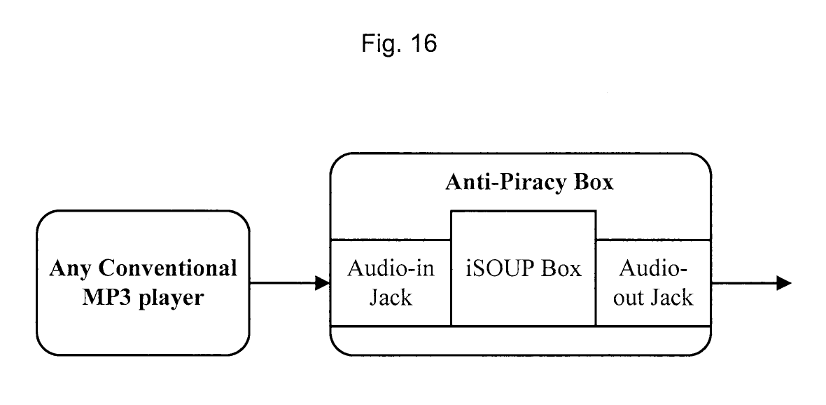

In a plurality of embodiments, iSOUP enables an anti-piracy MP3 player for making pirated copies become useless, comprising the steps: a) Only the licensed user of said MP3 player not anyone else can enjoy songs he purchases. As shown in FIG. 16, said MP3 player consists of a conventional MP3 player and an anti-piracy box. The anti-piracy box consists of an audio-in jack, an iSOUP Box, and an audio-out jack. b) When a company sells a music file of a song, the company transforms the file into an iSOUP-FS. As a licensed user purchases the song, he will get the iSOUP-FS. Then, he can use the conventional MP3 player and play the iSOUP-FS to the anti-piracy box. The output of the anti-piracy box is the normal music. c) If another user copies the iSOUP-FS and plays it by a conventional MP3 player, he hears a distorted song, which can sound like (including but not limited to) noise, echo, smearing, partial music (plus partial noise), low-quality music, and/or any kind of distorted sound. d) Another optional feature is that when the programs, parameters, cores, operating systems of the anti-piracy box need updating or changing, an iSOUP-FS can be played from a computer (or any audio player) to the anti-piracy box for accomplishing the updating/changing. e) The conventional MP3 player can be replaced by any audio player. Said anti-piracy MP3 player shall have a number of variations: anti-piracy MP4 player, anti-piracy CD player, . . . , anti-piracy WAV player. For “each specific player”, an anti-piracy variation of “the specific player” is generated by replacing the conventional MP3 player of FIG. 16 with “the specific player”. The patent covers all these variations.

Internet Customized MP3 Player

In a plurality of embodiments, iSOUP enables a MP3 player comprising updating processor parameter, program, core, and/or operating system through an audio link.

Inaudible Copyright Protector

In a plurality of embodiments, an iSOUP inaudible copyright protector is created by iSOUP technique. Said protector works in a similar way to the iSOUP anti-piracy MP3 file, where the difference is that said protector keeps music in T-Signal as original, without delayed IDH (delayed inaudible data hiding) or TF-IDH (time-frequency inaudible data hiding). The purpose of said protector is that it protects the copyright of the music by means of: (1) a hardware of an iSOUP device can read User ID, Serial Number, Music ID, relative amplitudes, delays, production date, distribution date, reproduction date, purchase date, purchase store, user class, bar code, and/or user msg, from Message of music; and (2) if there happens to be a mismatched user (i.e. user ID is different from the listener), a modification, or a violation, the iSOUP device can caution anti-piracy administrative personnel. Although said protector is similar to the iSOUP anti-piracy MP3 file, music is kept high-quality and not distorted.

Audio Sales Tracker

In a plurality of embodiments, an iSOUP audio sales tracker is created by iSOUP technique. Said tracker works in a similar way to the iSOUP anti-piracy MP3 file, where the difference is that said tracker keeps music as original, without delayed IDH or TF-IDH. The purpose of said tracker is that it tracks the sales and distributions of an audio product. The means of tracking is that a hardware iSOUP device can read User ID, Serial Number, Music ID, relative amplitudes, delays, production date, distribution date, reproduction date, purchase date, purchase store, user class, bar code, and/or user msg, from Message of the audio product. Although said tracker works similarly to the iSOUP anti-piracy MP3 file, the audio product is kept high-quality and not distorted. A producer, a distributor, a retailer, and a reproduction-authorized user can use the iSOUP device to automatically read/insert production date, distribution date, purchase date, and reproduction date into iSOUP-FS Message. Furthermore, said tracker tracks the product source, the dates, the distribution, and reproduction, without affecting user appreciation.

For every embodiment disclosed in the present invention, the embodiment shall automatically have a variation in which the masking property of T-Signal (over adjacent Prefix, Message, and Postfix) is considered in iSOUP Inaudibility Procedure (iSOUP-IAP). The consideration is based on the level/spectrum of T-Signal and the psychoacoustic masking curve. In the variation, T-Signal masks Prefix, Message, and Postfix so that a user can not hear Prefix, Message, and Postfix. The present invention covers the variation.

Detailed Description for Healthcare

Internet Healthcare, Internet Customized Medical Devices, Healthcare Sensor Network, Heart Rate Monitor, and Internet Surveillance of Chronic Disease

In a plurality of embodiments, an iSOUP Internet Healthcare device is created by iSOUP. Said device can be used at home for self training or home-based treatment by support of iSOUP-IHP (Internet Healthcare Procedure) and iSOUP-IUP (Internet Update Procedure). At home, a user can plug the audio link of the device into a computer, and then he can obtain user-optimized time-frequency (UOTF) series for best training or best treatment based on iSOUP-UOP of FIG. 12. After iSOUP-UOP, the user of said device can: (1) update processor parameter, program, core, and/or operating system, through an audio link plus Internet by iSOUP-IUP; (2) perform a diagnostic procedure through an audio link plus Internet by iSOUP-IHP; and (3) perform a treatment through said device and audio link plus Internet by iSOUP-IHP.

iSOUP-HSN (Healthcare Sensor Network) enables the diagnostic plots of a user to be viewed anywhere in the world, as a fundamental infrastructure created by iSOUP-IHP. Said iSOUP-HSN shall mean a collection of human body mounted sensors (e.g. heart rate sensor, breathing rate sensor, temperature sensor, and/or movement sensor), audio recorders, visual recorders, audio cables, Bluetooth and relevant wireless technologies, computer, Internet access, local alarm, remote alarm, local recorder, remote recorder, automatic telemetry equipment (ATE), all or part of which are interconnected by iSOUP technique over an audio links. Said body mounted sensors work at home in awake mode and sleep mode to monitor and track long-term chronic disease and protect a user at home, especially during sleep. Said iSOUP-HSN is home-based, where multiple iSOUP-HSNs can connect one healthcare provider (e.g. a medical center) via Internet to form a multiuser system. Said network includes multiple-to-one connection between multiple home-based HSNs and one healthcare provider.

In one embodiment, for low heart rate patients, Bradycardia patients, postsurgical or older people, an iSOUP-HSN based heart rate monitor is created by iSOUP technique to monitor whether a (resting) heart rate continues being under a critical number (e.g. 50 beats per minute), especially during sleep.

The alarm mechanism of iSOUP-HSN includes human body mounted sensors, a local alarm, a remote alarm, audio cables, and a computer. The human body mounted sensors use wireless iSOUP-FS to connect a Bluetooth receiver, which is attached to a computer audio jack. If an abnormal data of sensor measurement is acquired, said computer uses its headset jack with an audio cable to send out iSOUP-FS toward a local alarm. The local alarm includes multiple user-preferred components, e.g. LED light, alarm speaker, and body-worn flash. Meanwhile, user's data of sensor is also transmitted to a healthcare provider via an audio cable plus Internet. Said healthcare provider uses an automatic telemetry machine (ATE) to receive the data, which is then scrutinized by a remote alarm. Furthermore, a local recorder runs as software of user's computer, while a remote recorder works with ATE for analysis and abnormality detection.

In certain embodiments, the alarm mechanism of iSOUP-HSN can have three levels: normal, high risk, and emergence. For high risk level, local alarm plus remote alarm will be activated through an audio link. For emergence level, said two alarms being activated, emergence phone number will be auto-dialed as requested by a user computer before pre-recorded name, address, and medical status is automatically read out. In one embodiment, a user's analog waveforms of voice, photo, and video are recorded and mixed with digital measurements, both of which are combined into iSOUP-FS and reported simultaneously to a healthcare provider.

Multisensory Self-Trainer

In a plurality of embodiments, a multisensory self-trainer is created by iSOUP to train a user by himself at home. In one embodiment, a new-music appreciation self-trainer is created by iSOUP based on FIG. 6. Said self-trainer comprises simultaneous audio-visual-smell-taste-touch-linear-acceleration-rotary-temperature stimulus, which follows the steps:
Said self-trainer improves full appreciation of outside stimulus (e.g. high-fidelity music and CD-quality music), which can not be perceived by many disease acquired people or postsurgical people.
Specialized materials (e.g. specialized MP3) are created for a specific user by the Spectrum-Shaping Module of FIG. 5, and played to improve personal perception. For example, for a hearing impaired user, the Spectrum-Shaping filter can be an inverse shape of the user's aided audiogram.
Said self-trainer improves a variety of aspects of subjective feelings, e.g. timbre, emotion, new music, and familiar music.
Said self-trainer takes advantage of multisensory brain integration, brain memory, and brain plasticity.
And either 8-sensory stimulus or any of its simplified multisensory combinations (e.g. audio-visual stimulus) can be used.

Said self-trainer uses a multisensory iSOUP frame (including N senses) to stimulates N conventional user devices. The N user devices can be but are not limited to conventional audio devices, which can be a microphone or an audio receiver, if said self-trainer is used by an unaided mild-to-moderately hearing-impaired user; or can be a hearing aid (HA), middle ear implant (MEI), bone conduction implant (BCI), vestibular implant (VI), cochlear implant (CI), hybrid cochlear/vestibular implant (HCVI), auditory nerve implant (ANI), auditory brainstem implant (ABI), or auditory midbrain implant (AMI)), if said self-trainer is used by a hearing aided or implanted user.

The user devices may also include conventional visual devices (e.g. the visual screen defined herein), conventional taste devices, conventional smell devices, conventional touch devices, conventional linear-acceleration devices, conventional rotary devices, and conventional temperature devices.

Multisensory Rehabilitation Device, Multisensory Treatment Device, Wireless Multisensory Device, and Children Learning Device

In a plurality of embodiments, a multisensory rehabilitation device is created by iSOUP. Said rehabilitation device improves multisensory integration in the cerebellum near the brain stem, which controls many automatic functions and overall sensory and motor integration. In one embodiment, said rehabilitation device is a device that helps rehabilitation after hearing loss or auditory surgery, e.g. hearing aid or implantation. In said device, 8-sensory stimulus or its simplified multisensory combinations (e.g. audio-visual stimulus) can be used. Often the process of neuron firing off a message also creates new interneuronal connections called dendrites or axons. This means that using said device may build new brain connections, increasing the neural network, exactly what is needed to recover from a plurality of neurological disorders and hearing diseases. Said device can also be used by older people undergoing various forms of health crises or degeneration, where said device can bring personalized comfort and solace, inner calm, deeper sleep, better mental balance, awareness, and focus.

In a plurality of embodiments, a multisensory treatment device is created by iSOUP technique. In certain embodiments, said device is specialized to treat hearing diseases or neurological disorders, namely hearing disease treatment device (HDTD) and neurological disorder treatment device (NDTD), regarding suppression of disease onset, rehabilitation, relief of severity, or avoidance of deterioration. In one embodiment, said device is based on a multichannel time-frequency (MCTF) series of FIG. 3, where each channel represents an electrode instead of audio channel. To that end, the stimuli of HDTD and NDTD can be customized for a user through iSOUP-UOP, while their alternative drug can not be customized. For HDTD and NDTD, iSOUP-UOP is critical to find a best stimulus for treatment in accordance with the fact that only a user himself can help catch the point of his best stimulus. In certain embodiments, NDTD decreases stress associated with neurological diseases, lift the user's state of vitality, achieves greater states of wellbeing, happiness, and an end to depressed feelings.

In normal use, said hearing disease treatment device (HDTD) and neurological disorder treatment device (NDTD) work in either of two modes. In the first mode, a conventional MP3 player and an iSOUP Box are needed to follow iSOUP-UOP, where the MP3 player acts as a controller and a user interface based on Message of iSOUP-FS over an audio link. In the second mode, a standalone iSOUP Box is used as the transmitter shown in FIG. 9-(a). In update, a computer connects and controls the iSOUP Box, where the iSOUP Box upgrades via an audio link plus Internet.

In certain embodiments, a children learning center is created by iSOUP technique. Said center is a multisensory device that includes multiple modules with different Module IDs shown in FIG. 6-(h) to deliver simultaneous 8-sensory stimulus or its simplified multisensory combinations (e.g. audio-visual stimulus) through the frame structure of FIG. 6-(h).

In a plurality of embodiments, a wireless multisensory self-trainer, a wireless multisensory rehabilitation device, a wireless multisensory treatment device, or a wireless children learning center, is created by iSOUP, replacing an audio cable with Bluetooth or relevant wireless technologies defined by

Remote Control

In a plurality of embodiments, an iSOUP remote control is created to be wristwatch, wristband, waist clip, bracelet, armlet, neckloop, in-pocket device, waistband, clothes clip, or fabric sensor based garment in accordance to iSOUP technique. In certain embodiments, the remote control is used with a BTE/ITE device to provide Bluetooth music and also solve the four conventional problems. In the first case, a user often does not know what mode (or program) his BTE/ITE device currently is, if his BTE/ITE device has multiple modes (or programs). Additionally, the user can hardly switch modes as he will, because it is hard for him to operate a (tiny) button of the BTE/ITE device while wearing the device. Moreover, if the BTE/ITE device provides an audio jack for music appreciation (e.g. MP3), the audio jack (sometimes called direct audio input, i.e. DAI) is barely used, because it is troublesome to have an audio cable connected to the ear. Furthermore, mobility is significantly limited, not even mentioning to switch back and forth from conversation to music. Finally, if a user wants to control the BTE/ITE device, he usually has to first take off the device from the ear, read the display screen (if there is one), change the configuration, and then wear the device back again.

The iSOUP remote control solves the problems described above. Said remote control transmits Message of iSOUP-FS, which includes the user information of program selection, timer, digital volume control, direction of listening (with directional microphones), music/speech/noisy/environmental/directional/omnidirectional/automatic mode selection, sensitivity control, battery remote turn-off/turn-on, and/or sound source localization. In one embodiment, said remote control has a display screen to show the coming direction of strongest speaker or loudest sound source (e.g. door knock).

In certain embodiments, when said remote control works in automatic mode, it automatically detects and classifies different environments, then uses Message of iSOUP-FS to deliver the classified mode to a BTE/ITE device. To that end, different environments are listening situations that can include but are not limited to crowded areas (e.g. restaurants and conferences), homes, vehicles, and cocktail meetings.

Internet Customized Hearing Aid and Auditory Implants

In certain embodiments, a multisensory hearing aid (HA) and a multisensory auditory implant (AI), as defined herein, are created in accordance to iSOUP technique. In said HA and AI, 8-sensory stimulus or its simplified multisensory combinations are used to improve the user's auditory perception.

Optimal Auto-Fitting, Wireless Fitting, Internet Fitting, Home Auto-Refitting, and Over-The-Air Fitting

The method of iSOUP-OAFP (Optimal Auto-Fitting Procedure) is one simplified version of iSOUP-UOP (User Optimization Procedure). In a plurality of embodiments, said method is performed optimally and randomly. The advantages are that said method is per-trial randomized, has no operational bias nor human subjective bias, has no time cost of doctor's manual operation, eliminates gradual drift of human parameter values, eliminates effect of user anticipation, and offers stable results. Said device is faster and more convenient. When a conventional user device, e.g. hearing aid (HA) or auditory implant (AI), needs fitting, an audio player can use an audio cable to do iSOUP-OAFP, avoiding the problems of doctor's intervention and doctor's operational bias.

According to Stage I of FIG. 12, a set of desired fitting parameters, e.g. index of frequency bin, electrode index, FIR/IIR filter coefficient, subchannel gain, audible threshold (THL), most comfortable level (MCL), windowing function, compression function, and/or block size of input/processing/output, are put into Message of iSOUP-FS.

One parameter, e.g. index of frequency bin or electrode index, is selected out of the set as a representative parameter, while other parameters are called the “rest parameters”. All acceptable values that can be configured to the representative parameter are defined as A={a₁, a₂, . . . , a_{M}}. For each element of A, a strategy is assigned to the element so that M strategies are assigned to M elements of A. One strategy runs L trials.

For each trial of the strategy, an audio player plays an iSOUP-FS signal to a conventional user device (e.g. HA or AI), where Message carries the representative parameter and the rest parameters, and T-Signal carries an analog stimulus. In case that each trial consists of I intervals (e.g. in a multiple-interval forced-choice task), I sets of fitting parameters can be put into Message correspondingly. The user device receives Message, configures its DSP algorithm based on Message, processes the analog signal using Message, and generates a desired signal. If there is an additional enhancement needed, said method can include iSOUP-AEP.

After the user perceives the desired signal, he makes a decision about his perception, e.g. he may request turning the subchannel gain up/down, or select one interval out of I intervals. A group of decisions are recorded to adjust one or more of the rest parameters of Message, e.g. subchannel gain, THL or MCL, for next trial.

The foregoing steps are one approach or mechanism to finishing one strategy. However, to finish multiple strategies, M strategies are randomly interleaved into one combined test. Then the combined test is performed to a user.

When said fitting is done, statistics of user decisions are automatically scored, and the optimal set of fitting parameters are directly saved into the user device by transmitting an iSOUP frame over the audio cable.

The advantages of iSOUP Optimal Auto-Fitting Procedure (iSOUP-OAFP) are that the combined test breaks the continuous adjustment of one strategy, because the trails of the strategy are not consecutively tested but interleaved with the trails of other strategies. Thus, the combined test is per-trial randomized and eliminates user anticipation of the fitting parameters.

Another advantage is that the device is fair for all strategies. The reason is that: strictly speaking, there is always effect of gradual drift in human parameter values during a test. Conventionally, when a strategy is tested earlier than another, the test result changes if the order of testing strategies changes, because human response curves are time-varying. However, the combined test described above interleaves the trials of all strategies so that all strategies are performed at the same time, equally affected by the fluctuation of the gradual drift. Thus, the combined test is fairer than conventional tests.

Another advantage is the test does not need a doctor's manual intervention to reinitialize and/or reload strategies multiple times for multiple strategies. Thus, it is free from operational bias and doctor's unintentional subjective bias.

Still another advantage is said device has no time cost of doctor's operation. Finally, the last advantage is said device offers stable results.

Correspondingly, the combined test of above is a fitting method that achieves optimal performance and solves some conventional problems. For example, conventionally tests are significantly affected by the effect of gradual drift in human parameter values during a test. Also, there always exists a possibility that a doctor, a medical consultant, or an authorized person, has operational bias and unintentional subjective bias. In addition, it costs a doctor, a medical consultant, or an authorized person intensive time to manually reinitialize and/or reload strategies multiple times. This not only costs intensive time, but also increases the possibility of incurring human mistakes. And conventionally, to validate the test result, it is common to completely retest multiple strategies in a different order, which costs even more intensive time. One or more of these problems may be solved by the method of iSOUP Optimal Auto-Fitting Procedure (iSOUP-OAFP).

In certain embodiments using the iSOUP-OAFP method, a critical dimension for a conventional user device, e.g. subchannel index for HA or electrode index for AI, can be picked as the representative parameter.

In certain embodiments, another different purpose is to pick the best DSP algorithm out of multiple candidate algorithms, where one candidate algorithm is considered as one mode. To that end, the representative parameter of the iSOUP-OAFP method is the mode. Through the same foregoing steps, the per-trial randomized iSOUP-OAFP method can be used to compare the candidates fairly and obtain the best DSP program through an audio link. This capability that multiple DSP algorithms are per trail randomized, does not exist in conventional methods.

In certain embodiments, the set of DSP candidate algorithms can change as a test is being executed. The change of the set follows the steps of foregoing Types 1-4 of iSOUP-BFRP (iSOUP Bias-Free Random Procedure).

In certain embodiments, the iSOUP-OAFP method provides a means to tune FIR/IIR coefficient, windowing function, compression function, and/or block size of input/processing/output inside a conventional user device.

In certain embodiment, two or more of fitting parameters in the iSOUP-OAFP method can be jointly defined as the representative parameter, and thus the representative parameter becomes a multidimensional variable. Based on the joint definition, the steps set forth above can be done by simultaneously randomizing multiple fitting parameters. These variations are covered by the present invention. For example, both the mode of DSP candidate algorithms and the electrode index can be simultaneously randomized so that in each trail both the mode and the electrode index are random. Thus, the best fitting performance of all modes can be fairly compared, and jointly optimal results can be found.

In certain embodiments, a rest parameter, e.g. audible threshold (THL) or most comfortable level (MCL), does not rely on the tracking mechanism of above. The tracking mechanism means the rest parameter of next trial is adjusted according to user's decisions till now. Instead, the rest parameter is done by the ergodic mechanism. The ergodic mechanism means if all acceptable values of the rest parameter are defined as B, the ergodic method randomly assigns an element of B to the rest parameter in each trail. Thus, in each trail, both the rest parameter and the representative parameter are random. Such a method is a variation of the iSOUP-OAFP method. In certain embodiment, two or more rest parameters are jointly randomized by the ergodic method.

In a plurality of embodiments, the method of iSOUP wireless fitting replaces the audio cable of the iSOUP-OAFP method by Bluetooth or relevant wireless technologies defined herein.

In a plurality of embodiments, the method of iSOUP Internet fitting replaces the audio cable of the iSOUP-OAFP method by an audio cable plus Internet (or Bluetooth or relevant wireless technologies plus Internet). iSOUP Internet fitting follows the process of the Internet diagnosis and Internet treatment of iSOUP-IHP. A doctor, a medical consultant, or an authorized person, appears at the other end of Internet connection by conversations and videos of Instant Messaging (IM) software. Meanwhile, the results of the optimal fitting parameters are automatically reported through Backward Subframe to a healthcare provider.

In a plurality of embodiments, the method of iSOUP home auto-refitting is similar to the method of iSOUP Internet fitting, except neither Internet connection, nor a doctor, a medical consultant, or an authorized person is needed. Said refitting aims at the gradual change of a user's human body over time. Before said refitting is done by the user himself, the original set of parameters is saved from the user device to a computer by the Backward Subframe of FIG. 5 over an audio cable, Bluetooth, or relevant wireless technologies defined herein). Said refitting follows similar process of the above method of iSOUP Internet fitting. After said refitting, the result of the new optimal set is automatically reported to a healthcare provider. After a predefined period, the original set may be easily restored by playing the saved iSOUP-FS frame to the user device, as a backup mechanism.

In a plurality of embodiments, the method of iSOUP over-the-air fitting is similar to the iSOUP-OAFP method, except that the audio cable is replaced by an inaudible over-the-air connection. The over-the-air connection is the free-field propagation of inaudible sound wave from a transmitter to a receiver, e.g. a speaker to a microphone. Additionally, iSOUP over-the-air fitting can also be done via Internet or at home. Said method needs no cable connection and provides faster and optimal fitting.

In certain embodiments, the conventional user device using the methods of iSOUP-OAFP, iSOUP wireless fitting, iSOUP Internet fitting, iSOUP home auto-refitting, and/or iSOUP over-the-air fitting, is a hearing aid (HA) or an auditory implant (AI) defined herein. As HAs and AIs typically have an audio jack (either in all standard sizes or in modified shapes), namely Direct Audio Input (DAI), said methods can be done through DAI which also connects TV, computer, radio, and video game.

Internet Controlled Psychoacoustic or Physiological Test

In a plurality of embodiments, iSOUP is integrated into a hardware device so that Internet user interface can activate and control the device of a patient through an iSOUP frame. Thus, a psychoacoustic and/or a physiological test can be performed to obtain parameters from the patient. The final goal is to obtain personal measurements from the patient so that a better customized surveillance or treatment can be done for the patient.

Customized Mp3 Song

For hearing-impaired patients, a uniquely customized MP3 song is preferred. iSOUP enables this by using a psychoacoustic test first and then apply the test result to the MP3 song. Thus, the perception can be enhanced.

Assistive Listening MP3 File

In a plurality of embodiments, an iSOUP assistive listening MP3 file is created by iSOUP for both normal-hearing (NH) and hearing-impaired (HI) users to fully hear high-fidelity and CD-quality music. After standardization of the format of said file, both normal-hearing users and hearing-impaired users appreciate the same file due to the inaudibility of iSOUP. Said MP3 file mainly employs two components: (1) the spectrum-shaping filter of the Spectrum-Shaping Module of FIGS. 5; and (2) Message of iSOUP-FS.

For said MP3 file, the impulse response of the spectrum-shaping filter, i.e. hₛₛ(t), is generated based on a user's health information (e.g. aided audiogram, subchannel gains of a HA user, or THL and/or MCL of an AI user). In one embodiment, when a HA can not completely compensate frequency-selective hearing loss, the user's aided audiogram is still a non-flat spectral shape r_{d}(f) that has residual distortion. Therefore, even if a normal MP3 song is played, the HA-worn user still hears a distorted song. For the full perception of high-fidelity and CD-quality, the spectrum-shaping filter hₛₛ(t) is designated as an inverse filer of r_{d}(f) in the present invention. In case that r_{d}(f) has singularity, hₛₛ(t) can also be a simplified reduction as: (1) a FIR filter that approximates said inverse filer; or (2) an IIR filter that approximates said inverse filter. After hₛₛ(t) is created, its coefficients are injected into Message of the iSOUP-FS frame that also stores a piece of MP3 music in T-Signal. During playing the frame, an iSOUP Box automatically extracts Message to convolve hₛₛ(t) with the music signal, and thus compensates the residual distortion. The iSOUP frame can be saved as a file into a MP3 player or a computer drive. The saved file is called an iSOUP assistive listening MP3 file, which is personalized for each individual user, different from conventional MP3 file. Nevertheless, normal-hearing users can also enjoy the file, because they do not hear Prefix, Message, and Postfix due to iSOUP-IAP (Inaudibility Procedure).

Said iSOUP Assistive Listening MP3 File can work with a hearing aid or an auditory implant defined herein. For a hearing aid, said iSOUP Assistive Listening MP3 File solves various known problems of a hearing aid (HA). First, a HA has a limited number of subchannels, where amplification gain is flat within one subchannel. However, a user's audiogram is non-flat everywhere. Thus, in theory and in practical, a hearing aid can not perfectly match a user's residual ear capability. The mismatched part is compensated by said MP3 file. Additionally, a HA mismatches a user's gradually-changing ear. A HA has a limited range of amplification so that when a user's hearing loss at one frequency is significantly better than his severe hearing loss at another frequency, the HA can not provide proper amplification. In this case, compensation can be applied to an original sound, and the compensated sound can be saved as said MP3 file. On top of the compensation, the HA only needs to provide amplification that requires normal dynamic range. The challenge the HA faces is avoided by said MP3 file.

For an auditory implant, it is similar to a HA that the auditory implant has the same problems of limited subchannels, flat gain within one subchannel, and mismatch with a user's residual capability. Said MP3 file can solve the problems similarly.

In certain embodiments, a multisensory iSOUP assistive listening MP3 file is created by iSOUP technique. All or part of visual, taste, smell, touch, linear-acceleration, rotary, and temperature cues (saved in Left-Eye Msg, Right-Eye Msg, Binocular-Balance Msg, Taste Msg, Smell Msg, Touch Msg, Linear-Acceleration Msg, Spinning Msg, and Temperature Msg, in a digital manner, respectively), and/or their cues in analog format (stored in Left-Eye Waveform, Right-Eye Waveform, Taste Waveform, Smell Waveform, Touch Waveform, Linear-Acceleration Waveform, Spinning Waveform, and Temperature Waveform, respectively), can be inserted together with audio cue (Left-Ear Msg, Right-Ear Msg, Binaural-Balance Msg, Left-Ear Waveform, and/or Right-Ear Waveform) into iSOUP Frame Structure (iSOUP-FS). When said multisensory MP3 file is played from a MP3 player to multiple conventional user devices, said file takes advantage of both multisensory integration and the foregoing spectrum-shaping to jointly enhance the full hearing of CD-quality music of hearing-impaired users.

In certain embodiments, an audio-visual iSOUP assistive listening MP3 file based the above information is created. Visual cue is also embedded in Left-Eye Msg and Right-Eye Msg of said audio-visual MP3 file. The visual cue can be but is not limited to the display of the feature information: energy, rms, magnitude spectrum, phase spectrum, spectrogram, intensity, pitch, formants (F1, F2, F3, F4, F5, and F6), slope of pitch, interval of pitch, contour of pitch, rhythm, onset time-points, sound source location, sensory type, sensory location, sensory duration, mean, standard deviation, skewness, kurtosis, high-order central moments, cumulants, and/or any statistical characteristics.

The visual cue can be shown by a visual screen. A progress bar, a flashing arrow, a digital number, a letter/word, a light, a light array, a transient flashing effect, an image, or any other content, is displayed. Here, the displayed content is directly controlled by the foregoing visual cue. The shape of the visual screen can be but is not limited to rectangle, cylinder, sphere, triangle, disc, or any geometric shape.

Two or more of the visual cues can be shown simultaneously when the visual screen has two or more screens. For example, one left screen shows sound source location, while one right screen shows pitch/intensity/energy/rms height or onset time-points. The left screen can be controlled by Left-Eye Msg, while the right can be controlled by Right-Eye Msg.

If the displayed content is not digital but analog, Left-Eye Waveform and Right-Eye Waveform can also be used to convey the foregoing visual cue in an analog manner. For example, the visual cure is continuous and obtained from filtering.

A plurality of embodiments is for music entertainment of normal hearing (NH) users. In the entertainment, an iSOUP assistive listening MP3 file is created by the foregoing steps. Said file enables a NH user to appreciate high sensation, high fidelity, broad frequency range, and high quality in music. For a NH user, hₛₛ(t) is generated based on his audiogram, except that his audiogram has less-than-20 dB hearing loss everywhere. The spectral shape of his audiogram is non-flat and compensated by hₛₛ(t).

In another embodiment, for an unaided mild-to-moderately hearing-impaired (MMHI) user, hₛₛ(t) is similarly created as an inverse of r_{d}(f), except that the MMHI user does not have a HA and r_{d}(f) used here is an unaided audiogram rather than an aided audiogram.

In yet another embodiment, for an auditory implant user, hₛₛ(t) can be generated similarly, except that the aided audiogram is tested when the user wears an auditory implant defined by [0078], instead of a hearing aid.

In certain embodiments, to generate iSOUP Assistive Listening MP3 File, a conventional audiogram is not accurate enough to get hₛₛ(t), while the required audiogram is retested in a boarder range of frequencies, e.g. [20 Hz, 20 KHz].

In certain embodiments, iSOUP assistive listening MP3 file is similarly created by iSOUP for a user with a hearing disease, e.g. Meniere's disease, tinnitus, or auditory neuropathy. The spectrum-shaping filter hₛₛ(t) is an inverse of the residual distortion r_{d}(f)that corresponds to the diseased affected audiogram. Said file is used to treat or alleviate the disease, and maximizes patient's full appreciation of music, audio book, digital radio, and other audio materials, which in turn soothe the patient.

The iSOUP assistive listening MP3 file defined by [00248]-[400261] is an implicit format, which saves the user information of a patient into Message. Later on, a MP3 player (connected with an iSOUP Box) can use Message to change the spectrum shape of the original sound so that the shaped spectrum fits with the distorted hearing of the patient. The implicit format maximizes the patient's entertainment. However, the iSOUP assistive listening MP3 file also has another different format, namely an explicit format. The explicit format works for a hearing impaired user, where computer software stores the user information and automatically applies the information to filter the spectrum shape of the original sound. The filtering substitutes the functionality of a hearing aid (HA). The filtered sound is saved as an assistive listening MP3 file. The MP3 file is the explicit format. The MP3 file is an iSOUP-FS frame. The advantage of the explicit format is that a hearing aid wearer can take off the HA and appreciate the MP3 file from a conventional MP3 player.

An optional feature is that: a bit that shows whether an assistive listening MP3 file is the implicit format or the explicit format is saved into Message.

Another optional feature is that: if the bit shows the MP3 file is the explicit format, another normal hearing user will also be able to appreciate the original sound using computer software to restore the original sound. The restoration is done by inverse filtering.

One other optional feature is that: if the user wants to wear the HA to enjoy the MP3, the aforementioned step of the filtering needs to be designed so that the filtering does not substitute the functionality of the HA but compensate the residual mismatch of the HA.

In certain embodiments, both the implicit format and the explicit format of the iSOUP assistive listening MP3 file can be used for music database management. In search of a specific song, the music database management looks up a keyword within Message.

Wireless Telemetry and Internet Telemetry

In a plurality of embodiments, the automatic method of iSOUP wireless telemetry is created by iSOUP over Bluetooth or relevant wireless technologies defined herein. Said method uses the Backward Subframe of FIG. 5 to bear telemetry data, avoiding cable entanglement. To that end, digital data logging and analog waveform recording are automatically and simultaneously done by said method. Meanwhile, the measurement data logging can be connected through an audio cable to a generic receiver, e.g. a computer, cell phone, PDA, or mobile device, to store the data.

In a plurality of embodiments, the method of iSOUP Internet telemetry replaces the audio cable of the method of iSOUP Optimal Auto-Fitting Procedure by an audio cable plus Internet. iSOUP Internet telemetry follows the process of the Internet diagnosis and Internet treatment of iSOUP-IHP. A doctor, a medical consultant, or an authorized person, appears at the other end of Internet connection by Instant Messaging (IM) software. Meanwhile, the measurement result of telemetry is automatically reported through the Backward Subframe to a healthcare provider.

In a plurality of embodiments, the method of iSOUP Internet wireless telemetry replaces the audio cable of the method of iSOUP Optimal Auto-Fitting Procedure by an audio cable plus Internet and Bluetooth (or relevant wireless technologies defined above).

In a plurality of embodiments, iSOUP enables an Internet Telemetry method comprising the steps: a) Said method enables the telemetry plots, medical image, and data of a patient to be viewed anywhere in the world, through an audio link plus Internet. b) Said method works with a conventional user device and follows the process of the Internet diagnosis and Internet treatment of iSOUP-IHP. The measurement result of telemetry is automatically reported through the Backward Subframe to a healthcare provider. c) Said method can transmit music, user information, command, and control messages to the conventional user device through the Forward Subframe of Message. d) Said method can update the processor parameter, program, core, and/or operating system through an audio link plus Internet by iSOUP-IUP.

Internet Chronic Disease Tracker

In a plurality of embodiments, iSOUP enables an Internet chronic disease tracker comprising the steps: a) Visual waveform, audio waveform, heart rate, movement, and other information, can be transmitted to a Bluetooth receiver by an iSOUP surveillance-frame. b) Said tracker is used to measure, record, and monitor. c) Said tracker enjoys low-cost of one-dollar level Bluetooth receiver, and hybrid analog (voice) digital (measurement) transmission on free internet.

Hearing Aid Wireless Controller

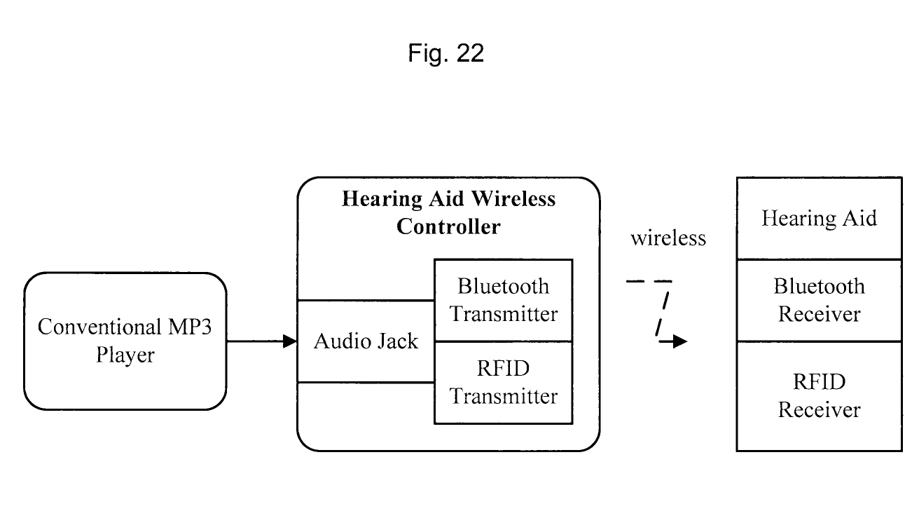

In a plurality of embodiments, iSOUP enables a wireless controller for controlling a hearing aid (HA) remotely and/or playing music to the HA remotely, comprising the steps: a) Said controller can control a HA remotely and/or play music to the HA remotely. For example, said controller can switch the HA to different programs, or adjust the HA volume. b) Said controller consists of an audio jack, an Bluetooth transmitter, and an RFID (Radio Frequency IDentification) transmitter, as shown in FIG. 22. Said controller works with a hearing aid (HA) and a conventional MP3 player. The HA is integrated with a Bluetooth receiver and a RFID receiver. The conventional MP3 player as well as the Bluetooth transmitter is optional. c) If the functionality of remotely playing music is not needed in an embodiment, the Bluetooth transmitter and the conventional MP3 player can be removed and will not be needed. In this case, when the HA has multiple modes (e.g. multiple modes can represent multiple DSP programs, multiple configurations, multiple values of a parameter, or multiple levels of volume (i.e. remote volume control)), a user can switch from one mode to another based on time-varying conversational environments or personal preference. When the user switches to some mode, the RFID transmitter will deliver the mode to the RFID receiver. The RFID receiver will wake up and inform the hearing aid (HA) to switch to the mode. d) If remotely playing music is needed in an embodiment, the Bluetooth transmitter will be needed. Then, in daily use, the RFID transmitter informs the HA to switch to the mode of “music”. The MP3 player plays music to the audio jack, which finally transmits the music through Bluetooth to the HA. e) Bluetooth and RFID can be replaced by any of relevant wireless technologies. f) The MP3 player can be replaced by any audio player. g) Said controller can be personalized, configured, or reconfigured for a specific user by iSOUP-FS.

Bluetooth Musical HAs and AIs

In a plurality of embodiments, iSOUP enables a Bluetooth hearing aid (HA) comprising the steps: a) Rather than over an audio cable, information transmission is over a Bluetooth audio connection. b) Said HA can also use one of passive RFID (Radio Frequency Identification) and relevant wireless technologies, instead of Bluetooth.

Audio-Visual HAs/AIs and Eyeglass HAs/CIs

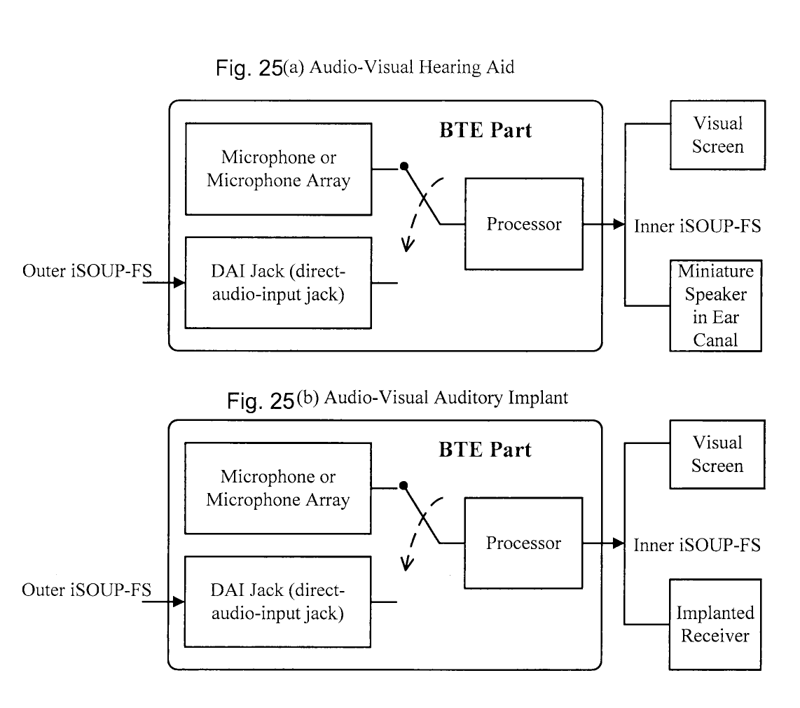

In a plurality of embodiments, iSOUP enables an audio-visual hearing aid (HA) comprising all or part of iSOUP technique and the steps shown in FIG. 25 for full CD-quality music appreciation, highest entertainment, and/or highest speech perception: a) Said audio-visual HA benefits from auditory and visual coordination, especially useful for full CD-quality music appreciation, highest entertainment, and highest speech perception. Said audio-visual HA is also superior in case that: (1) environmental lumination is insufficient for lipreading; (2) speaker can not be seen, e.g. speaker's voice is from behind listener or speaker is obstructed; and (3) speaker turns away from you during conversation. b) The timing offset between the stimulation of eyes and the stimulation of ears is precisely configured, controlled, and shifted by Message being embedded in the audio-visual stimulus. The precise configuration of the timing offset is critical for maximum audio-visual integrated sensation, based on the fact that: b.i) Longer or inaccurate audio-visual delay can cause interference between speech and visual integration. b.ii) The stimulation rate of the visual cue used in said device is jointly determined by (1) foveal vision is very slow with only 3 to 4 high quality telescopic images per second; and (2) peripheral vision is very inaccurate but also very fast with up to 90 images per second (permitting to see the flicker of the 50 Hz TV images). c) Therefore, Timing Offset Msg of the iSOUP-FS frame is used to adjust the timing offset of the stimulation times between the audio receiver and the eyeglass. The adjustment compensates the different response times of photoreceptor and auditory mechanoreceptor plus the different processing times of auditory cortex and visual cortex. Furthermore, the precise adjustment is used to match a user's individual brain capability and personalize said device. d) Referring to FIG. 25, there are two connections using an iSOUP-FS frame. The first is an outer iSOUP-FS, which is transmitted from a conventional MP3 player to the DAI jack of said HA. The second is an inner iSOUP-FS, which is transmitted from the processor of said HA to both a visual screen and a miniature speaker (in ear canal). e) The processor takes a sound either from a microphone or from the DAI jack. f) When the processor takes the sound from the DAI jack, the DAI jack is driven by a conventional MP3 player that plays a MP3 file. The MP3 file can be an iSOUP assistive listening MP3 file to enhance the full hearing of CD-quality music of hearing-impaired users. f.i) Visual cue is embedded in Left-Eye Msg and Right-Eye Msg of the iSOUP assistive listening MP3 file. The visual cue can be but is not limited to the feature information: energy, rms, magnitude spectrum, phase spectrum, spectrogram, intensity, pitch, formants (F1, F2, F3, F4, F5, and F6), slope of pitch, interval of pitch, contour of pitch, rhythm, onset time-points, sound source location, sensory type, sensory location, sensory duration, mean, standard deviation, skewness, kurtosis, high-order central moments, cumulants, and/or any statistical characteristics. The iSOUP assistive listening MP3 file, which shall be personalized for each user, compensates the residual distortion of the user's aided audiogram. f.ii) After the processor processes the sound, it sends out an inner iSOUP-FS to both a visual screen and a miniature speaker in the ear canal. The visual screen shows the foregoing visual cue. The visual screen is a small electronic screen made of (but not limited to) LCD or relevant display technologies. f.iii) On the visual screen, a progress bar, a flashing arrow, a digital number, a letter/word, a light, a light array, a transient flashing effect, an image, or any other content, is displayed. Here, the displayed content is directly controlled by the foregoing visual cue. The shape of the visual screen can be but is not limited to rectangle, cylinder, sphere, triangle, disc, or any geometric shape. Here, the displayed content is directly controlled by the foregoing visual cue. For example, the direction that is pinpointed by the flashing arrow is sound source location, the lit part of the progress bar is proportional to the height of pitch/intensity/energy/rms, the onset of the transient flashing effect is the sound onset time-points, the different colors of the transient flashing effect depends on the different sound source locations, or the digital number is the instantaneous value of any feature information. f.iv)

Two or more of the visual cues can be shown simultaneously when the visual screen has two or more parts. For example, one left part shows sound source location, while one right part shows pitch/intensity/energy/rms height or onset time-points. The left part can be controlled by Left-Eye Msg, while the right can be controlled by Right-Eye Msg. f.v) If the displayed content is not digital but analog, Left-Eye Waveform and Right-Eye Waveform can be used to convey the visual cue in an analog manner. For example, the visual cure can be continuous and obtained from filtering. f.vi) The visual screen can be mounted onto an eyeglass, headband, hat, wristwatch, wristband, waist clip, bracelet, armlet, neckloop, in-pocket device, waistband, clothes clip, fabric sensor based garment, headset, or headphone. g) Otherwise, if the processor takes a sound from the microphone, the visual cue is embedded into Left-Eye Msg and Right-Eye Msg of the foregoing inner iSOUP. The embedding is done by the processor of said HA through extracting the feature information of the sound. h) Whether the processor takes the sound from the DAI jack or the microphone, said HA employs audio-visual integration to maximize speech perception and full CD-quality music appreciation, based on the fact of that: neuroscience research has already shown that the visual cortex of even adult blind people can become responsive to sound, and sound-induced illusory flashes can be evoked in most sighted people. i) The processor parameter, program, core, and/or operating system of said HA can be updated through an audio link plus Internet by iSOUP-IUP. j) Said device can train brain development and brain coordination of deaf children.

General Use

It should be appreciated that low-cost methods, apparatus, and systems implementing certain aspects of the invention can be used in current and future electronic devices, entertainment devices and medical devices. Moreover, simplified versions of iSOUP-FS, iSOUP-TP, iSOUP-UOP, iSOUP-IUP, iSOUP-IHP, iSOUP-AEP, iSOUP-IAP, and iSOUP-BFRP can be used to enhance current processors' capability and efficiency of said devices, particularly when the transmission is based on an audio link.

It should be appreciated that the method of iSOUP-UOP can create a standalone device or be integrated as a building block into a larger system. Here, said standalone device supports the functionality of iSOUP-UOP. Said standalone device and said integrated system are two variations. The present invention covers the two variations. Similarly, each of iSOUP-IUP, iSOUP-IHP, iSOUP-AEP, iSOUP-IAP, iSOUP-BFRP, and iSOUP-FS can create a standalone device or be integrated as a blocking block into a larger system. The present invention covers all the created devices and all the integrated systems.

For the first time, the disclosed invention creates the methods, apparatus and systems that jointly transmit and process inaudible digital information or hybrid analog-digital information through an audio cable, wireless audio connection, over-the-air audio connection, Internet, or other media. Said transmitting and processing jointly is one use of the invention. Other uses of the disclosed invention include but are not limited to the transmission of underwater audio connection, infrared audio connection, optical audio connection, mechanical conduction based audio connection, audio connection over a network (constructed by the above connections as well as transmitters, receivers, transceivers, plugs/jacks, audio splitters, adders, multipliers, mixers, modulators, audio adaptors, extension cables, telecoils, and computers), and any combinations of the above.

For every “multisensory device” disclosed in this application, the device shall automatically have 255 variations: its 8-sensory version (using audio-visual-taste-smell-touch-linear-acceleration-rotary-temperature signal in said device) and all its 254 simplified devices. The signal used by a simplified device, is one of the following 254 types:
audio signal, visual signal, taste signal, smell signal, touch signal, linear-acceleration signal, rotary signal, and temperature signal, all of which are 1-sensory. The subtotal number of 1-sensory signals is eight.
audio-visual signal, audio-temperature signal, and other twenty-six 2-sensory signals. The subtotal number of 2-sensory signals is twenty-eight. The twenty-eight signals can be enumerated by the four steps: (1) define a universal set={a, b, c, d, e, f, g, h}; (2) all the mathematical 2-combinations from the universal set are a-b, a-c, a-d, a-e, a-f, a-g, a-h, b-c, b-d, b-e, b-f, b-g, b-h, c-d, c-e, c-f, c-g, c-h, d-e, d-f, d-g, d-h, e-f, e-g, e-h, f-g, f-h, and g-h; (3) define a=audio, b=visual, c=temperature, e=smell, d=taste, f=touch, g=linear-acceleration, and h=rotary; and (4) substitute the definitions into the above twenty-eight mathematical 2-combinations, and obtain the twenty-eight terms of audio-visual signal, audio-temperature signal, . . . , and linear-acceleration-rotary signal. Correspondingly, the universal set becomes {audio, visual, temperature, smell, taste, touch, linear-acceleration, rotary}.
audio-visual-temperature signal, and other fifty-five 3-sensory signals. The subtotal number of 3-sensory signals is fifty-six. The fifty-six signals can be enumerated by all the mathematical 3-combinations from the universal set {audio, visual, temperature, smell, taste, touch, linear-acceleration, rotary}.
audio-visual-temperature-smell signal, and other sixty-nine 4-sensory signals. The subtotal number of 4-sensory signals is seventy. The seventy signals can be enumerated by all the mathematical 4-combinations from the universal set {audio, visual, temperature, smell, taste, touch, linear-acceleration, rotary}.
audio-visual-temperature-smell-taste signal, and other fifty-five 5-sensory signals. The subtotal number of 5-sensory signals is fifty-six. The fifty-six signals can be enumerated by all the mathematical 5-combinations from the universal set {audio, visual, temperature, smell, taste, touch, linear-acceleration, rotary}.
audio-visual-temperature-smell-taste-rotary signal, and twenty-seven 6-sensory signals. The subtotal number of 6-sensory signals is twenty-eight. The twenty-eight signals can be enumerated by all the mathematical 6-combinations from the universal set {audio, visual, temperature, smell, taste, touch, linear-acceleration, rotary}.
audio-visual-temperature-smell-taste-rotary-linear-acceleration signal, and other seven 7-sensory signals. The subtotal number of 7-sensory signals is eight. The eight signals can be enumerated by all the mathematical 7-combinations from the universal set {audio, visual, temperature, smell, taste, touch, linear-acceleration, rotary}.

Thus, by summing up the subtotals, the total of the above types is 254. Therefore, each simplified device corresponds to and uses one of the above 254 types. For a simplified device, its Message in iSOUP-FS is a simplified version of FIG. 5. For example, if the simplified device uses audio-visual signal, then only Left-Eye Msg, Right-Eye Msg, Left-Ear, Right-Ear, Binocular-Balance Msg, Binaural-Balance Msg, Timing Offset Msg, and User Msg are kept in iSOUP-FS Message, while Smell Msg, Taste Msg, Spinning Msg, Linear-Acceleration Msg, and Temperature Msg are removed. Similarly, in T-Signal, Smell Waveform, Taste Waveform, Spinning Waveform, Linear-Acceleration Waveform, and Temperature Waveform, are removed. In summary, for a simplified device using an n-sensory signal, its Message (or its T-Signal) in iSOUP-FS is a simplified version, where the Msgs (or Waveforms) associated to unused senses, are removed. Finally, 254 simplified devices of the aforementioned 8-sensory device are created. The present invention covers each 8-sensory device and all its 254 simplified devices

Similar to above, a “8-sensory frame” (of an 8-sensory device) shall mean an iSOUP Frame Structure (iSOUP-FS) that uses all messages and all waveforms relevant to 8 senses: Left-Eye Msg, Right-Eye Msg, Binocular-Balance Msg, Left-Ear Msg, Right-Ear Msg, Binaural-Balance Msg, Taste Msg, Smell Msg, Touch Msg, Linear-Acceleration Msg, Spinning Msg, Temperature Msg, Left-Eye Waveform, Right-Eye Waveform, Left-Ear Waveform, Right-Ear Waveform, Taste Waveform, Smell Waveform, Touch Waveform, Linear-Acceleration Waveform, Spinning Waveform, and Temperature Waveform. The term “254 simplified frames” (of an 8-sensory frame) shall mean the 254 frames that use the messages and the waveforms enumerated above in the categories of 1-sensory, 2-sensory, 3-sensory, 4-sensory, 5-sensory, 6-sensory, and 7-sensory. The term “multisensory frame” shall mean an 8-sensory frame or any of its 254 simplified frames. The present invention covers all the variations of the 8-sensory frame and its 254 simplified frames.

For every “Bluetooth” used in the invention, the device described with this “Bluetooth” shall automatically have the variations in which the Bluetooth technology is replaced by one of relevant wireless technologies, including but not limited to Zigbee™, RFID™, WiFi™, WiMax™, ANT network, FM (Frequency Modulation) system, AM (Amplitude Modulation) system, PM (Phase Modulation) system, any system using one of relevant modulation schemes (defined herein), or any existing/customized wireless techniques. The present invention covers all these variations.

For every “audio link” used in this application, the device described with this “audio link” may have up to eighteen variations:
the first variation is the device based on an audio cable;
the second variation is the device in which the audio cable is replaced by one of Bluetooth and relevant wireless technologies defined herein;
the third variation is the device in which the audio cable is replaced by an inaudible over-the-air audio connection (e.g. from a loudspeaker to a microphone via free field);
the fourth variation is the device in which the audio cable is replaced by an underwater audio connection;
the fifth variation is the device in which the audio cable is replaced by an infrared audio connection;
the sixth variation is the device in which the audio cable is replaced by an optical audio connection;
the seventh variation is the device in which the audio cable is replaced by a mechanical conduction based audio connection;
the eighth variation is the device in which the audio cable is replaced by an audio connection over a network that is constructed by audio links, transmitters, receivers, transceivers, plugs/jacks, audio splitters, adders, multipliers, mixers, modulators, audio adaptors, extension cables, telecoils, and computers;
the ninth variation is the device in which the audio cable is replaced by an audio connections combined with each of the above;
the tenth, eleventh, twelfth, thirteenth, fourteenth, fifteenth, sixteenth, seventeenth, and eighteenth embodiments are the devices in which the audio links of the above first to ninth embodiments are extended by Internet, respectively. Here, the term “being extended by Internet” shall mean an audio link connects a terminal (or a computer) that has Internet connection to a remote terminal (or a remote computer), where the remote terminal (or a remote computer) is supervised by a machine or another person (e.g. a doctor, a medical consultant, or an authorized person).

The present invention covers all the eighteen variations. For every embodiment that comprises an auditory implant (AI), the embodiment shall automatically have eight variations: the first variation uses middle ear implant (MEI), the second uses bone conduction implant (BCI), the third uses vestibular implant (VI), the fourth uses cochlear implant (CI), the fifth uses hybrid cochlear/vestibular implant (HCVI), the sixth uses auditory nerve implant (ANI), the seventh uses auditory brainstem implant (ABI), and the eighth uses auditory midbrain implant (AMI). The present invention covers all the eight variations.

For every embodiment disclosed in the invention, the embodiment shall automatically have two variations: the first variation is the embodiment itself, and the second variation is the embodiment whose processor parameter, program, core, and/or operating system are updated through an audio link plus Internet by iSOUP-IUP. The present invention covers both of the two variations.

For every embodiment disclosed in the invention, the embodiment shall automatically have variations in which Prefix, Message, Postfix, and/or any combinations of the three, are adjusted from inaudible level(s) to audible level(s). The present invention covers all these variations.

For every embodiment disclosed in the invention, the embodiment shall automatically have two variations: (1) the first variation is a standalone device that completely realizes the embodiment; and (2) the second variation is an integrated system, where the embodiment is integrated as a part onto another device (e.g. a hearing aid, an auditory implant, or a MP3 player). The present invention covers the two variations.

With respect to embodiments that comprise a transmitter, the transmitter shall mean any of the transmitting devices of a MP3 player, MP4 player, WMA player, WAV player, CD player, computer, cell phone, loudspeaker, iPod™, iPhone™, PDA (Personal Digital Assistant), handheld computer, amplifier's output, camcorders, tape player, MD (MiniDisc), Hi-MD, electric instruments (e.g. guitars, keyboard, and organs), professional console, audio mixing desk, walkman, AM/FM radio, telecoil, modular synthesizer, and any combinations of the above. An audio player shall equivalently mean a transmitter.

With respect to embodiments that comprise a receiver, the receiver shall mean any of the receiving devices of microphone, headphone, headset, earphone, earpiece, earset, computer, cell phone headset, canalphone, audio recorder, PDA, handheld computer, amplifier's input, hearing aid, auditory implants, hydrophone, camcorders, professional console, audio mixing desks, telecoil, effects processing device, camera flash synchronization input, and any combinations of the above.

With respect to embodiments that comprise a transceiver, the transceiver shall mean any of the transceiving devices, each of which is a combination of a transmitter and a receiver, either physically or functionally.

Wireless Connector

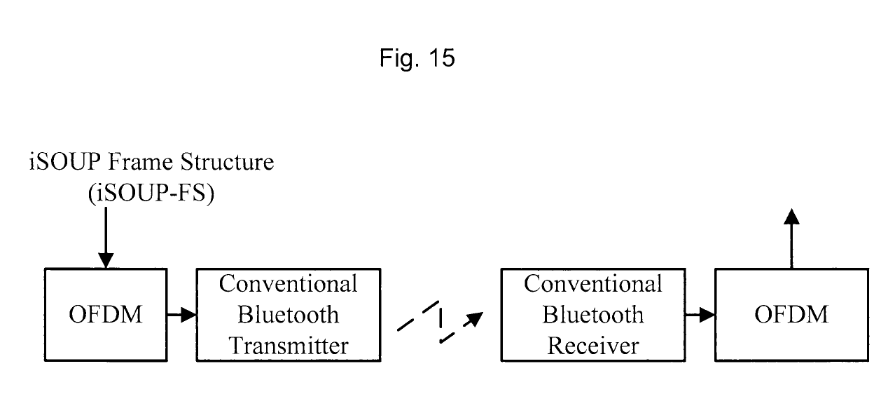

A wireless connector comprising a wireless audio connection that is controlled by iSOUP on Bluetooth™ or relevant wireless technologies defined herein. Said wireless connector is for interconnecting devices or building up a network. With reference to FIG. 15, depicted in one embodiment of a Bluetooth iSOUP Frame Structure (iSOUP-FS) over orthogonal frequency-division multiplexing (OFDM). In the structure of FIG. 15, iSOUP Frame Structure (iSOUP-FS) is first transmitted through an OFDM (orthogonal frequency-division multiplexing) module to a conventional Bluetooth transmitter. After the conventional Bluetooth receiver receives the frame, it will send the frame to another OFDM module for output. An optional feature is that Bluetooth can be substituted by one of relevant wireless technologies defined herein. Another optional feature is that OFDM can be replaced by other multicarrier technologies as described herein.

Anti-Piracy MP3 Player

As shown in FIG. 16, an MP3 player includes a conventional MP3 player and an anti-piracy box. The anti-piracy box consists of an audio-in jack, an iSOUP Box, and an audio-out jack. When a company sells a music file of a song, the company transforms the file into an iSOUP-FS. As a licensed user purchases the song, he will get the iSOUP-FS. Then, he can use the conventional MP3 player and play the iSOUP-FS to the anti-piracy box. The output of the anti-piracy box is the normal music. If another user copies the iSOUP-FS and plays it by a conventional MP3 player, he hears a distorted song, which can sound like (including but not limited to) noise, echo, smearing, partial music (plus partial noise), low-quality music, and/or any kind of distorted sound.

Another optional feature is that when the programs, parameters, cores, operating systems of the anti-piracy box need updating or changing, an iSOUP-FS can be played from a computer (or any audio player defined herein) to the anti-piracy box for accomplishing the updating/changing. The conventional MP3 player can be replaced by any audio player defined herein. Said anti-piracy MP3 player shall have a number of variations: anti-piracy MP4 player, anti-piracy CD player, . . . , anti-piracy WAV player. For “each specific player”, an anti-piracy variation of “the specific player” is generated by replacing the conventional MP3 player of FIG. 16 with “the specific player”. The patent covers all these variations.

MP3 Lyrics LCD Displayer

In the case of a low-cost synchronous MP3 lyrics LCD displayer, when a user uses a conventional audio player to play an iSOUP song, the song goes through an audio splitter that has two output branches. Said conventional audio player includes but is not limited to a MP3 player, MP4 player, WMA player, WAV player, CD player, computer, cell phone, iPod™, iPhone™, PDA (Personal Digital Assistant), or handheld computer.

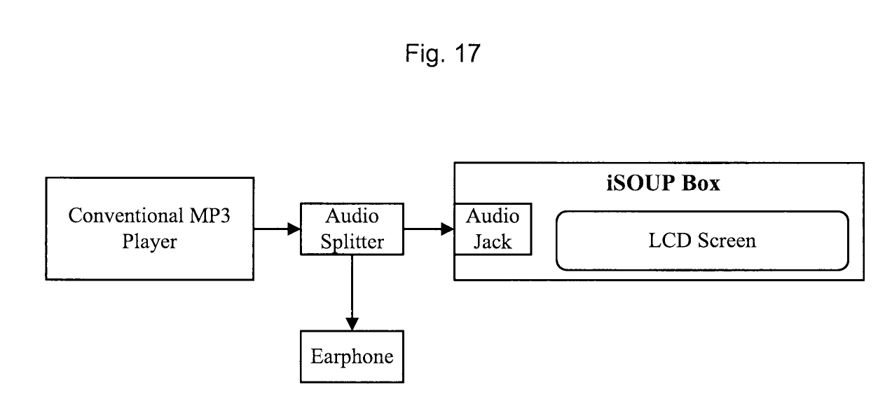

One output branch goes to a conventional audio receiver that a user listens to. Said conventional audio receiver includes but is not limited to headphone, headset, earphone, earpiece, earset, computer, cell phone headset, canalphone, audio recorder, PDA, handheld computer, hearing aid, or auditory implants. The other branch goes to the iSOUP Box that consists of a LCD screen and an audio jack, as shown in FIG. 17. The iSOUP Box displays the lyrics of the song on its LCD Screen. The display of the lyrics is synchronized letter by letter with the flow of the song. The song is created by an iSOUP-FS (iSOUP Frame Structure), where Text Msg stores the lyrics and T-Signal stores an original song. Because Text Msg is inaudible to the user, the user appreciates the song just as he appreciates the original one. Furthermore, simultaneously reading lyrics and listening, form audio-visual integration to achieve highest sensation of music appreciation.

Using the iSOUP Box may have several advantages:
Personalization. Having a favorite song, the user can create his own lyrics for the song. iSOUP-FS can display his own lyrics for fun and entertainment while the song is played.
Filling Lyrics. Having a newest or popular song, the user can find its original lyrics and fill the lyrics into iSOUP-FS for display.
Low-cost and fast-manufactured. All components of iSOUP Box is off-the-shelf and low-cost.
Synchronous. Listening and reading are precisely synchronized so that highest sensation of music appreciation is achieved.

Writing Lyrics. When the user is a lyrics writer, a musician, a composer, or has professional musical background, the iSOUP Box is an optimal job tool for him. For a new song, he can create a number of candidate lyrics, try them all through the iSOUP Box, and narrow down to find the best matched lyrics for the song.

With the MP3 lyrics displayer, an enhancement module may be added between the audio splitter and the earphone (or an audio receiver), and wherein the enhancement module may performs one or more of the following functions: noise cancellation; headset or speaker equalization that flattens frequency response since all audio receivers/transmitters have peaks and dips at certain frequencies; automated mode selection that automatically chooses one of Jazz, Rock, Pop and Classical for each specific song); live sound reproduction; feedback cancellation by which an undesirable “shrieking” sound (that occurs in live music or sound reproduction when the amplified sound from a speaker is picked up by a microphone) is removed; precise lowpass (LP), bandpass (BP), or highpass (HP) filtering, which is used not only to cut unwanted frequencies, but also to enhance frequencies which are not “speaking” well by a specific instrument or on an audio material (e.g. string instruments such as the double bass may have particular notes which cannot be produced at same volume as the other notes on the instrument); echo removal, echo addition, reverb removal, and/or reverb addition. Said functions are determined and controlled by Message of iSOUP-FS.

In the case of a patient having relevant hearing diseases, timing Offset Msg of iSOUP-FS is defined as the timing offset between the song and the lyrics display. The patient adjusts the digital value of Timing Offset Msg to maximize his sensation of simultaneous reading and listening. Said timing offset compensates the sensorineural delay and/or the brain central processing delay that the user's hearing disease causes. Because of the disease, said sensorineural delay and/or said central processing delay of the user is different from normal people.

Said patient lyrics displayer works in either of the two modes:
Mode 1 is Blind Fitting Mode. The user adjusts the value of Timing Offset Msg to find the optimal point to compensate said delays.
Mode 2 is Prior Knowledge Based Mode. The user joins physiological and/or psychological tests to measure the personal values of said delays.

A remote healthcare provider operates to create a special mp3 file at the other end of Internet connection. The mp3 file is played through Internet plus audio cable to the iSOUP Box. The iSOUP Box changes its parameter according to Timing Offset Msg. The user sends a decision to the doctor on whether the user's sensation is better or worse than previous. Based on the decision, the doctor updates a new special mp3 file. Repeat steps until patient's sensation is maximized.

In one embodiment, the invention may be used by an airplane on-board audio-visual system in which a traditional airplane 310 connector (3.5 mm) is used to delivery iSOUP-FS for simultaneous listening and reading lyrics, since this type of 310 connector is often used in the armrests of aircraft entertainment system.

Single-Interface Mini MP3 Player

The invention may be sued by a single-interface MP3 player comprising only one audio jack to both transfer music files (from a computer) and play the files out (to an earphone or an audio receiver), different from a conventional MP3 player that has a specialized data interface for transferring the files from a computer, plus an audio jack for playing music. The mini MP3 player may be manufactured in less weight and smaller size than conventional MP3 players, because only one interface is manufactured instead of two, and the processor parameter, program, core, and/or operating system of said player is updated through an audio link plus Internet by iSOUP-IUP.

Multisensory Entertainment Device

The invention also relates to an 8-sensory entertainment device, comprising simultaneously delivering audio, visual, taste, smell, touch, linear acceleration, rotary, and temperature messages and waveforms through iSOUP-FS, and using 8-sensory integration for highest entertainment and optimal subjective feeling. Multisensory entertainment device according to claim 0, wherein rather than the 8-sensory device of claim 0, one of its 254 simplified devices is used. Said multisensory entertainment device comprises the steps:

Timing Offset Msg of iSOUP-FS is used to adjust the stimulation times of the successive Left-Eye Waveform, Right-Eye Waveform, Left-Ear Waveform, Right-Ear Waveform, Taste Waveform, Smell Waveform, Touch Waveform, Linear Acceleration Waveform, Spinning Waveform, Temperature Waveform, and User Waveform.

The adjustment compensates the different response times of the eight human receptors based on the fact that: different receptors typically have different response times in the order of 200 ms for photoreceptor, 160 ms for auditory mechanoreceptor, 250 ms for olfactoreceptor, 400 ms for gustatoreceptor, 110 ms for touch mechanoreceptor, and 370 ms for pain receptor. The response times of gravity sensitive receptor and thermoreceptor are also different.

Based on said adjustment, highest entertainment, highest sensation, and optimal subjective feeling of multiple senses, are achieved.

First, the eight response times are different from user to user. Second, even for one user, his response times change along with time. Based on these facts, before the configuration of Timing Offset Msg, a Prior Knowledge Based Mode may be executed to perform tests and measure personal up-to-date response times. The measured times are used to compute Timing Offset Msg. If the tests can not be performed, a Blind Fitting Mode may be used instead.

In another embodiment, an underwater entertainment system can use an underwater audio connection to take the role to deliver the iSOUP-FS from an underwater transmitter to an underwater receiver (e.g. hydrophone), and wherein a user emerges underwater for highest music entertainment.

### Audio-Visual Integrator, Audio-Touch Integrator, Audio-Visual-Touch Integrator, Audio-Smell Integrator, Audio-Taste Integrator, and Auditory Skin-Temperature Integrator

According to the principles of the invention, an audio-visual integrator is provided, wherein only audio-visual integration is used for highest entertainment or best treatment, wherein visual information is displayed by LCD display or one of relevant display technologies defined herein.

An audio-touch integrator, an audio-visual-touch integrator, an audio-smell integrator, an audio-taste integrator, and an auditory skin-temperature integrator are also within the principles of the invention.

Multiuser Multimedia Sharing Device

According to the principles of the invention, multiuser multimedia sharing device is provided in which the device can be used in teaching class, music hall, auditorium, multilingual translation, and church. An iSOUP super-frame including multiple frames may be used. Each frame has a field of User ID as defined in FIG. 5. Said User ID determines which user its associated frame is delivered to, where User ID works as a personal address. Said User IDs can vary over frames. Msgs and Waveforms can be different for different users so that different users can appreciate same or different content. In each frame, multiple multimedia materials are embedded into the corresponding Msgs. For each user to achieve real-time sharing, compressed-frame or multichannel time-frequency (MCTF) series can be used. Said device can work with existing FM system. Each user personalizes his preference, which is executed by said device.

Entertainment Special Effects Generator

According to the principles of the invention, an optimal entertainment special effects generator is also provided, wherein the generator comprises a conventional MP3 player connected with an iSOUP Box. Said iSOUP Box generates special effects including but not limited to one or more modes of stereo imaging, chorusing, heavy low frequency effects, echo, reverberation (as in theater, music hall, cinema, auditorium, performance, concerto, and sonata), as well as pitch shifting, phasing, flanging, and additive background sound (e.g. natural sea flows, winds, rains, or lullabies).

For each original audio material (e.g. a song), one of the foregoing modes, which best boosts the audio material, is selected. For example, the reverberation mode can be selected for a concerto song.

The selected mode is saved in Message, while the original audio material is saved in T-Signal of FIG. 5. Then, an iSOUP-FS frame composed of Message and T-Signal, is saved as a new MP3 file. The sound of the new MP3 file is played by a conventional MP3 player to the iSOUP Box.

The iSOUP Box receives the sound, takes the selected mode out of Message, casts the special effects of the mode onto the audio material, and outputs the processed material for user appreciation.

The lyrics may be embedded into Message for display. The generator can be built as a part into a MP3 player, an audio player, or an audio receiver, e.g. headphone, headset, or earphone. The processor parameter, program, core, and/or operating system of said generator is updated through an audio link plus Internet by iSOUP-IUP.

According to the principles of the invention, a 3D stereo imaging shaker is also provided in which interaural time difference (ITD) and interaural level difference (ILD) shake (or change) over time so that a user feels the virtual sound sources in an audio material changes over time in the virtual 3D space imagined by his brain. Thus, said shaker creates time-varying stereo imaging. The ITD and the ILD vary in accordance to a stereo time-frequency (TF) series. The stereo TF series is controlled by User Msg of iSOUP-FS. User Msg changes frame to frame so that the stereo TF series changes frame by frame, and the virtual sound sources change frame by frame in the user's brain, and the user can freely edit the preferred values of User Msg of all frames.

In addition, one of chorusing, heavy low frequency effects, echo, reverberation, shifting, phasing, flanging, and additive background sound, replaces the role of stereo imaging. The effect of a concerto is mimicked by mixing the sounds of multiple instruments (including but not limited to strings, woodwinds, brass instruments, and percussion instruments) by using different ITDs (interaural time difference) and ILDs (interaural level difference) for different instruments. The ITDs and the ILDs are controlled by stereo time-frequency (TF) series, respectively. The timing offsets between the different sounds are stored in Timing Offset Msg. The effect of concerto is created by adding the different sounds together. The creation is changed frame by frame so that the shaking of the sound sources is created.

Still another aspect is a helmet sound system which uses a stereo audio connection to both the left ear and the right ear of a user, and connecting them to a helmet through an audio link over iSOUP technique.

Multisensory Special Effects Generator

According to the principles of the invention, a multisensory entertainment special effects generator may be provided, but rather than an audio-only iSOUP frame, an 8-sensory (audio-visual-taste-smell-touch-linear-acceleration-rotary-temperature) frame or one of its 254 simplified frames, is used. Said generator stimulates multiple devices simultaneously and aims at multiple human sensory receptors to maximize entertainment and integration. The processor parameter, program, core, and/or operating system of said generator is updated through an audio link plus Internet by iSOUP-IUP.

Fast Verification Tool

According to the principles of the invention, a verification tool is provided. Said tool checks real-time steps of a new algorithm running within a user's processor and verify the correctness of each step of the algorithm, namely synchronous verification and debugging (SVD). In said SVD, there is only an audio link between a host computer and said processor. Said verification tool is the first one-audio-link based verification tool, which offers to stop a real-time algorithm at any desired point and compare the intermediate result of the point with theoretical result. Said comparison is fast and precise, and even for a user's analog waveform input into the processor, each bit of intermediate/final digital result can be scrutinized during running. And development cycle is fast.

Optimal Children Learning Device

According to the principles of the invention, an optimal synchronous children learning device is also provided. The optimal synchronous children learning device uses an 8-sensory frame or one of its 254 simplified frames, composed of Message and T-Signal, and can be used in a method that includes activating a child's multiple human sensory receptors simultaneously so that the child can learn new knowledge faster, more completely, more tangibly, more vividly, and more impressively; improving brain development by learning, based on the fact that efficient learning depends on integration of all sensory inputs, audio, visual, taste, smell, touch, linear-acceleration, rotary, temperature, in a part of the brain called the cerebellum; improving creative potential, balance, co-ordination, short-term memory, long-term memory, spelling, language fluency, focus, and concentration; and improving cerebellar integration, speed and efficiency of the brain for comprehending, sorting and remembering information.

Additionally, the processor parameter, program, core, and/or operating system of said device are updated through an audio link plus Internet by iSOUP-IUP.

Real-Time Algorithm Accelerator

The principles of the invention further provide a real-time algorithm accelerator for enhancing the performance of a conventional user device, and solving the conventional problem that: the conventional user device can not afford the computation due to limited power consumption, size, and weight when a higher-version algorithm becomes available and more intelligent but more computationally intensive.

Said accelerator includes an iSOUP Box running iSOUP Algorithm Enhancement Procedure (iSOUP-AEP) with iSOUP-FS, iSOUP-TP, iSOUP-UOP, iSOUP-IUP, and iSOUP-IHP.

The iSOUP-AEP here includes an Acceleration-Part (A-Part) to make a Resident-Part (R-Part) run faster, which transforms a computationally intensive offline algorithm into a real-time implementation, with no hardware added. The A-Part runs within the iSOUP Box, while the R-Part runs within a conventional user device so that the performance of the conventional user device can be optimally enhanced.

Before execution, a new algorithm is partitioned into the A-Part and the R-Part. The A-Part is a computational core that bears major computational load, e.g. wavelet transform, speaker recognition, noise cancellation, music onset detection, pitch extraction, or extraction of the feature information defined herein. The R-Part is a part that jointly combines digital Message and analog T-Signal to reach a high performance. The R-Part can be used to make use of the feature information. The iSOUP Box works in either of two modes: the integrated mode and the standalone mode as defined in FIG. 12.

As a non-real-time to real-time transformer, said accelerator provides a low-cost device in small size and still offers conventional uses of playing music. The newest update of software can be tracked online and remote supervision for home use can be provided.

The iSOUP Box consists of two parallel modules, where one module is for the conventional use of playing analog audio signal (music), and the other is the Resident-Part for iSOUP-AEP (iSOUP Algorithm Enhancement Procedure). The processor parameter, program, core, and/or operating system of said accelerator is updated through an audio link plus Internet by iSOUP-IUP.

The accelerator is a perceptual music onset detector running for music analysis applications based on the fact that: the physical onset time and the perceptual onset time of a musical tone are distinctive, where the former occurs when the tone reaches a level of approximately 6-15 dB below its maximum value. The accelerator is a real-time pitch extractor used with a conventional audio player defined herein, and such a use does not exist currently.

iSOUP Network

The principles of the invention further envision a network, comprising edges, lines, and interconnections that are created by iSOUP technique using transmitters, receivers, transceivers, and/or audio links.

Parallel Processing System

In the case of a parallel processing system, the system may include a plurality of modules. Each module runs on a separate node of a network. The edges, lines, and interconnections between two nodes are created by audio links plus iSOUP technique.

Multiple-Device Synchronizer

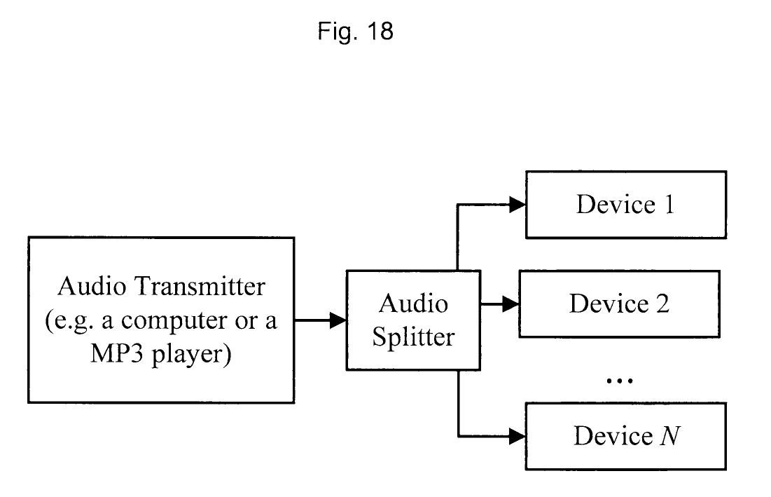

In the case of a multiple-device synchronizer, one embodiment of the structure of said synchronizer is as FIG. 18. An audio transmitter sends out an iSOUP-FS frame to multiple devices (namely Device 1, Device 2, . . . , Device N) through an audio splitter. The times that N devices work are synchronized by the frame. Devices 1, 2, . . . , N can be different.

For Data Hiding

Anti-Piracy MP3 File

The principles of the invention further provide an anti-piracy MP3 file. Said MP3 file is used for anti-piracy to avoid illegal pirated copies. Listening directly to the sound of the file, a person can only hear unbearable low-quality music. Thus, a pirated copy of the file cannot offer benefit for the person. Said MP3 file invalidates illegal pirated copies in two layers. Layer 1 is that only a unique MP3 player can play the sound of the file. Said MP3 player is unique to its legal owner. Additionally, the anti-piracy MP3 file distributed to the owner by entertainment and/or music companies is also personalized and unique to him. Based on the uniqueness of both said player and said Mp3 file, only the owner can appreciate the CD-quality music out of the file. Layer 2, another person's MP3 player can not play the sound of the owner's file.

Said file is created by iSOUP inaudible data hiding (IDH). The information of User ID, Serial Number, Music ID, relative amplitudes, delays, production date, distribution date, reproduction date, purchase date, purchase store, user class, bar code, and/or user msg are embedded into Message of iSOUP-FS. The Prefix, Message, and Postfix are then attached to an original MP3 file by one of the four multiplexing types (sequential IDH, parallel IDH, overlapped IDH, and MCTF IDH) as well as one of the two interleaving methods (delay method and allocation method, as defined herein).

The Prefix, Message, and Postfix are inaudible based on iSOUP-IAP. The T-Signal stores the waveform of the original MP3 file. The iSOUP-FS generated by Prefix, Message, T-Signal, and Postfix, is saved as the iSOUP anti-piracy MP3 file. The relative amplitude of the delay method may be increased to a level that an unlicensed user can only hear meaningless noise, rather than unbearable low-quality music, and wherein said file provides stricter protection.

Rather than the delay method, the allocation method is used, and wherein allocating different segments of music into non-continuous frequency bands makes them unbearable, jointly making distortion in time domain and/or frequency domain. The iSOUP Box may add special effects for music, which is embedded in Message. The processor parameter, program, core, and/or operating system of said file is updated through an audio link plus Internet by iSOUP-IUP.

For the iSOUP anti-piracy file formats, the interleaving method of the 1st format is the delay method referred to above, while the multiplexing type of the 1st format is the sequential inaudible data hiding (IDH) described above. The interleaving method of the 2nd format may be the delay method defined herein, while the multiplexing type of the 2nd format is the parallel inaudible data hiding (IDH) defined herein.

The interleaving method of the 3rd format is the delay method defined herein, while the multiplexing type of the 3rd format is the overlapped inaudible data hiding (IDH) defined herein.

The interleaving method of the 4th format is the delay method defined herein, while the multiplexing type of the 4th format is the multichannel time frequency inaudible data hiding (IDH) defined herein.

The interleaving method of the 5th format is the allocation method defined herein, while the multiplexing type of the 5th format is the sequential inaudible data hiding (IDH) defined herein.

The interleaving method of the 6th format is the allocation method defined herein, while the multiplexing type of the 6th format is the parallel inaudible data hiding (IDH) defined herein.

The interleaving method of the 7th format is the allocation method defined herein, while the multiplexing type of the 7th format is the overlapped inaudible data hiding (IDH) defined herein.

The interleaving method of the 8th format is the allocation method defined herein, while the multiplexing type of the 8th format is the multichannel time frequency inaudible data hiding (IDH) defined herein.

Inaudible Copyright Protector

The principles of the invention further provide for an inaudible copyright protector. Said protector includes two parts. The first part is an iSOUP MP3 file distributed and released by entertainment and/or music companies in the same way as conventional MP3 files. The sound of said iSOUP MP3 file can be played by any conventional MP3 players and appreciated just like conventional MP3 files. The second part is an inspection device that reads inaudible Message out of said file.

During anti-piracy enforcement, said file can be inspected by playing it to the inspection device to verify User ID, Serial Number, Music ID, production date, distribution date, reproduction date, purchase date, purchase store, user class, bar code, and/or user msg. The inspection device tells whether said file is a pirated copy or not, whether said file has been modified illegally, who is its legal owner, whether everything is legal, and/or where the source of the music is.

Said protector works in the same way to the iSOUP anti-piracy MP3 file of above, while the only difference is that said protector keeps music as original without distortion.

Said protector protects the copyright of music by means a hardware of the inspection device can read the user information, out of Message of the music. If there is a mismatched user (i.e. user ID is different from the listener), a modification, or a violation, the iSOUP device can caution anti-piracy reinforcement personnel. Although said protector is similar to the iSOUP anti-piracy MP3 file, music is kept high-quality and not distorted. The processor parameter, program, core, and/or operating system of said protector is updated through an audio link plus Internet by iSOUP-IUP.

Inaudible Data Hider

The principles of the invention further provide for an inaudible data hider. Said data hider is used by music inventory and music database for automatic generation of audio materials, search, auto-indexing, use, and routine maintenance. For example, said data hider can insert the data of User ID, Serial Number, Music ID, production date, distribution date, reproduction date, purchase date, purchase store, user class, bar code, and/or user msg. The inserted data is an inaudible part attached to an original MP3 file. Based on reading and writing of the inserted data, music inventory and music database with their routine maintenance can be done.

Said data hider includes two parts. The first part is an iSOUP MP3 file distributed and released by entertainment and/or music companies in the same way as conventional MP3 files. The sound of the distributed file can be played by any conventional MP3 players and appreciated like conventional MP3 files. The second part is an iSOUP software that reads, edits, and writes inaudible Message into (or out of) said file. Said software works as a standalone tool or integrated as a building block into a database. The processor parameter, program, core, and/or operating system of said hider is updated through an audio link plus Internet by iSOUP-IUP.

Audio Sales Tracker

The principles of the invention further provide for an audio sales tracker. Said tracker tracks users and music sales chain of sales, distribution, and management for music products for manufacturers, producers, stores, distributors, retailers, and logistics centers.

Said tracker includes two parts. The first part is an iSOUP MP3 file distributed and released by entertainment and/or music companies in the same way as conventional MP3 files. The sound of said file can be played by any conventional MP3 players and appreciated like conventional MP3 files. The second part is a standalone inspection device that reads inaudible Message out of said file.

Said tracker works in the same way, while the exception is during the tracking of music products at manufacturers, stores and logistics centers, said file can be played to a standalone inspection device for examination. The tracker reads the data of the user information defined herein. The data is automatically recorded and transmitted through iSOUP-FS to a centralized device.

The processor parameter, program, core, and/or operating system of said tracker is updated through an audio link plus Internet by iSOUP-IUP.

For Internet Healthcare

Healthcare Sensor Network

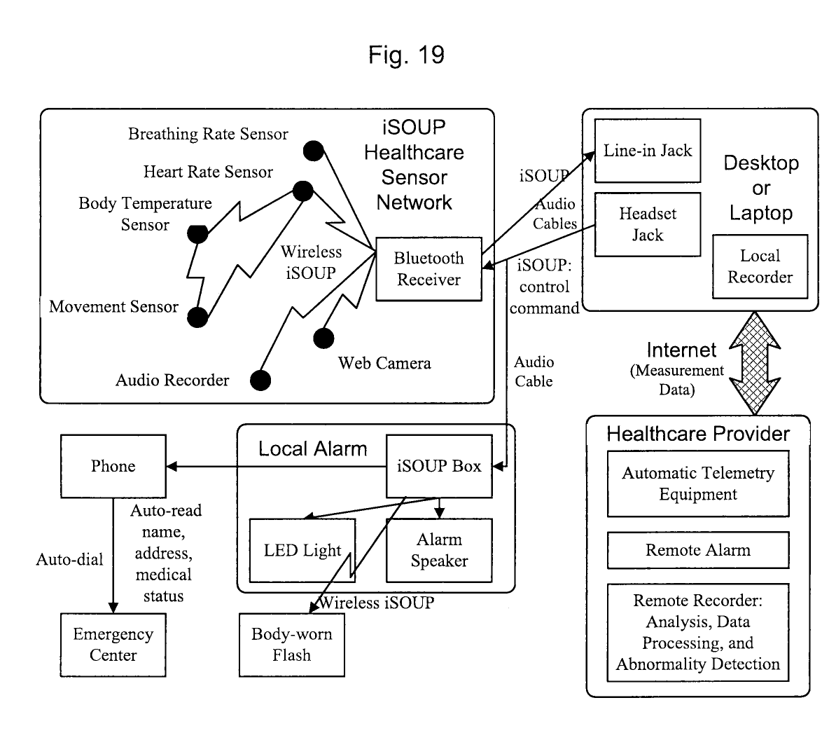

The principles of the invention further envision an iSOUP Healthcare Sensor Network (iSOUP-HSN) for enabling the diagnostic plots of a patient to be viewed anywhere in the world. FIG. 19 depicts one embodiment of an architecture of iSOUP Healthcare Sensor Network (iSOUP-HSN) with Alarming Mechanism

Said iSOUP-HSN include a collection of human body mounted sensors (e.g. heart rate sensor, breathing rate sensor, temperature sensor, and/or movement sensor), audio recorders, visual recorders, audio cables, Bluetooth and relevant wireless technologies, computer, Internet access, local alarm, remote alarm, local recorder, remote recorder, automatic telemetry equipment (ATE), all or part of which are interconnected by iSOUP technique over an audio links.

Said network can be used at home for self training or home treatment by support of iSOUP-IHP (Internet Healthcare Procedure) and iSOUP-IUP (Internet Update Procedure). At home, a user can plug said network into a computer via line-in jack.

Said network updates its processor parameter, program, core, and/or operating system through an audio link plus Internet by iSOUP-IUP.

Said network performs (1) long-term surveillance, (2) Internet diagnosis, (3) Internet treatment, and/or (4) Internet counseling session through an audio link plus Internet by iSOUP-IHP. In more detail, said network provides long-term surveillance of: (1) progress and deterioration of a chronic disease, (2) a user's gradual change of medical status, and (3) performance and side effect of a treatment device, a self-use device, or an assistive device.

Said network can perform a routine Internet based human test/measurement as predefined, where the result of the test/measurement is fed back through iSOUP-FS to a healthcare provider.

Such a telemetry mechanism of said network can be reinforced by a local recorder that writes a result into both a local terminal and a remote recorder that works remotely through iSOUP-IHP, solving the problem that routinely visiting a healthcare provider for measurement or telemetry data costs both money and time.

The human body mounted sensors work at home in awake mode and sleep mode to monitor and track long-term chronic disease and protect a user at home. The mounted sensors use wireless iSOUP-FS to connect a Bluetooth receiver, which is attached to a computer jack. If an abnormal data of sensor measurement is acquired, the computer uses its headset jack with an audio cable to send out iSOUP-FS toward a local alarm. The local alarm includes multiple user-preferred components, e.g. LED light, alarm speaker, and/or body-worn flash. Meanwhile, user's data of sensor is also transmitted to a healthcare provider via an audio cable plus Internet. Said healthcare provider uses an automatic telemetry machine (ATE) to receive the data, which is then scrutinized by a remote alarm. Furthermore, a local recorder runs as software of the user's computer, while a remote recorder works with ATE for analysis and abnormality detection.

The above-reference healthcare sensor network may include a local alarm and a remote alarm. The local alarm includes LED lights, speaker, or body-worn flash/vibrator, is used to caution a user. A remote alarm is used to caution a doctor, a medical consultant, or an authorized person at a remote healthcare provider about an abnormal result.

Any relevant wireless technologies (can collect data through iSOUP-FS in replace of the audio cable. An auto-dial phone for disabled or older persons may be used, where the phone is connected to iSOUP Box to activate auto-reading of name, address, and medical status.

The iSOUP-HSN may be home based, and wherein multiple iSOUP-HSNs connects one healthcare provider (e.g. a medical center) via Internet to form a multiuser sharing system through iSOUP super-frame. The alarm mechanism of iSOUP-HSN may have three levels: normal level, high risk level, and emergence level.

For high risk level, local alarm plus remote alarm will be activated. For emergence level, said two alarms being activated, emergence phone number will be auto-dialed as requested by a user's computer before pre-recorded name, address, and medical status is automatically read out.

The user's analog waveform of voice, photo, and video is recorded and mixed with digital medical measurements, both of which are combined into iSOUP-FS and reported simultaneously to the healthcare provider. Additionally, rather than over an audio cables, transmission is inaudibly over the air.

Bluetooth Sensor

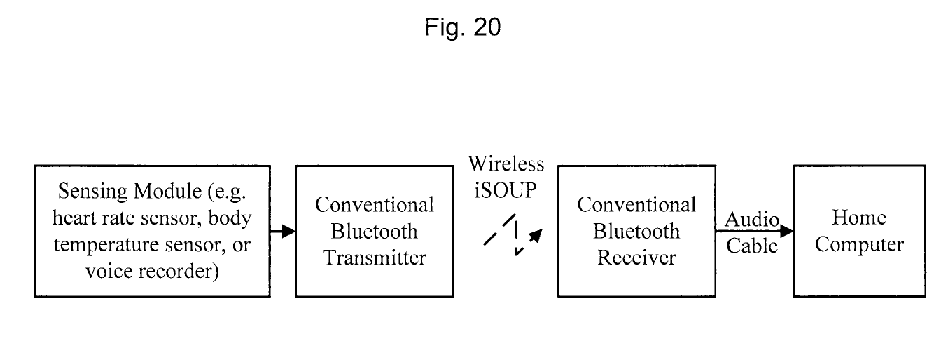

The principles of the invention further provide a Bluetooth sensor comprising a sensing module and a home computer. The structure of said sensor is as FIG. 20. The sensing module inserts an iSOUP-FS frame into a conventional Bluetooth transmitter. The transmitter conveys the frame to a conventional Bluetooth receiver.

The receiver connects a home computer through an audio cable. The home computer records and analyses the frame for a desired purpose.

An optional feature is that: Bluetooth is substituted by one of relevant wireless technologies.

Internet Chronic Disease Tracker

The principles of the invention further provide an Internet chronic disease tracker in which visual waveform, audio waveform, heart rate, movement, and other information, can be transmitted to a Bluetooth receiver by an iSOUP surveillance-frame. Said tracker is used to measure, record, and monitor. Said tracker enjoys low-cost of one-dollar level Bluetooth receiver, and hybrid analog (voice) digital (measurement) transmission on free internet. The processor parameter, program, core, and/or operating system of said tracker is updated through an audio link plus Internet by iSOUP-IUP.

Internet Heart Rate Monitor

The principles of the invention further provide an Internet-based heart-rate monitor. Said monitor enables the diagnostic plots of a patient to be viewed anywhere in the world, and aims at low heart rate patients, Bradycardia patients, postsurgical or older people in sleep, training, weight management, fitness, and race performance analysis, where said monitor measures their heart rate and its variability in real time. The heart rate and its variability are combined with acquired breathing rate and body temperature for joint analysis.

Said monitor consists of a transmitter and a receiver. The transmitter can be but is not limited to a plastic chest strap transmitter, a strapless transmitter, or a fabric sensor based transmitter (for comfort or garment integration), while the receiver is a computer whose jack connects the transmitter via an audio cable. For the fabric sensor based transmitter, movement artifacts are removed by the receiver.

A critical threshold of resting heart rate can be set up, e.g. 50 beats per minute. The threshold can be used to activate local and remote alarms, especially during sleep.

The processor parameter, program, core, and/or operating system of said device are updated through an audio link plus Internet by iSOUP-IUP. Rather than a wired receiver, the wireless receiver (e.g. a wrist receiver or a cell phone), is used.

When a heart beat is detected, a radio signal is transmitted, which the receiver uses to determine the current heart rate. This signal can be based on Bluetooth, ANT wireless network, or relevant wireless technologies.

For Treatment Devices

Music Enhancer

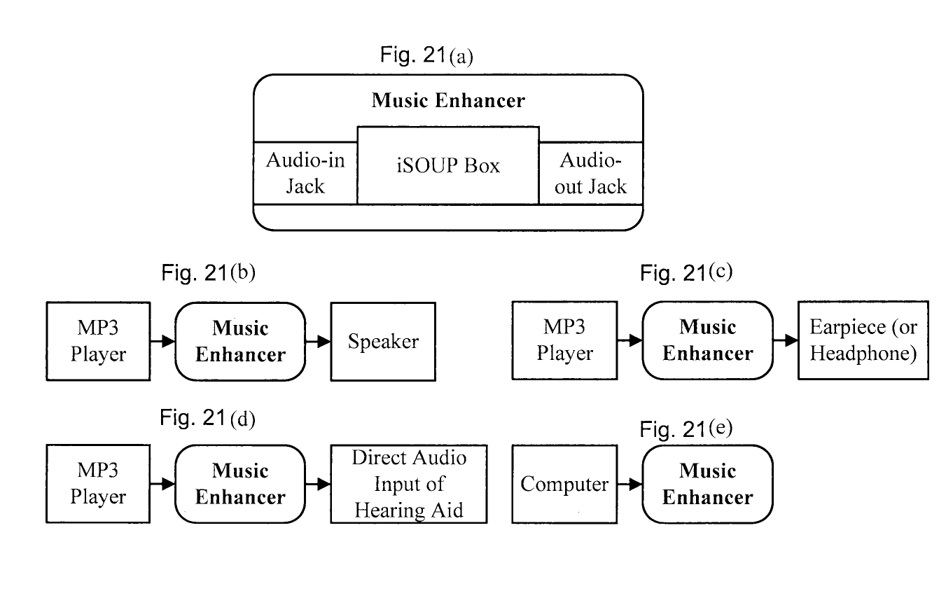

The principles of the invention further provide a music enhancer for enhancing the real-time music appreciation of a hearing aid (HA) user. Said music enhancer consists of an audio-in jack, an iSOUP Box, and an audio-out jack, as shown in FIG. 21-(a). The audio-in jack and the audio-out jack can be any of the connectors defined herein.

Most hearing aids (HA) are optimized for speech but not for music. Thus, a HA user experiences poor perception of music, because there are major physical differences between music and speech. Music can derive from many sources (e.g. a percussive instrument, a woodwind or brass instrument, or a vocal tract) with highly variable long-term spectrum, while long-term spectrum of speech is limited and well defined.

Music has a much larger dynamic range than speech (the dynamic range of music is on the order of 100 dB vs. only 30-35 dB for speech).

The crest factor of music is significantly larger than that of speech (music is on the order of 18-20 dB vs. only 12 dB for speech).

Both music and speech have requirements for amplifying lower- and higher-frequency regions. But their requirements are different.

When said music enhancer is in daily use, the iSOUP Box is used to compensate the HA regarding the differences above between music appreciation and speech perception so that the iSOUP Box works with the direct-audio-input (DAI) of the HA for enhancing the HA user's music appreciation, as shown in FIG. 21-(d).

Another setup is needed to initially configure or reconfigure said music enhancer for a specific HA user (i.e. fitting or refitting), as shown FIG. 21-(e). A computer (or a MP3 player) plays an iSOUP-FS to said music enhancer so that said music enhancer is personalized based on the user's audiogram and other information.

An optional setup is that the HA user employs a loudspeaker instead of the DAI to enjoy a free-field musical sound wave, as shown in FIG. 21-(b). The HA user can either wear a HA or not. If he wears a HA, then the iSOUP Box is used for compensation, while if he does not, then the iSOUP Box completely substitutes the HA to provide better music.

As shown in FIG. 21-(c), another optional setup is that the HA user employs a headphone or an earpiece instead of the loudspeaker of [00382], wherein the headphone can also be replaced by a telephone, a remote microphone, a computer, a CD player, a tape player, a radio, or any audio player defined herein.

All MP3 players above can be replaced by any of the audio players defined herein. Additionally, rather than a hearing aid (HA) user, said music enhancer enhances the music appreciation of a normal-hearing (NH) user.

Rather than a hearing aid (HA) user, said music enhancer enhances the music appreciation of a middle ear implant (MEI) user, and wherein “hearing aid” is replaced by “middle ear implant”.

Rather than a hearing aid (HA) user, said music enhancer enhances the music appreciation of a bone conduction implant (BCI) user, and wherein “hearing aid” is replaced by “bone conduction implant”.

Rather than a hearing aid (HA) user, said music enhancer enhances the music appreciation of a vestibular implant (VI) user, and wherein “hearing aid” is replaced by “vestibular implant”.

Rather than a hearing aid (HA) user, said music enhancer enhances the music appreciation of a cochlear implant (CI) user, and wherein “hearing aid” is replaced by “cochlear implant”.

Rather than a hearing aid (HA) user, said music enhancer enhances the music appreciation of a hybrid cochlear/vestibular implant (HCVI) user, and wherein “hearing aid” is replaced by “hybrid cochlear/vestibular implant”.

Rather than a hearing aid (HA) user, said music enhancer enhances the music appreciation of an auditory nerve implant (ANI) user, and wherein “hearing aid” is replaced by “auditory nerve implant”.

Rather than a hearing aid (HA) user, said music enhancer enhances the music appreciation of an auditory brainstem implant (ABI) user, and wherein “hearing aid” is replaced by “auditory brainstem implant”.

Rather than a hearing aid (HA) user, said music enhancer enhances the music appreciation of an auditory midbrain implant (AMI) user, and wherein “hearing aid” is replaced by “auditory midbrain implant”.

Hearing Aid Wireless Controller

The principles of the invention also provide for a wireless controller for controlling a hearing aid (HA) remotely and/or playing music to the HA remotely. Said controller can control a HA remotely and/or play music to the HA remotely. For example, said controller can switch the HA to different programs, or adjust the HA volume. Said controller consists of an audio jack, an Bluetooth transmitter, and an RFID (Radio Frequency IDentification) transmitter, as shown in FIG. 22. Said controller works with a hearing aid (HA) and a conventional MP3 player. The HA is integrated with a Bluetooth receiver and a RFID receiver. The conventional MP3 player as well as the Bluetooth transmitter is optional.

If the functionality of remotely playing music is not needed in an embodiment, the Bluetooth transmitter and the conventional MP3 player can be removed and will not be needed. In this case, when the HA has multiple modes (e.g. multiple modes can represent multiple DSP programs, multiple configurations, multiple values of a parameter, or multiple levels of volume (i.e. remote volume control)), a user can switch from one mode to another based on time-varying conversational environments or personal preference. When the user switches to some mode, the RFID transmitter will deliver the mode to the RFID receiver. The RFID receiver will wake up and inform the hearing aid (HA) to switch to the mode.

If remotely playing music is needed in an embodiment, the Bluetooth transmitter will be needed. Then, in daily use, the RFID transmitter informs the HA to switch to the mode of “music”. The MP3 player plays music to the audio jack, which finally transmits the music through Bluetooth to the HA. Bluetooth and RFID can be replaced by any of relevant wireless technologies. The MP3 player can be replaced by any audio player. Said controller can be personalized, configured, or reconfigured for a specific user by iSOUP-FS.

Auditory Implant Wireless Controller

Rather than a hearing aid, said controller comprises controlling a middle ear implant (MEI) remotely and/or playing music to the MEI remotely.

Rather than a hearing aid, said controller comprises controlling a bone conduction implant (BCI) remotely and/or playing music to the BCI remotely.

Rather than a hearing aid, said controller comprises controlling a vestibular implant (VI) remotely and/or playing music to the VI remotely.

Rather than a hearing aid, said controller comprises controlling a cochlear implant (CI) remotely and/or playing music to the CI remotely.

Rather than a hearing aid, said controller comprises controlling a hybrid cochlear/vestibular implant (HCVI) remotely and/or playing music to the HCVI remotely.

Rather than a hearing aid, said controller comprises controlling an auditory nerve implant (ANI) remotely and/or playing music to the ANI remotely.

Rather than a hearing aid, said controller comprises controlling an auditory brainstem implant (ABI) remotely and/or playing music to the ABI remotely.

Rather than a hearing aid, said controller comprises controlling an auditory midbrain implant (AMI) remotely and/or playing music to the AMI remotely.

Radio Assisted Hearing Aid

The principles of the invention further provide for a radio assisted hearing aid (HA) for improving hearing and understanding in challenging situations where the speaker is far away.

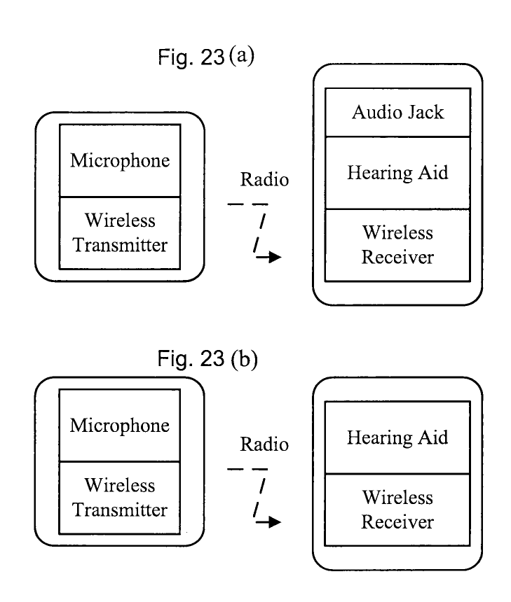

Said HA can be realized as either FIG. 23-(a) or FIG. 23-(b). Said HA improves hearing and understanding the sound of a far-away person speaking in classrooms, meetings, seminars, and other places. Said HA consists of a microphone (that is assisted by a wireless transmitter) and a HA (that is assisted by a wireless receiver and an optional audio jack).

If the realization is FIG. 23-(a), the microphone picks up the sound of the far-away person and delivers the sound to the HA via the wireless transmitter and the wireless receiver. Said HA can be fitted or refitted for a specific user by iSOUP-FS over the audio jack.

If the realization is FIG. 23-(b), Said HA can be fitted or refitted by wireless iSOUP-FS over a radio signal.

Wireless technology in said HA can be Bluetooth, FM, or any of relevant wireless technologies.

Radio Assisted Auditory Implants

The principles of the invention further provide for a radio assisted middle ear implant (MEI), wherein rather than a hearing aid, a MEI is used. In addition, rather than a hearing aid, any one of a bone conduction implant, a radio assisted vestibular implant, a radio assisted cochlear implant, a radio assisted hybrid cochlear/vestibular implant, a radio assisted auditory nerve implant, a radio assisted auditory brainstem implant, a radio assisted auditory midbrain implant may be used.

Bluetooth Remote Control

The principles of the invention further provide for a Bluetooth remote control. The shape of said remote control can be but is not limited to wristwatch, wristband, waist clip, bracelet, armlet, neckloop, in-pocket device, waistband, clothes clip, or fabric sensor based garment through a Bluetooth audio connection over iSOUP technique. Thus, said remote control enjoys low energy consumption, encrypted communication, and simple configuration of Bluetooth technology.

Said remote control communicates and works with a conventional user device to control processor parameter, program, core, and/or operating system of the user device.

Said remote control can also use one of passive RFID (Radio Frequency Identification) and relevant wireless technologies, instead of Bluetooth.

The conventional user device includes but is not limited to hearing aid (HA), middle ear implant (MEI), bone conduction implant (BCI), vestibular implant (VI), cochlear implant (CI), hybrid cochlear/vestibular implant (HCVI), auditory nerve implant (ANI), auditory brainstem implant (ABI), auditory midbrain implant (AMI), or any combinations of the above.

When said remote control works with a BTE/ITE (behind-the-ear/in-the-ear) device, said remote control also solves problems associated with the fact that a user often does not know what mode (or program) his BTE/ITE device currently is, if his BTE/ITE device has multiple modes (or programs). Additionally, the user can hardly switch modes as he will, because it is hard (if not impossible) for him to operate a (tiny) button of the BTE/ITE device while wearing the device. If the BTE/ITE device provides an audio jack for music appreciation (e.g. MP3), the audio jack (called direct audio input, i.e. DAI) is barely used, because it is troublesome to have an audio cable connected to the ear. Furthermore, mobility is significantly limited, not even mentioning to switch back and forth from conversation to music. If a user wants to control the BTE/ITE device, he usually has to first take off the device from the ear, read the display screen (if there is one), change the configuration, and then wear the device back again.

Message of iSOUP-FS includes the user information of program selection, timer, digital volume control, direction of listening (with directional microphones), music/speech/noisy/environmental/directional/omnidirectional/automatic mode selection, program selection, sensitivity control, battery remote turn-off/turn-on, and/or sound source localization.

Bluetooth music may be transmitted from said remote control to a conventional user device for convenient music appreciation. Said remote control substitutes the functionality of an audio cable plus an audio jack interface of the conventional user device. Thus, the conventional user device can remove the audio jack interface for smaller size and less weight.

Said remote control may work in an automatic mode in which it detects and classifies different environments, then automatically uses Message of iSOUP-FS to deliver the classified mode to a conventional user device.

Different conversational environments are listening situations that can include crowded areas (e.g. restaurants and conferences), homes, vehicles, and cocktail meetings.

Said HA remote control communicates the user information, command, and control messages to/from a conventional hearing aid through iSOUP, where Message includes but is not limited to program selection, timer, digital volume control, direction of listening (with directional microphones), music/speech/noisy/environmental/directional/omnidirectional/automatic mode selection, program selection, sensitivity control, battery remote turn-off/turn-on, and/or sound source localization.

Said HA remote control can have an optional screen, if prompt or help messages need to be viewed by LCD display or one of relevant display technologies. Said HA remote control can have an optional indicator light, if speaker location or loudest sound source like door knocks needs to be shown.

Another optional feature is that said HA remote control can have multiple indicator lights, where if one light is lit, that means sound comes from the direction associated with the light. The multiple lights are especially useful for faint/dark environments, speaker behind listener, faraway speaker, and/or door knock.

Passive Remote Control

The principles of the invention further envision a passive remote control that works to control a conventional user device, including but is not limited to a BTE/ITE (behind-the-ear/in-the-ear) device, hearing aid (HA), middle ear implant (MEI), bone conduction implant (BCI), vestibular implant (VI), cochlear implant (CI), hybrid cochlear/vestibular implant (HCVI), auditory nerve implant (ANI), auditory brainstem implant (ABI), auditory midbrain implant (AMI), or any combinations of the above.

Said remote control uses a passive mechanism to maximize the lifetime of the battery of the conventional device. The conventional device has a communication module. The communication module sleeps and consumes no power when the conventional device works normally. If a user pushes any button of said remote control, the wireless signal that is emitted by said remote control will power the communication module. Then the communication module will wake up and receive iSOUP Message that will finally control the conventional device.

The passive mechanism can be based on the widely used technique RFID (Radio Frequency Identification, e.g. it is used in an RFID tag mounted under the windshield of a car for electronic toll collection) or other passive wireless technologies.

The processor parameter, program, core, and/or operating system of said remote control is updated through an audio link plus Internet by iSOUP-IUP.

Bluetooth Telemetry

The principles of the invention further provide a Bluetooth telemetry method works with a conventional user device to measure, record, log, and/or report both digital data and analog waveform automatically and simultaneously through an audio link.

Said method uses the Backward Subframe of FIG. 5 to bear measurement data and avoid cable entanglement. Digital data, analog waveform, and measurement data are transmitted from the conventional user device to a normal audio receiver, including but not limited to a computer, cell phone, PDA, or mobile device. Said normal audio receiver stores the data.

Said method can also use one of passive RFID (Radio Frequency Identification) and relevant wireless technologies, instead of Bluetooth.

The conventional user device includes but is not limited to hearing aid (HA), middle ear implant (MEI), bone conduction implant (BCI), vestibular implant (VI), cochlear implant (CI), hybrid cochlear/vestibular implant (HCVI), auditory nerve implant (ANI), auditory brainstem implant (ABI), auditory midbrain implant (AMI), or any combinations of the above.

The Bluetooth telemetry methodology of above may include transmitting the user information, command, and control messages to a conventional user device through the Forward Subframe of Message, including but not limited to program selection, timer, digital volume control, direction of listening (with directional microphones), music/speech/noisy/environmental/directional/omnidirectional/automatic mode selection, program selection, sensitivity control, battery remote turn-off/turn-on, and/or sound source localization.

The methodology may also include transmitting Bluetooth music to a conventional user device. The processor parameter, program, core, and/or operating system of said method is updated through an audio link plus Internet by iSOUP-IUP.

In addition, a low-cost factory-test device may be provided with the structure shown in Eq. (1) and Eq. (2). Said factory-device performs fitting for multiple factory products. It will test whether the function of each product is good or not. The type of the products, each of which has an interface for audio link, includes but is not limited to hearing aid (HA), middle ear implant (MEI), bone conduction implant (BCI), vestibular implant (VI), cochlear implant (CI), hybrid cochlear/vestibular implant (HCVI), auditory nerve implant (ANI), auditory brainstem implant (ABI), auditory midbrain implant (AMI)

Simultaneously with fitting, the telemetry data of the Backward Subframe is collected by said factory-test device. Using a 1-to-N audio splitter, one said device connects N products through an audio links so that said device is shared by the N products through iSOUP super-frame.

When one out of N products is a known benchmark product, the telemetry data of this particular benchmark product is a standard for other N-1 products. Whether the N-1 products are good or not, is determined by whether the telemetry data of each of the N-1 products matches with that of the benchmark product or not. Through comparison of match, factory-test is performed fast.

Internet Telemetry

The principles of the invention further encompass an Internet Telemetry method which enables the telemetry plots, medical image, and data of a patient to be viewed anywhere in the world, through an audio link plus Internet. Said method works with a conventional user device and follows the process of the Internet diagnosis and Internet treatment of iSOUP-IHP. The measurement result of telemetry is automatically reported through the Backward Subframe to a healthcare provider. Said method can transmit music, user information, command, and control messages to the conventional user device through the Forward Subframe of Message. Said method can update the processor parameter, program, core, and/or operating system through an audio link plus Internet by iSOUP-IUP.

Optimal Auto-Fitting

The principles of the invention further encompass an optimal auto-fitting method, in which the method performs optimal fitting for parameters of a conventional user device (e.g. hearing aid) automatically. Said method is performed optimally and randomly. The advantages are that said method is per-trial randomized, has no operational bias nor human subjective bias, has no time cost of doctor's manual operation, eliminates gradual drift of human parameter values, eliminates effect of user anticipation, and offers stable results. Said device is fast and convenient.

Said conventional user device includes but is not limited to hearing aid (HA), middle ear implant (MEI), bone conduction implant (BCI), vestibular implant (VI), cochlear implant (CI), hybrid cochlear/vestibular implant (HCVI), auditory nerve implant (ANI), auditory brainstem implant (ABI), auditory midbrain implant (AMI), or any combinations of the above.

The fitting parameters include but are not limited to index of frequency bin, electrode index, FIR/IIR filter coefficient, subchannel gain, audible threshold (THL), most comfortable level (MCL), windowing function, compression function, and/or block size of input/processing/output.

When a conventional user device, e.g. hearing aid (HA) or auditory implant (AI), needs fitting, an audio player can use an audio link to do iSOUP-OAFP, avoiding the problems of doctor's intervention and doctor's operational bias. When there is an additional enhancement needed, said method can include iSOUP Algorithm Enhancement Procedure (iSOUP-AEP) for an additional functionality of enhancing performance of an existing algorithm. After the user perceives the signal, he makes a decision about his perception, e.g. he may request turning the subchannel gain up/down, or decide selecting one interval out of I intervals. The decision is recorded to adjust one or more of the rest parameters of Message, e.g. subchannel gain, THL or MCL, for next trial.

When there are multiple programs, multiple strategies, or multiple algorithms or to be fitted, the M programs/strategies/algorithms can be randomly interleaved and combined into one test. Then the test is performed to a user like one strategy.

The set of the programs/strategies/algorithms can change as the test is being executed. The change of the set is based on the user decisions till now, and it follows the steps of Types 1-4 of iSOUP-BFRP as defined herein.

Currently there is effect of gradual drift in human parameter values during a test. Also, there always exists a possibility that a doctor, a medical consultant, or an authorized person, has operational bias and unintentional subjective bias. It costs a doctor, a medical consultant, or an authorized person intensive time to manually reinitialize and/or reload strategies in multiple times. Finally, conventionally, to validate the test results, it is common to completely retest multiple strategies in another sequential order, which costs intensive time. These problems are now solved by said method iSOUP-OAFP, which takes advantage of iSOUP-BFR (Bias-Free Randomness).

Said method also provides a means to tune FIR/IIR coefficient, windowing function, compression function, and/or block size of input/processing/output inside the user device.

Said method can perform simultaneous fitting and telemetry through one audio link.

Two or more of fitting parameters can be jointly fitted as a multidimensional variable, and wherein the joint fitting is done by simultaneously randomizing multiple fitting parameters. All or part of the fitting parameters are done by the ergodic mechanism.

The fast and optimal auto-fitting method may be integrated into a cochlear implant (CI).

Said method jointly fits stimulation rate and electrode place for a specific user. Each combination of a rate with an electrode index, namely each rate-electrode combination, can stimulate a unique pitch perception of the user. The pitch perception is important for a multirate signal processing strategy of CI.

Due to the variability across users, it is practically impossible to predict the pitch structure of all rate-electrode combinations, where the pitch structure is defined as the order of the ascendant sort of the combinations. To obtain the maximum benefit for the multirate strategy, the joint fitting of rate and electrode through an audio link, offers the desired pitch structure in a random bias-free manner.

The processor parameter, program, core, and/or operating system of said method is updated through an audio link plus Internet by iSOUP-IUP.

Optimal Bluetooth Fitting

Rather than over an audio cable, auto-fitting is over a Bluetooth™ audio connection or inaudibly over the air, or using any relevant wireless technologies.

Optimal Internet Fitting

The principles of the invention further encompass an optimal Internet fitting method in which, rather than over an audio link, auto-fitting is over an audio link plus Internet, wherein said method further comprises reporting the result of the optimal fitting parameters automatically through the Backward Subframe to a healthcare provider.

Optimal Auto-Refitting

The method may be home based and performed by the user himself/herself. Said home-based method aims at refitting a conventional user device to match the gradual change or long-term variability of the user's human body, where the device is applied to.

Before said auto-refitting, the original fitting parameters are saved from the user device to a computer by the Backward Subframe of FIG. 5 over an audio link.

The user operates on computer software that generates a user interface to complete a test through an audio link to the device. The material of the test, including but not limited to physiological part and/or psychological part, is downloaded from Internet. The result of the test determines the refitting parameters that are to overwrite the original ones.

After said refitting, the result of the new parameters is automatically reported to a healthcare provider. As a backup mechanism, the original parameters may be easily restored by playing the saved iSOUP frame back to the user device.

Rather than Bluetooth™, one of relevant wireless technologies is used instead. The processor parameter, program, core, and/or operating system of said method is updated through an audio link plus Internet by iSOUP-IUP.

Inaudible Over-The-Air Fitting

Rather than over an audio link, auto-fitting is performed inaudibly over the air, and wherein said over-the-air fitting method is based on the free-field propagation of inaudible sound wave from a transmitter to a receiver, e.g. a speaker to a microphone.

### One-Interface Hearing Aids (HA) and One-Interface Auditory Implants (AI)

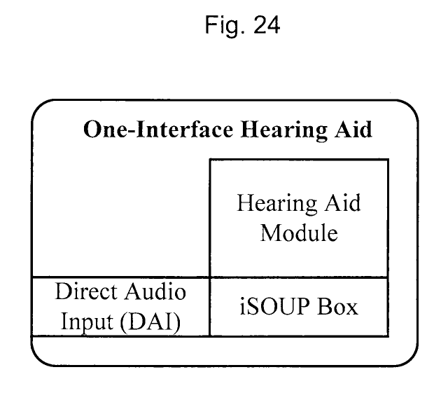

FIG. 24 depicts one embodiment of a one-interface hearing aid (OI-HA) for fitting without requiring hardware. The advantage of said OI-HA is: fitting (or personalizing) it to a specific patient needs only a one-dollar audio cable not thousands-of-dollars fitting hardware.

Said OI-HA consists of a direct audio input (DAI), an iSOUP Box, and a hearing aid module. For a specific user, the DAI is used for both fitting/refitting (namely Mode 1) and receiving audio signal from outside (namely Mode 2). Thus, the DAI is “one interface” used for all purposes.

The fitting/refitting is done by receiving an iSOUP-FS that is played by a computer, a MP3 player, or any of the audio players.

Said OI-HA checks the input signal to automatically determine whether Mode 1 or Mode 2 is happening. In certain embodiments, instead of automatic determination, the user manually indicates whether Mode 1 or Mode 2 is happening (e.g. by operating a switch/button/knob).

An optional component of said OI-HA is a module called a direct audio output (DAO). The DAO is an audio jack (or a variant of an audio jack). The DAO transmits information from inside the hearing aid module to outside, e.g. data of ear canal measurement, current channel gains, current filter coefficients, current kneepoints, current compression function, or other information.

The “hearing aid” may be replaced with middle ear implant, bone conduction implant, vestibular implant, cochlear implant, hybrid cochlear/vestibular implant, auditory nerve implant, auditory brainstem implant, or auditory midbrain implant.

Hearing Aids (HA) and Auditory Implants (AI)

The principles of the invention further provides a hearing aid (HA) comprising all or part of Inaudible Synchronous Online User-optimized Processing (iSOUP) technique defined herein. For example, a single-interface HA is provided, wherein said HA has only one single interface that accepts both digital data transmission and analog speech/music transmission.

The digital transmission is used to write/read user information, command, control message, processor parameter, program, core, operating system, and/or any desired data into/out of said HA.

The analog transmission is used to receive speech or music from an audio player to said HA.

The single interface of said HA is a replacement of the two conventional interfaces of a conventional HA, i.e. a direct-audio-input (DAI) and an expensive specialized digital interface.

A mini single-interface low-cost low-weight HA is also provided, wherein because of single interface, the weight of the BTE/ITE part of said HA is less, the wearer's comfort is higher, the size of the BTE/ITE part is smaller, and the cost of said HA is lower due to exclusion of an expensive specialized digital line and its associated interface (as well as and the design/development cost of the line and the interface), and wherein less weight, higher comfort, smaller size, and lower cost, make said HA more superior, competent, flexible, and convenient.

In certain aspects, the fast optimal auto-fitting is performed over an audio link to said HA according to iSOUP Bias-Free Random Procedure (iSOUP-BFRP). The best fitting performance is achieved by iSOUP Optimal Auto-Fitting Procedure (iSOUP-OAFP) or iSOUP Internet Healthcare Procedure (iSOUP-IHP).

Audio-Visual HAs/AIs and Eyeglass HAs/CIs

The principles of the invention further provide for an audio-visual hearing aid (HA) comprising all or part of iSOUP technique defined above, including the steps shown in FIG. 25 for full CD-quality music appreciation, highest entertainment, and/or highest speech perception.

Said audio-visual HA benefits from auditory and visual coordination, especially useful for full CD-quality music appreciation, highest entertainment, and highest speech perception. Said audio-visual HA is also superior in case that: (1) environmental lumination is insufficient for lipreading; (2) speaker can not be seen, e.g. speaker's voice is from behind listener or speaker is obstructed; and (3) speaker turns away from you during conversation.

The timing offset between the stimulation of eyes and the stimulation of ears is precisely configured, controlled, and shifted by Message being embedded in the audio-visual stimulus. The precise configuration of the timing offset is critical for maximum audio-visual integrated sensation, based on the fact that:

Longer or inaccurate audio-visual delay can cause interference between speech and visual integration.

The stimulation rate of the visual cue used in said device is jointly determined by (1) foveal vision is very slow with only 3 to 4 high quality telescopic images per second; and (2) peripheral vision is very inaccurate but also very fast with up to 90 images per second (permitting to see the flicker of the 50 Hz TV images).

Therefore, Timing Offset Msg of the iSOUP-FS frame is used to adjust the timing offset of the stimulation times between the audio receiver and the eyeglass. The adjustment compensates the different response times of photoreceptor and auditory mechanoreceptor plus the different processing times of auditory cortex and visual cortex. Furthermore, the precise adjustment is used to match a user's individual brain capability and personalize said device.

Referring to FIG. 25, there are two connections using an iSOUP-FS frame. The first is an outer iSOUP-FS, which is transmitted from a conventional MP3 player to the DAI jack of said HA. The second is an inner iSOUP-FS, which is transmitted from the processor of said HA to both a visual screen and a miniature speaker (in ear canal). The processor takes a sound either from a microphone or from the DAI jack. When the processor takes the sound from the DAI jack, the DAI jack is driven by a conventional MP3 player that plays a MP3 file. The MP3 file can be an iSOUP assistive listening MP3 file to enhance the full hearing of CD-quality music of hearing-impaired users.

Visual cue is embedded in Left-Eye Msg and Right-Eye Msg of the iSOUP assistive listening MP3 file. The visual cue can be but is not limited to the feature information: energy, rms, magnitude spectrum, phase spectrum, spectrogram, intensity, pitch, formants (F1, F2, F3, F4, F5, and F6), slope of pitch, interval of pitch, contour of pitch, rhythm, onset time-points, sound source location, sensory type, sensory location, sensory duration, mean, standard deviation, skewness, kurtosis, high-order central moments, cumulants, and/or any statistical characteristics. The iSOUP assistive listening MP3 file, which shall be personalized for each user, compensates the residual distortion of the user's aided audiogram.

After the processor processes the sound, it sends out an inner iSOUP-FS to both a visual screen and a miniature speaker in the ear canal. The visual screen shows the foregoing visual cue. The visual screen is a small electronic screen made of (but not limited to) LCD or relevant display technologies.

On the visual screen, a progress bar, a flashing arrow, a digital number, a letter/word, a light, a light array, a transient flashing effect, an image, or any other content, is displayed. Here, the displayed content is directly controlled by the foregoing visual cue. The shape of the visual screen can be but is not limited to rectangle, cylinder, sphere, triangle, disc, or any geometric shape. Here, the displayed content is directly controlled by the foregoing visual cue. For example, the direction that is pinpointed by the flashing arrow is sound source location, the lit part of the progress bar is proportional to the height of pitch/intensity/energy/rms, the onset of the transient flashing effect is the sound onset time-points, the different colors of the transient flashing effect depends on the different sound source locations, or the digital number is the instantaneous value of any feature information.

Two or more of the visual cues can be shown simultaneously when the visual screen has two or more parts. For example, one left part shows sound source location, while one right part shows pitch/intensity/energy/rms height or onset time-points. The left part can be controlled by Left-Eye Msg, while the right can be controlled by Right-Eye Msg.

If the displayed content is not digital but analog, Left-Eye Waveform and Right-Eye Waveform can be used to convey the visual cue in an analog manner. For example, the visual cure can be continuous and obtained from filtering.

The visual screen can be mounted onto an eyeglass, headband, hat, wristwatch, wristband, waist clip, bracelet, armlet, neckloop, in-pocket device, waistband, clothes clip, fabric sensor based garment, headset, or headphone.

Otherwise, if the processor takes a sound from the microphone, the visual cue is embedded into Left-Eye Msg and Right-Eye Msg of the foregoing inner iSOUP. The embedding is done by the processor of said HA through extracting the feature information of the sound.

Whether the processor takes the sound from the DAI jack or the microphone, said HA employs audio-visual integration to maximize speech perception and full CD-quality music appreciation, based on the fact of that: neuroscience research has already shown that the visual cortex of even adult blind people can become responsive to sound, and sound-induced illusory flashes can be evoked in most sighted people.

The processor parameter, program, core, and/or operating system of said HA can be updated through an audio link plus Internet by iSOUP-IUP.

Said device can train brain development and brain coordination of deaf children.

Said HA works with a conventional user eyeglass. The small visual screen of said HA is clamped at a corner of the frame of the conventional eyeglass, or mounted on a leg of the eyeglass. The LCD visual screen shows a progress bar, a flashing arrow, a digital number, a letter/word, a light, a light array, a transient flashing effect, an image, or any other content.

The screen mounted on an eyeglass is like a side mirror on a car. Peripheral vision is used to see the screen. Thus, the user can catch sight of the screen out of the corner of his eye, which does not need his foveal vision.

The stimulation rate of the visual cue is initialized to match the capability of peripheral vision, which is up to 90 images per second. The stimulation rate is then optimized and personalized for the user via iSOUP-FS.

The displayed content is directly controlled by the visual cue. The visual cue can be any of the feature information. For example, when the digital number is displayed, the number is the instantaneous value of any of the feature information.

LCD can also be replaced by one of relevant display technologies.

The principles of the invention further encompass a sound-localization eyeglass hearing aid. The visual screen shows where the sound comes from, e.g. front, back, left side, right side, above, or below. For example, the direction that is pinpointed by the flashing arrow is sound source location. Or the different colors of the transient flashing effect depends on the different sound source locations. Or different digital letters represent the source locations.

Directional sensitivity can also be integrated into said HA so that the signal-to-noise ratio (SNR) of a selected direction is enhanced. The selection can be changed through Message of iSOUP.

Microphone array is integrated within said HA or can be mounted on the frame/leg of the user eyeglass.

For the visual screen, the lit part of the progress bar is proportional to the height of pitch. Or the digital number is proportional to the value of the pitch.

Said pitch eyeglass HA improves the user for highest entertainment, clear speech, and full music appreciation. The intensity/energy/rms can be used as the visual cue, and displayed as a progress bar or relevant visual images.

When the contrast of music onset versus silence gap is small, hearing-impaired users experience difficulty in enjoying music.

Said music-onset HA uses onset time-points as the visual cue, and displays it as a transient flashing, a lit progress bar, or relevant visual images.

The onset of the transient flashing effect is the onset time-point of music.

Rather than a hearing aid, an MEI, BCI, VI, CI, HCVI, ANI, ABI, or AMI may be used instead for full music appreciation, highest entertainment, and highest speech perception based on iSOUP technique, and wherein said audio-visual MEI comprises a visual screen, a processor, and an implanted receiver as shown in FIG. 25-(b).

Anyone of the MEI, BCI, VI, CI, HCVI, ANI, ABI,or AMI may be of the following types: LCD eyeglass, sound-localization eyeglass, pitch eyeglass, sound-intensity, music-onset eyeglass.

Bluetooth Audio-Visual HAs/AIs and Bluetooth Eyeglass HAs/CIs

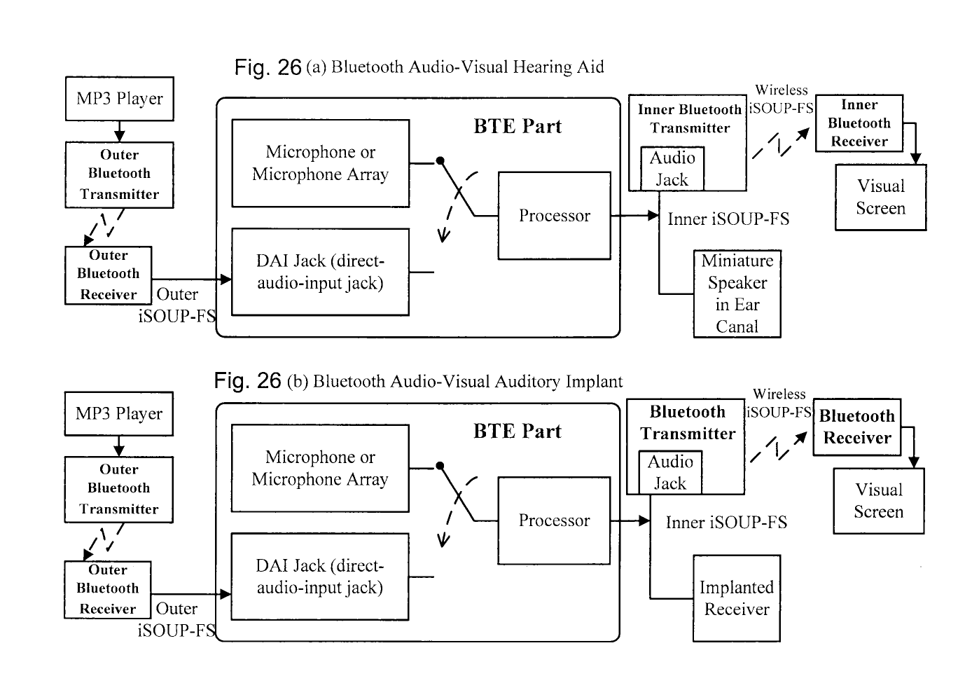

The principles of the invention further include a Bluetooth audio-visual hearing aid (HA) for full CD-quality music appreciation, highest entertainment, and highest speech perception. Referring to FIG. 26-(a), in said Bluetooth audio-visual HA the Bluetooth (BT) connection replaces the role of the audio cable from the processor to the visual screen. After the replacement, the output frame (i.e. an inner iSOUP-FS) of the processor goes to the audio jack of an inner BT transmitter. The inner BT transmitter delivers the inner iSOUP-FS into an inner BT receiver, which finally displays the visual cue onto the visual screen.

One optional feature is that the inner BT transmitter can be integrated as a building block into the BTE/ITE part of said HA. Another optional feature is that the inner BT receiver can be integrated as a building block into the visual screen.

Yet another optional feature is that: the outer iSOUP-FS can be extended by an outer BT receiver, where the outer BT receiver connects an outer BT transmitter that gets a sound from a conventional MP3 player, as shown in FIG. 26-(a).

Still another optional feature is that: the visual screen can be integrated with the remote control so that the screen of the remote control is also used to show the visual cue here for audio-visual integration. Bluetooth™ can be replaced by one of relevant wireless technologies.

### Wireless Audio-Visual Hearing Aids and Wireless Audio-Visual Auditory Implants

A wireless audio-visual hearing aid (AV-HA) for employing audio-visual integration to enhance the perception of speech and music is also provided. The advantage of said AV-HA is: fitting (or personalizing) it to a specific patient needs only a one-dollar audio cable not thousands-of-dollars fitting hardware.

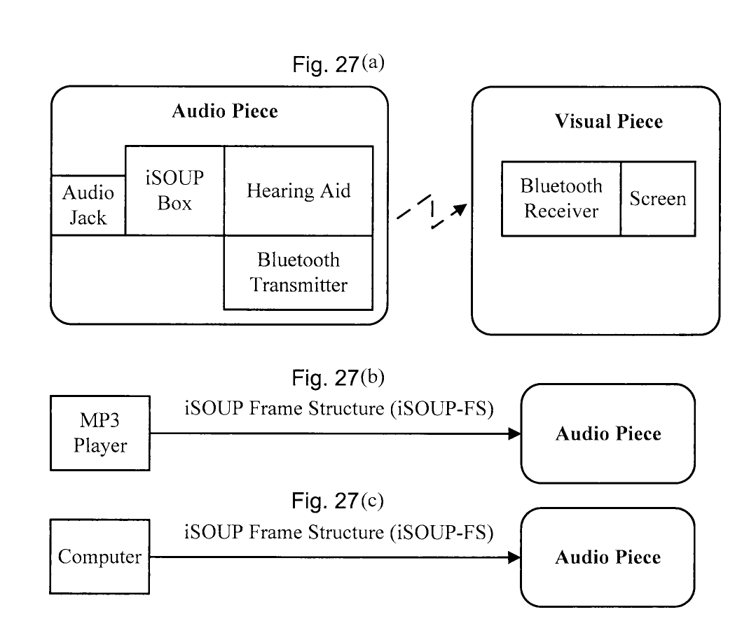

Said AV-HA consists of two pieces: an audio piece and an visual piece, as shown in FIG. 27-(a). The audio piece includes an audio jack, an iSOUP Box, a hearing aid, and a Bluetooth transmitter. The visual piece includes a Bluetooth receiver and a screen.

Said AV-HA provides audio-visual integration to maximize the perception of a patient in daily use.

As shown in FIG. 27-(b) and FIG. 27-(c), when said AV-HA is initially configured or reconfigured (e.g. fitting or refitting) for a specific patient, a computer or a MP3 player plays an iSOUP-FS to the audio piece for personalizing said AV-HA based on his audiogram and other information. The MP3 player can be replaced by any of the audio players. Bluetooth can be replaced by any of relevant wireless technologies.

### Wireless Audio-Touch Hearing Aids and Wireless Audio-Touch Auditory Implants

Said AT-HA consists of two pieces: an audio piece and an touch piece, as shown in FIG. 27-(a). The audio piece includes an audio jack, an iSOUP Box, a hearing aid, and a Bluetooth transmitter. The touch piece includes a Bluetooth receiver and a vibrator.

Said AT-HA provides audio-touch integration to maximize the perception of a patient in daily use.

As shown in FIG. 27-(b) and FIG. 27-(c), when said AT-HA is initially configured or reconfigured (e.g. fitting or refitting) for a specific patient, a computer or a MP3 player plays an iSOUP-FS to the audio piece for personalizing said AT-HA based on his audiogram and other information. The MP3 player can be replaced by any of the audio players. Bluetooth can be replaced by any of relevant wireless technologies.

Optimal New-Music Self-Trainer

The principles of the invention also encompass an optimal new-music appreciation self-trainer based on FIG. 6. Said self-trainer improves full appreciation of new music and highest feeling of its emotion/variation/timbre, none of which can be enjoyed or even “understood” by hearing impaired users or hearing disease postsurgical users. Said self-trainer also improves full appreciation of familiar music.

Said self-trainer optimally uses an 8-sensory (audio-visual-taste-smell-touch-linear-acceleration-rotary-temperature) frame or one of its 254 simplified frames at home. The 254 simplified devices are based on the 8-sensory device. A “multisensory frame” is defined as an 8-sensory frame or any of its 254 simplified frames.

Said self-trainer uses a multisensory frame (including N senses) to stimulate N conventional user devices. The N user devices can be but are not limited to:
Conventional audio device, which can a microphone or an audio receiver, if said self-trainer is used by an unaided mild-to-moderately hearing-impaired user; or can be hearing aid (HA), middle ear implant (MEI), bone conduction implant (BCI), vestibular implant (VI), cochlear implant (CI), hybrid cochlear/vestibular implant (HCVI), auditory nerve implant (ANI), auditory brainstem implant (ABI), or auditory midbrain implant (AMI)), if said self-trainer is used by an aided or implanted user.
Conventional visual device (the visual screen).
Conventional taste device, conventional smell device, conventional touch device, conventional linear-acceleration device, conventional rotary device, and conventional temperature device.

The iSOUP assistive listening MP3 file, is specialized for a specific user and used by said self-trainer.

Said self-trainer takes advantage of multisensory brain integration, brain memory, and brain plasticity. The processor parameter, program, core, and/or operating system of said self-trainer is updated through an audio link plus Internet by iSOUP-IUP. An audio-visual frame is used for a conventional audio device and a conventional visual device.

### New Music Trainer

A new music trainer for employing audio-visual integration to hearing-impaired people and enhancing appreciation of new music, comprising the steps:

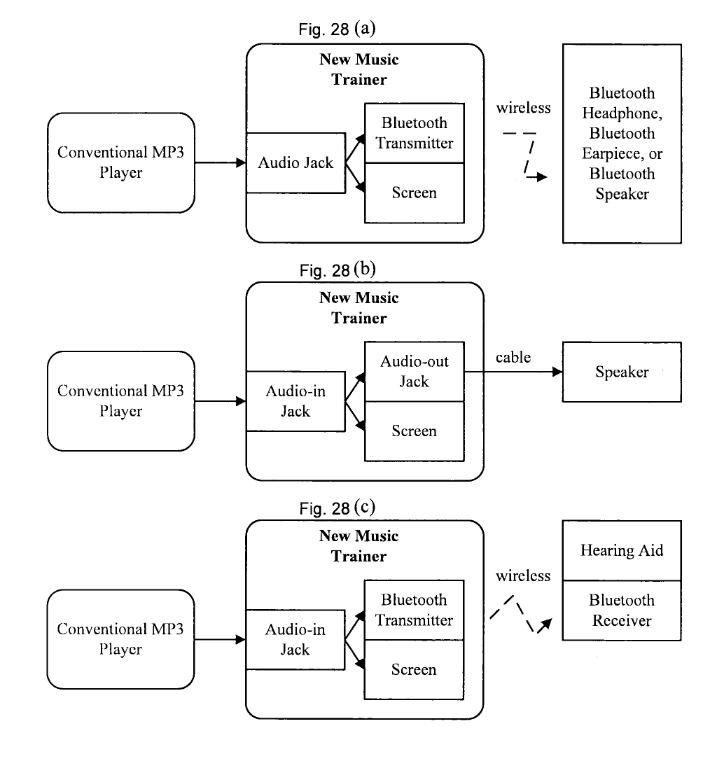

Said trainer helps hearing-impaired people enjoy new music by audio-visual integration. It works without requiring connecting a hearing aid. Said trainer can be realized as FIG. 28-(a), FIG. 28-(b), or FIG. 28-(c).

In FIG. 28-(a), said trainer consists of an audio jack, a Bluetooth transmitter, and a screen. Said trainer obtains music from a conventional MP3 player and outputs the music to a Bluetooth headphone, a Bluetooth earpiece, a Bluetooth speaker, or any audio receiver. The screen displays any of relevant visual images (e.g. pitch is displayed as a highlightened key on a keyboard). The display is synchronized with playing the audio.

An optional feature is that Bluetooth can be replaced by any of relevant wireless technologies. Another optional feature is that MP3 player can be replaced by any audio player. Yet another optional feature is that said trainer can be expanded by other functionalities or other modules, e.g. a module for extracting pitch. Said trainer can also be used by normal-hearing people to obtain highest feeling from music. Said trainer can be personalized, configured, or reconfigured for a specific user by iSOUP-FS.

Rather than audio-visual integration, audio-touch integration is used and the screen is replaced by a vibrator. Rather than audio-visual integration, audio-visual-touch integration is used, and wherein besides the screen, a vibrator is added and works synchronously with the screen. Additionally, the hearing aid of FIG. 28-(c) may be replaced by any of an MEI, BCI, VI, CI, HCVI, ANI, ABI, or AMI.

Patient Entertainment Device

The principles of the inventions further provide a patient entertainment device, wherein said device is specialized for a specific patient. Said patient entertainment device uses a multisensory frame for highest integration, entertainment, and subjective feeling for a patient. The multisensory frame is defined as an 8-sensory frame or any of its 254 simplified frames.

Timing Offset Msg of iSOUP-FS is used to adjust the stimulation times of the multiple sensory waveforms. The adjustment considers the sensory delays of the patient. The sensory delays are measured through physiological and psychological tests.

A hearing-impaired patient MP3 Player may also be provided for highest music entertainment of unaided hearing-impaired users in which a conventional MP3 player or an audio player is used. The MP3 player stores an iSOUP assistive listening MP3 file. The iSOUP assistive listening MP3 file is specialized for a specific patient and played to the user for highest entertainment.

An optional feature is that the processor parameter, program, core, and/or operating system of said MP3 player or said file is updated through an audio link plus Internet by iSOUP-IUP.

Another optional feature is that additionally an iSOUP Box is used, where the iSOUP Box works with the conventional MP3 player and modifies music stimuli using the structure of FIG. 9-(b).

Rather than over an audio cable, transmission is over a wireless audio connection or inaudibly over the air, and wherein the wireless audio connection is Bluetooth™ or relevant wireless technologies.

In the iSOUP assistive listening MP3 file, the spectrum of T-Signal is be modified based on a specific patient's medical parameters. A conventional MP3 player either plays the file in free field or connects to a conventional MEI through DAI jack.

Said Bluetooth MP3 player may also be a conventional MP3 player plugged by a conventional Bluetooth transmitter. Said Bluetooth MP3 player works with a conventional MEI. The conventional MEI is plugged by a conventional Bluetooth receiver.

An optional feature is that said Bluetooth MP3 player can be one device integrated with both a conventional MP3 player and a conventional Bluetooth transmitter.

Another optional feature is that a conventional hearing aid is integrated with a conventional Bluetooth receiver.

Still another optional feature is that Bluetooth™ is replaced by one of relevant wireless technologies. Rather than an MEI, a BCI, VI, CI, HCVI, ANI, ABI, or AMI may be used instead.

Optimal Sleep Helper

The principles of the inventions are also applicable to an optimal sleep helper, wherein the disease being treated is insomnia and a multisensory frame as a stimulus is optimized for best treatment over an audio link through iSOUP User Optimization Procedure (iSOUP-UOP). Rather than over an audio cable, iSOUP transmission may be over a wireless audio connection or inaudibly over the air, and wherein Bluetooth™ or one of relevant wireless technologies, is used.

Disorder Treatment Device

The principles of the invention also provide a neurological disorder treatment (NDT) device, wherein a multisensory frame as a stimulus is optimized for best treatment over an audio link through iSOUP User Optimization Procedure (iSOUP-UOP). The multisensory frame is defined as an 8-sensory frame or any of its 254 simplified frames. Said NDT device is an effective non-pharmaceutical treatment for a range of hard-to-treat neurological disorders. The processor parameter, program, core, and/or operating system of said NDT device is updated through an audio link plus Internet by iSOUP-IUP. The device may also be provided to treat phantom pain, neuralgia, depression, dementia, stroke, brain damage, Parkinson's disease, and multiple sclerosis

Tinnitus Treatment Device

The principles of the invention may also provide an optimal tinnitus treatment device. Said optimal tinnitus treatment (OTT) device treats tinnitus (ear noise or ear ringing) in a user-personalized and user-optimized manner, and works with a conventional MP3 player, a conventional CD player, or an audio player. The conventional MP3 player (for convenience, only the term “MP3 player” is used hereafter, but it shall be understood that a conventional CD player, or an audio player, can replaces the role of the MP3 player hereafter) stores a file of an iSOUP-FS frame and plays the file to said OTT device. Said OTT device increases the plasticity of the brain.

Said tinnitus treatment device uses an optimal time-frequency (TF) series defined by FIG. 2, whose basic time frequency block can be but is not limited to a bandlimited signal, lowpass/highpass/bandpass signal, multi-pole/multi-zero/pole-zero signal, white bandlimited noise, spectrum-shaped bandlimited noise, AM/FM/PM/SSB signal, puretone, multi-tone, complex tone, multi-notch signal, multi-comb signal, or a signal modulated by relevant modulation schemes.

The optimal time-frequency series is optimized and personalized for a specific user through the steps defined iSOUP-UOP, as shown in FIG. 12. Referring to FIG. 12, the optimization and personalization are done according to the iSOUP-UOP Stage I-VI defined by FIG. 12, where the elements of optimization argument A are center frequencies to suppress tinnitus, the elements of optimization argument C are amplitudes of the basic time frequency block centered around the center frequencies, and the elements of argument E are the allocated time slots that a basic time-frequency block around a center frequency appears (or disappears).

After obtaining A, C, and E, Stage IV organizes the three best sets into an optimal joint vector P₁, and then searches a suboptimal joint vector P₂ until a combined matrix Q=[P₁, P₂, . . . , P_{M}] is constructed.

Stage V sets a ripple matrix Δ that provides an intentional variation for each element of Q. The ripple matrix Δ creates fluctuation of the combined matrix Q, where the fluctuation matches properties of human perception. The fluctuation over the arguments of center frequencies, amplitudes, allocation of time slots, bandwidths, duration of time slots, and subband category, soothes human limbic system that affects a variety of functions including subjective feeling, emotion, behavior, memory, and olfaction, and makes brain stay vital from refractory status, tiredness, or boringness.

Stage VI adds a noise and a piece of music to the Stage V output. The addition of the three, which are one foreground and two backgrounds, creates a composite signal. The best composite signal finally forms a complete User-Optimized Time-Frequency (UOTF) series for best treatment.

The optimization of Stage I-VI is performed by tracking the user's feedback. The UOTF series is the best stimulus to treat the specific user's tinnitus, and the UOTF series is also time-varying. Besides the optimal feature, the time-variability solves the problem that tinnitus sufferers find conventional tinnitus treatments are merely a substitute of one annoying sound for another.

One feature of tinnitus is its time-variability. A tinnitus of a user can have different changing sensations at different times, where the property of the sensation can be but is not limited to ringing, buzzing, hissing, roaring, whistling, multiple noises, rustling, clanging, whining, water-running, cracking, chirping, screeching, or even musical sounds. In addition the loudness of the sensation can change back and forth between loud and soft, the duration of the sensation can become intermittent, constant, or pulsating, and the bandwidth of the sensation can change from wideband (noise-like) to bandlimited (tone-like). In addition, the center frequency of the sensation can change from high pitched ringing (whistling-like) to low-pitched ringing (roaring), and the number of distinguishable ear noises can change back and forth between one to a few.

Due to time-variability of tinnitus sensation, different sensations can switch several times in a day/week/month, or on a longer basis. For each sensation of tinnitus, an optimal stimulus can be obtained so that multiple (N) optimal stimuli are achieved for one user. Defining each optimal stimulus as a mode, the user picks a mode out of N to suppress time-varying tinnitus.

The change of a mode is done by playing an iSOUP-FS frame being stored in the conventional MP3 player. The iSOUP-FS frame has Message that includes mode selection, timer, digital volume control, battery remote turn-off/turn-on, and/or the user information.

When the sensation of tinnitus changes, by playing the sound of the iSOUP-FS frame to said optimal tinnitus treatment (OTT) device, said OTT device picks up the embedded “mode selection” and follows the mode selection to select an optimal stimulus to suppress tinnitus. When the “timer” is embedded, said OTT device follows the timer to use different stimulus at different times, change a mode at specific time points, intentionally turn off said OTT device at a time point designated by the timer, and/or turn on said OTT device at a desired time point. Thus, said OTT device best tracks and treats tinnitus.

The treatment time and the change of a mode can be configured by the timer, while the conventional MP3 player provides a user interface. For said OTT device, all its processor parameter, program, core, and/or operating system are updated either through an audio link by the MP3 player or through an audio link plus Internet by a computer via iSOUP-IUP. The present invention covers both of the two variations.

A monthly/quarterly/annual test is performed via an audio link plus Internet or on a computer by iSOUP-IHP so that the long-term change of tinnitus can be measured and automatically reported to a healthcare provider. The measurement is jointly considered with aging and hearing loss by the healthcare provider, who will then generate an updated iSOUP-FS frame. The updated iSOUP-FS frame is downloaded to the conventional MP3 player of the user.

The whole procedure of agilely updates a low-cost time-varying full-spectrum best-performance stimulus for the user. When a higher-version DSP program or a new core of said OTT device is distributed through an iSOUP-FS frame, the whole procedure can also download and play it to update said tinnitus treatment device, based on the ubiquitous audio link and Internet.

An optional feature is that a remotely supervising doctor, medical consultant, or authorized person, can monitor the user's decisions and remotely controls said OTT device through an audio link plus Internet by iSOUP-IHP. Said supervising doctor, medical consultant, or authorized person, can change the parameters, programs, core, or operating system remotely.

Another optional feature is that the processor parameter, program, core, and/or operating system of said device are updated through an audio link plus Internet by iSOUP-IUP.

The above multisensory optimal tinnitus treatment device may use multisensory stimulation and multisensory integration to suppress and treat tinnitus. A multisensory frame as the stimulus is optimized for tinnitus treatment over an audio link through iSOUP User Optimization Procedure (iSOUP-UOP). The multisensory frame is defined as an 8-sensory frame or any of its 254 simplified frames. Said device is an effective non-pharmaceutical treatment for hard-to-treat tinnitus.

The device may be include an audio player defined, a visual screen defined by, an iSOUP Box, and a headset/headphone/earphone or other receiver. The visual screen shows visual cue. Two or more of the visual cues can be shown simultaneously when the visual screen has two or more parts. The visual screen can be mounted onto an eyeglass, headband, hat, wristwatch, wristband, waist clip, bracelet, armlet, neckloop, in-pocket device, waistband, clothes clip, fabric sensor based garment, headset, or headphone. The processor parameter, program, core, and/or operating system of said HA can be updated through an audio link plus Internet by iSOUP-IUP.

The tinnitus treatment device may also be an eyeglass optimal tinnitus treatment which includes an eyeglass, an audio player, an iSOUP Box, and a headset/headphone/earphone or an audio receiver.

The eyeglass works as a visual screen to show a progress bar, a flashing arrow, a digital number, a letter/word, a transient flashing effect, or any relevant visual images. The displayed content is directly controlled by the Message.

The visual cue can be any of the feature information. For example, when the digital number is displayed, the number is the instantaneous value of any of the feature information. Another optional feature is that the iSOUP Box can be integrated into the eyeglass.

Tinnitus Treatment HA and AIs

Rather than a standalone optimal tinnitus treatment (OTT) device, the full OTT functionality may be integrated as a building block (namely Generator Block) into a hearing aid.

Besides offering the time-varying full-spectrum best-performance stimulus, said optimal tinnitus treatment hearing aid (OTTHA) offers an additional mode of joint treatment. The joint treatment is based on the fact that over 50% of hearing-impaired people are less affected by tinnitus if a hearing aid is worn and its hearing aid processor provides amplification.

The hearing aid processor itself can also alleviate tinnitus, the joint treatment is that the two works jointly to treat tinnitus. On the other hand, the Sound Activity Detection (SAD) of FIG. 5 detects whether a sound is present or silence is present. Thus, when a sound comes from the hearing aid microphone, the hearing aid processor works and the Generator Block stops. Otherwise, when no sound is present, the Generator Block kicks in to treat tinnitus, avoiding pure silence for the users. When the sound comes in again, the Generator Block suspends the progress of its stimulus, and returns control to the processor.

An optional feature is that said OTTHA can be incorporated with the Bluetooth remote control. After the incorporation, the Bluetooth remote control provides its full functionality, and additionally can edit and/or update the parameters, program, core, or operating system of the Generator Block by playing an iSOUP-FS frame.

Furthermore, the Bluetooth remote control can also bypass the Generator Block and directly play the optimal stimulus of treating tinnitus to the miniature speaker (in ear canal). The bypass command is conveyed to the Generator Block by User Msg of iSOUP-FS. Then, the Bluetooth remote control continues transmitting the stimulus. During the transmission, if the SAD detects the hearing aid microphone is recording an active voice, the processor regains control of the miniature speaker, works like a conventional hearing aid, and sends the Backward Subframe to stop the transmission of the Bluetooth remote control.

Another optional feature is that the processor parameter, program, core, and/or operating system of said OTTHA is updated through an audio link plus Internet by iSOUP-IUP.

In certain embodiments, an optimal tinnitus treatment middle ear implant (MEI) may replace the role of a hearing aid, while an implanted receiver replaces the role of a miniature speaker in ear canal. Additionally, the hearing aid may be replaced with any one of a BCI, VI, CI, HCVI, ANI, ABI, or AMI.

A Bluetooth optimal tinnitus treatment device may also be provided, wherein rather than over an audio cable between the conventional MP3 player and the optimal tinnitus treatment (OTT) device, transmission is instead over a wireless audio connection or inaudibly over the air, and wherein the wireless connection is based on Bluetooth™ or relevant wireless technologies.

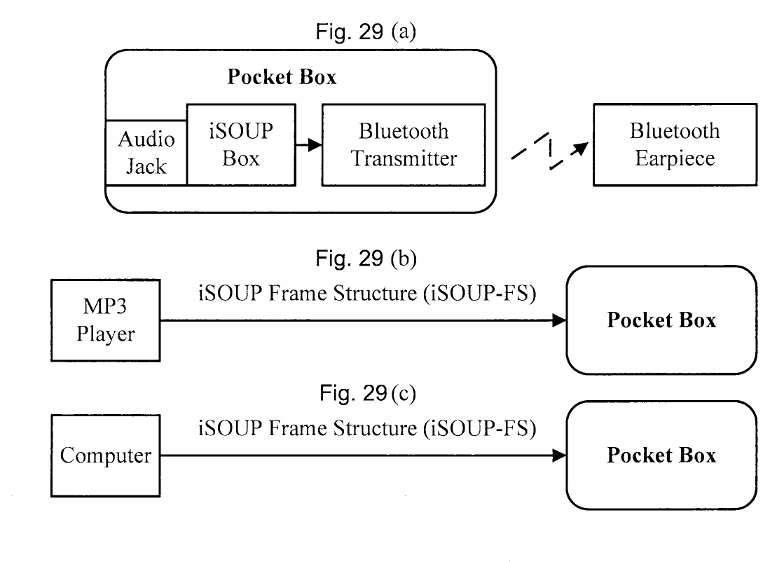

FIG. 29 depicts one embodiment of a wireless tinnitus treatment device. One or more of the advantages of said device are: (1) fitting (or personalizing) it to a specific patient needs only a one-dollar audio cable not thousands-of-dollars fitting hardware; (2) a treatment stimulus can be non-periodic and unlimited in time; (3) a treatment stimulus can be a combination of personalized sound, music, and noise; and (4) the best treatment stimulus can be automatically generated.

Said device includes a pocket box, a Bluetooth earpiece, and an optional MP3 player. The pocket box includes an audio-in jack, an iSOUP Box, and a Bluetooth transmitter.

When said device is in daily use to treat tinnitus, a standard setup is as shown in FIG. 29-(a), where the pocket box transmits a sound to the Bluetooth earpiece. The sound is the best stimulus generated by iSOUP-UOP. The sound can have a unlimited period of time, can be non-repetitive, and/or can be non-periodic.

Besides the standard setup, three other optional setups can be used for enhancement. The 1st optional setup is called music setup. The music setup uses music to treat tinnitus by further employing a MP3 player. The music is played from the player to the pocket box, which then personalizes the music for a specific patient.

The 2nd optional setup is called sequential setup. The sequential setup uses both music and the best stimulus sequentially. The sequential setup organizes the order of the appearance of music and the best stimulus as time goes by. Thus, a patient does not feel boringness or tiredness so that the best treatment can be achieved.

The 3rd optional setup is called integrated setup. The best stimulus generated by iSOUP-UOP inherently consists of both music and personalized sound(s).

When said device needs first-time configuration, reconfiguration, or upgrading programs (e.g. fitting, refitting, or updating), a computer (or a MP3 player) plays an iSOUP-FS to the audio-in jack of the pocket box, as shown in FIG. 29-(b) and FIG. 29-(c). The iSOUP-FS includes parameters, coefficients, programs, cores, and/or operating systems, which are needed by the pocket box.

The MP3 player used in said device can be replaced by any audio player. The earpiece of FIG. 29 can be replaced by a headphone, a earphone, or any audio receiver. The wireless connection can be based on Bluetooth™ or relevant wireless technologies. Thus, Bluetooth transmitter and Bluetooth earpiece of FIG. 29 can be replaced by a transmitter and a receiver of relevant wireless technologies. The audio jack can be replaced by any wireless audio receiver. The pocket box can be not only a pocket-size box but also any other form of portable device (or non-portable device).

Wireless Treatment Devices

Other uses for the above-referenced device include Meniere's disease, auditory hallucination, otosclerosis treatment, insomnia, depression, stroke, brain, schizophrenia, dementia, multiple sclerosis, Parkinson's, neuralgia, chronic pain, phantom pain, paralysis, Alzheimer's disease, and brain disorders. Such devices may work with a conventional MP3 player and N conventional user devices (including conventional audio device, visual devices, taste devices, smell devices, touch devices, linear-acceleration devices, rotary devices, and temperature devices, where the MP3 player acts as a controller and a user interface.

A multisensory frame as a stimulus is optimized for best treatment over an audio link through iSOUP User Optimization Procedure (iSOUP-UOP). The multisensory frame is defined as an 8-sensory frame or any of its 254 simplified frames.

Said device uses integration of multiple human sensory receptors to maximize plasticity. An optional feature is that the processor parameter, program, core, and/or operating system of said OHDT device is updated through an audio link plus Internet by iSOUP-IUP. Rather than over an audio cable between the conventional MP3 player and the OHDT device, transmission is instead over a wireless audio connection or inaudibly over the air, wherein the wireless connection is based on Bluetooth™ or relevant wireless technologies.

Assistive Listening MP3 File

The principles of the invention also provide for an assistive listening MP3 file. For normal-hearing and hearing-impaired users, said multisensory iSOUP assistive listening MP3 file enhances the full perception of CD-quality music, audio book, movies, and digital radio, as well as audio materials. When said MP3 file is played from a conventional MP3 player to an iSOUP Box and N conventional user devices (including conventional audio device, visual devices, taste devices, smell devices, touch devices, linear-acceleration devices, rotary devices, and temperature devices, said file takes advantage of both multisensory integration and the spectrum-shaping to jointly enhance the perception. Both normal-hearing users and hearing-impaired users appreciate the same file due to the inaudibility of Prefix, Message, and Postfix of iSOUP.

For normal hearing (NH) users, said file enables a NH user to appreciate highest sensation, highest fidelity, broadest frequency range, and highest quality in music. For a NH user, the spectrum-shaping filter hₛₛ(t) defined in FIG. 5, is generated based on the audiogram of a NH user, except that his audiogram has less-than-20 dB hearing loss everywhere. The spectral shape of his audiogram is still non-flat and can be compensated by hₛₛ(t).

For a hearing aid user, said MP3 file solves the three problems:
a hearing aid (HA) has a limited number of subchannels, flat amplification gain within one subchannel, mismatch with a user's residual hearing capability.
a HA mismatches a user's gradually-changing ear.
a HA has a limited range of amplification.

For a middle ear implant (MEI), bone conduction implant (BCI), vestibular implant (VI), cochlear implant (CI), hybrid cochlear/vestibular implant (HCVI), auditory nerve implant (ANI), auditory brainstem implant (ABI), or auditory midbrain implant (AMI), said file solves the same problems of limited subchannels, flat gain, and mismatch with a user's residual capability.

All or part of visual, taste, smell, touch, linear-acceleration, rotary, and temperature cues (saved in Left-Eye Msg, Right-Eye Msg, Binocular-Balance Msg, Taste Msg, Smell Msg, Touch Msg, Linear-Acceleration Msg, Spinning Msg, and Temperature Msg, in a digital manner, respectively), or their analog formats (stored in Left-Eye Waveform, Right-Eye Waveform, Taste Waveform, Smell Waveform, Touch Waveform, Linear-Acceleration Waveform, Spinning Waveform, and Temperature Waveform, respectively), are inserted into iSOUP Frame Structure (iSOUP-FS).

For said MP3 file, the impulse response of the spectrum-shaping filter is generated based on a user's aided audiogram, subchannel gains of a HA user, or THL and MCL. When the user's aided audiogram is still a non-flat spectral shape r_{d}(f), the spectrum-shaping filter hₛₛ(t) is designated as an inverse filer of r_{d}(f). After hₛₛ(t) is created, its coefficients is injected into Message of the iSOUP frame that also includes a piece of MP3 music as T-Signal.

The iSOUP-FS frame can be saved as a file into a conventional MP3 player or a computer disk. The saved file is called iSOUP assistive listening MP3 file, which is personalized for each user, different from conventional MP3 file.

During playing the frame, an iSOUP Box automatically extracts Message to convolve hₛₛ(t) with the music signal, and thus compensates the residual distortion r_{d}(f).

In treatment, iSOUP assistive listening MP3 file is used with hearing disease treatment devices or neurological disorder treatment devices defined in the present invention, including but not limited to the Sleep Helpers, the Phantom Pain Relief Devices, the Neuralgia Relief Devices, the Depression Relief Devices, the Dementia Rehabilitation Devices, the Stroke and Brain Damage Rehabilitation Devices, the Parkinson's Disease Rehabilitation Devices, the Multiple Sclerosis Rehabilitation Devices, the Tinnitus Treatment Devices, the Tinnitus Treatment Hearing Aids, the Tinnitus Treatment Middle Ear Implants, the Tinnitus Treatment Bone Conduction Implants, the Tinnitus Treatment Vestibular Implants, the Tinnitus Treatment Cochlear Implants, the Tinnitus Treatment Hybrid Cochlear/Vestibular Implants, the Tinnitus Treatment Auditory Nerve Implants, the Tinnitus Treatment Auditory Brainstem Implants, the Tinnitus Treatment Auditory Midbrain Implants, the Auditory Hallucination Treatment Devices, the Meniere's Disease Treatment Devices, and the Auditory Neuropathy Treatment Devices, all of which are defined in the present invention. The spectrum-shaping filter hₛₛ(t) is an inverse of the residual distortion r_{d}(f) that corresponds to the diseased affected audiogram. Said file is used to treat or alleviate the disease, and maximizes patient's full appreciation of music, audio book, digital radio, and other audio materials defined by [0062], which in turn soothe the patient.

The multisensory iSOUP assistive listening MP3 file according to claim 0, wherein the processor parameter, program, core, and/or operating system of said file is updated through an audio link plus Internet by iSOUP-IUP.

A visual cue may be embedded in Left-Eye Msg and Right-Eye Msg of said audio-visual MP3 file. The visual cue can be but is not limited to the feature information: energy, rms, magnitude spectrum, phase spectrum, spectrogram, intensity, pitch, formants (F1, F2, F3, F4, F5, and F6), slope of pitch, interval of pitch, contour of pitch, rhythm, onset time-points, sound source location, sensory type, sensory location, sensory duration, mean, standard deviation, skewness, kurtosis, high-order central moments, cumulants, and/or any statistical characteristics.

Two or more of the visual cues can be shown simultaneously to a user. For example, sound source location is shown to the left side of the user, while pitch/intensity/energy/rms height or onset time-points are shown to the right side. The left side is controlled by Left-Eye Msg, while the right is controlled by Right-Eye Msg.

Another optional feature is that for analog visual content to be shown, Left-Eye Waveform and Right-Eye Waveform can be used to convey the content.

Disabled Children Multisensory Learning Device

An optimal disabled children multisensory learning device exploits the multisensory processing and neural plasticity of the child, which also provides education through training.

Said device consists of one transmitter plus multiple (N) modules, where a multisensory frame as a stimulus is optimized for children learning over an audio link. The multisensory frame is defined as an 8-sensory frame or any of its 254 simplified frames.

Each sense of a child is stimulated by one of the N modules. The transmitter sends the multisensory frame to N modules simultaneously.

In the multisensory frame, Timing Offset Msg is used to adjust the stimulation times of the successive Left-Eye Waveform, Right-Eye Waveform, Left-Ear Waveform, Right-Ear Waveform, Taste Waveform, Smell Waveform, Touch Waveform, Linear Acceleration Waveform, Spinning Waveform, Temperature Waveform, and User Waveform.

The adjustment compensates the different response times of the disabled child's eight body receptors. Based on said adjustment, fastest learning and education based on integration of eight sensations is achieved.

The stimulation times of N modules can be further adjusted regarding the disability of the child or his abnormal receptors. The further adjustment is done by playing an iSOUP-FS frame. Audio-visual integration may be used as a simplified version of a multisensory frame. The processor parameter, program, core, and/or operating system of said device are updated through an audio link plus Internet by iSOUP-IUP. Rather than over an audio cable, transmission is over a wireless audio connection or inaudibly over the air.

Patient Multisensory Rehabilitation Device

An optimal patient multisensory rehabilitation device is also provided, wherein the rehabilitation device works to rehabilitate a patient by using a customized and optimized stimulus, where the optimization is done through iSOUP-UOP. Said device improves multisensory integration in the cerebellum near the brain stem, which controls many automatic functions and overall sensory and motor integration. Based on the fact that often the process of neuron firing off a message also creates new interneuronal connections called dendrites or axons, using said device can build new brain connections, increasing the neural network, exactly what is needed to recover from surgery, neurological disorders, or hearing diseases. Also, said device can also be used by older people undergoing various forms of health crises or degeneration, where said device can bring personalized comfort and solace, inner calm, deeper sleep, better mental balance, awareness, and focus.

Said device consists of one transmitter plus multiple (N) modules, where a multisensory frame as a stimulus is optimized for patient rehabilitation over an audio link. The multisensory frame is defined as an 8-sensory frame or any of its 254 simplified frames.

In the multisensory frame, Timing Offset Msg is used to adjust the stimulation times of multiple senses and make the brain integration synchronous. The processor parameter, program, core, and/or operating system of said device are updated through an audio link plus Internet by iSOUP-IUP. Audio-visual simultaneous stimulus may be used.

While the invention has been described in connection with various embodiments, it should be understood that the invention is capable of further modifications. This application is intended to cover any variations, uses or adaptation of the invention following, in general, the principles of the invention, and including such departures from the present disclosure as come within the known and customary practice within the art to which the invention pertains.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiments, methods, and examples, but by all embodiments and methods within the scope and spirit of the invention as described herein.

What is claimed is:

1. A method for transmitting information comprising:
transmitting, in a first direction over a communication link, a forward subframe containing feature information and user information;
transmitting, in a second direction over the communication link, a backward subframe including customer data, wherein such customer data comprise at least one of body resistance, capacitance, inductance, current, voltage, electromagnetic field distribution and response, user information, and feature information, and wherein the forward subframe and backward subframe are transmitted over the same communication link.

2. The method of claim 1, wherein the feature information includes at least one of energy, rms, magnitude spectrum, phase spectrum, spectrogram, intensity, pitch, formants (F1, F2, F3, F4, F5, and F6), slope of pitch, interval of pitch, contour of pitch, rhythm, onset time-points, sound source location, sensory type, sensory location, sensory duration, mean, standard deviation, skewness, kurtosis, high-order central moments, cumulants, and a statistical characteristic.

3. The method of claim 1, wherein the user information includes at least one of MP3 anti-piracy information, human psychophysical parameter, hearing aid parameter, human test parameter, physiological parameter, stereo parameter, customer preference, User ID, Serial Number, Music ID, relative amplitudes, delays, program selection, timer, digital volume control, direction of listening (with directional microphones), music/speech/noisy/environmental/directional/omnidirectional/automatic mode selection, sensitivity control, battery remote turn-off/turn-on, production date, distribution date, reproduction date, purchase date, purchase store, user class, bar code, index of frequency bin, electrode index, FIR/IIR filter coefficient, subchannel gain, audible threshold (THL), most comfortable level (MCL), windowing function, compression function, block size of input, block size of processing, and block size of output.

4. The method of claim 1, wherein digital and analog information are transmitted over the communication link.

5. The method of claim 1, wherein the transmission of the forward subframe and backward subframe is inaudible.

6. The method of claim 1, wherein the backward subframe is not transmitted.

7. The method of claim 1, wherein transmitting and processing are jointly performed.

8. The method of claim 1, wherein said transmitting further comprises transmitting, simultaneously, the forward subframe to a plurality of hardware devices.

9. A device comprising:
a transmitter configured to transmit a forward subframe, comprising feature information and user information, over a communication link;
a receiver configured to receive a backward subframe over the communication link, wherein the backward subframe includes customer data, wherein such customer data comprise at least one of body resistance, capacitance, inductance, current, voltage, electromagnetic field distribution and response, feature information, and user information, and wherein the forward subframe and backward subframe are respectively transmitted and received over the same communication link.

10. The device of claim 9, wherein the feature information includes at least one of energy, rms, magnitude spectrum, phase spectrum, spectrogram, intensity, pitch, formants (F1, F2, F3, F4, F5, and F6), slope of pitch, interval of pitch, contour of pitch, rhythm, onset time-points, sound source location, sensory type, sensory location, sensory duration, mean, standard deviation, skewness, kurtosis, high-order central moments, cumulants, and a statistical characteristic.

11. The device of claim 9, wherein the user information includes at least one of MP3 anti-piracy information, human psychophysical parameter, hearing aid parameter, human test parameter, physiological parameter, stereo parameter, customer preference, User ID, Serial Number, Music ID, relative amplitudes, delays, program selection, timer, digital volume control, direction of listening (with directional microphones), music/speech/noisy/environmental/directional/omnidirectional/automatic mode selection, sensitivity control, battery remote turn-off/turn-on, production date, distribution date, reproduction date, purchase date, purchase store, user class, bar code, index of frequency bin, electrode index, FIR/IIR filter coefficient, subchannel gain, audible threshold (THL), most comfortable level (MCL), windowing function, compression function, block size of input, block size of processing, and block size of output.

12. The device of claim 9, wherein digital and analog information are transmitted over the communication link.

13. The device of claim 9, wherein the transmission of the forward subframe and backward subframe is inaudible.

14. The method of claim 9, wherein the backward subframe is not transmitted.

15. The method of claim 9, wherein transmitting and processing are jointly performed.

16. The device of claim 9, wherein said transmitter is further configured to simultaneously transmit the forward subframe to a plurality of hardware devices.
